(19) United States
(12) Patent Application Publication
(10) Pub. No.: US 2017/0107413 A1
(43) Pub. Date: Apr. 20, 2017

(54) Anti-icing composition driven by catalytic hydrogen generation under subzero temperatures

(71) Applicants: Liang Wang, Acworth, GA (US); Viktoria Ren Wang, Acworth, GA (US)

(72) Inventors: Liang Wang, Acworth, GA (US); Viktoria Ren Wang, Acworth, GA (US)

(21) Appl. No.: 14/887,091

(22) Filed: Oct. 19, 2015

(51) Int. Cl. C09K 3/18

(52) U.S. Cl. CPC C09K 3/18

(57) ABSTRACT

The present invention relates to a self-renewing, anti-icing composition driven by a dehydrogenative reaction of a reactive hydrogen-rich compound catalyzed by nanoparticle immobilized catalysts, which is active under subzero temperatures. The disclosed coating displays a variety of properties including, but not limited to hydrophobicity, anti-wetting, and resistance to ice formation and ice adhesion. The novel anti-icing coating can be used on glass surfaces requiring optical clarity and transparency and can also be applied to a variety of smooth, roughened, or porous surfaces.

| | |
|---|---|
| Int. Cl. | C09K 5/18 |
| U.S. CPC | C09K 5/18 |
| U.S. Cl | 106/13 |
| Field of Search: | C09K 5/18; C09K 5/16; C09K 3/18; |
| | C08G 77/12; C09D 183/00; C09D |
| | 183/04; C09D 183/06; B05D 5/08 |

### REFERENCES CITED

### U.S. Patent Documents

US 2014/0234579 A1, Wang, L., and Wang, V. R. 2013. “Composite Preventing Ice Adhesion”
US 2014/0127516 A1, Wang, L., and Wang, V. R. 2013. “Composite for Preventing Ice Adhesion”
U.S. patent application Ser. No. 13/784,517, Wang, L., and Wang, V. R. 2013, “Novel Anti-icing Coating”
US 2014/0147627 A1, Aizenberg et al., 2014, “Slippery Surfaces with High Pressure Stability, Optical Transparency, and Self-healing Characteristics”
US 2014/0187666 A1, Aizenberg et al., 2014, “Slippery Liquid-Infiltrated Porous Surfaces and Biological Applications Thereof”
US 2013/0164521 A1, Myaeng et al., 2013, “Glass Substrate Manufacturing Method and Glass Thereof”
US 2007/0027286 A1, Blanc-Magnard et al., 2007, “Silicone Composition Which Can Be Crosslinked by Means of Dehydrogenetive Condensation in the Presence of Metal Catalyst”
US 2003/0185749 A1, Mahajan, 2003,“Method for Low Temperature Catalytic Production of Hydrogen”

| 9,067,879 B2 | June 2015 | Howard | C070C 67/08 |
|---|---|---|---|
| 9,067,821 B2 | June 2015 | Bleecher et al. | C03C 17/30 |
| 8,889,938 B2 | November | Masuno et al. | C070 51/16 |
| | 2014 | | |
| 8,883,308 B2 | November | Polshettiwar et al. | C09C 1/3054 |
| | 2014 | | |
| 8,754,176 | June 2014 | Yamanaka, et al. | 526/89 |
| 8,741,158 B2 | June 2014 | Autug, et al. | 216/11 |
| 8,658,573 B2 | February | Bae, et al. | 528/32 |
| | 2014 | | |
| 8,623,985 B2 | January 2014 | Maliverney | 528/14 |
| 8,470,899 B2 | June 2013 | Maliverney | 521/129 |
| 7,655,206 B2 | 423/325 | Fester et al. | 423/325 |
| 7,514,017 B2 | April 2009 | Bhamidipati | 252/70 |
| 7,258,731 B2 | September | D'Urso, et al. | 106/2 |
| | 2007 | | |
| 6,916,963 B2 | July 2005 | Van Hal, et al | 568/811 |
| 6,610,872 B1 | August 2003 | Choi et al. | 556/53 |
| 6,272,331 B1 | August 2001 | Gay et al. | 528/15 |
| 5,910,683 B2 | March 2011 | Byrd, et al. | 528/26 |
| 5,747,561 | May 1998 | Smirnov, et al. | 523/212 |
| 5,728,920 | March 1998 | Ramprasad, et al. | 568/930 |
| 5,188,750 | February | Kogure, et al. | 252/70 |
| | 1993 | | |
| 5,187,015 | February | Yorkgitis, et al. | 428/447 |
| | 1993 | | |
| 4,774,112 | September | Achtenberg, et al. | 427/387 |
| | 1998 | | |
| 4,301,208 | November | Jellinek, et al. | 428/334 |
| | 1981 | | |
| 4,271,215 | June 1981 | Coon | 427/387 |

### Foreign Patent Documents

| | |
|---|---|
| 0062575 | Japan |

### OTHER PUBLICATIONS

### Journals/Articles

[1] Anderson, D. N., NASA Lewis Research Center, Cleveland Ohio and Reich, A. D., BF Goodrich R&D Center, Brecksville, Ohio. 1997. “Tests of the Performance of Coatings for Low Ice Adhesion,” AIAA-97-0303, 35^{th} Aerospace Sciences Meeting & Exhibit, Jan. 6-10, 1997/Reno, Nev.
[2] Adhikary, S. D., Samanta, T., Roymahapatra, G., Loiseau, F., Jouvenot, D., Giri, S., Chattaraj, P. K., and Dinda, J., 2010. “Synthesis, structure and electrochemical behavior of Ru(II)- and Pt(II)-carbine complexes of NCN-pincer 1,3-bis(2-pyridylmethyl)-1H-benzimidazolium chloride,” New J. Chem., 34, 1974-80
[3] Anand, S., Paxson, A. T., Dhiman, R, Smith, J. D., Varanasi, K. K. 2012. “Enhanced Condensation on Lubricant-impregnated Nanostructured Surfaces, ACS Nano, 6, 10122-10129
[4] Antonini, C., Amirfazli, A. and Marengo, M. 2011. “Drop impact in icing conditions: effect of water solidification on contact line dynamics,” 18^{th} Oustwald Kolloquium on “Dynamic Wetting of Complex Liquids”, May 16-18, 2011, Mainz, Germany
[5] Arduengo, A. J., Harlow, R. L., and Kline, M. A. 1991, “A Stable Crystalline Carbene,” J. Am. Chem. Soc., 113, 361-363
[6] Baratta, W., Chelucci, G., Gladiali, S., Siega, K., Toniutti, M., Zanette, M., Zangrando, E., and Rigo, P., 2005. “Ruthenium (II) Terdentate CNN Complexes: Superlative Catalysts for the Hydrogen-Transfer Reduction of Ketones by Reversible Insertion of a Carbonyl Group into the Ru—H Bond,” Angew. Chem. Int. Ed. 44, 6214-6219
[7] Beisswenger, A., Fortin, G., and Laforte, C. 2010. “Advances in Ice Adherence and Accumulation Reduction Testing at the Anti-icing Materials International Laboratory (AMIL),” Icephobic SAE 2010
[8] Chen, L., Geissler, A., Bonaccurso, E., and Zhang, K. 2014. “Transparent Slippery Surfaces Made with Sustainable Porous Cellulose Lauroyl Ester Films,” ACS Appl. Mater. & Interf., 6, 6969-6976
[9] Dixon, B., Walsh, A., Gall, B, and Goodwin, M. 2011. “Novel Phase Change Material Icephobic Coating for Mitrigation in Marine Environmants,” The 12^{th} Annual General Assemble of IAMU, Gydnia, Poland
[10] Farhadi, S., Farzaneh, M. and Kulinich, S. A. 2011. “Anti-icing Performance of Superhydrophobic Surfaces,” Appl. Sur. Sci., 257(14) 6264-6269
[11] Farhadi, S., Farzaneh, M., and Simard, S. 2012. “On Stability and Ice-Releasing Performance of Nanostructured Fluoro-Alkylsilane-Based Superhydrophobic Al alloy 2024 Surfaces,” Int. J. Theo. Appl. Nanotech. 1, (1), 1929-1248.
[12] He, M., Li, H., Wang, J., and Song, Y. 2011. “Superhydrophobic Surface at Low Surface Temperature,” Appl. Phys. Lett. 98, 093118-1-093118-3
[13] Heydari, G., Thormann, E., Jarn, M., Tyrode, E. and Caesson, P. M. 2013. “Hydrophobic Surfaces: Topography Effects on Wetting by Supercooled Water and Freezing Delay,” J. Phys. Chem., 117, 21752-21762
[14] Hollas, A. M., Gu, W. X., Bhuvanesh, N., and Ozerov, O. V. 2011. “Synthesis and Characterization of Pd Complexes of a Carbazoly/Bis (Imine) NNN Pincer Ligand,” Inorg. Chem., 50(8), 3673-3679
[15] Jung, S., Dorrestijn, M., Raps, D., Das, A., Megaridis, C. M. and Poulikakos, D., 2011, “Are Superhydrophobic Surfaces Best for Icephobicity?” Langimuir, 27, 25-29
[16] Kawahara, R., Fujita, K. I., and Yamaguchi, R. 2012. “Dehydrogenative Oxidation of Alcohols in Aqueous Media Using Water-Soluble and Reusable Cp*Ir Catalysts Bearing a Functional Bipyridine Ligand,” J. Am. Chem. Soc., 134 (8), 3643-3646
[17] Kent, R. A., Andersen, D., Caux, P. and Teed, S., 1999. Canadian Water Quality Guidelines for Glycols: An Ecotoxicological Review of Glycols and Associated Aircraft Anti-Icing and Deicing Fluids, Environmental Toxicology, 14, 5, 481-522
[18] Khanna, R., Agnihotri, N. K. and A Sharma, A. 2009 “Kinetics of Dewetting,” pp 203-242, in Kinetics of Phase Transitions, Edited by S. Puri, S. and V. Wadhawan, V., CRC Press
[19] Kim, P., Wong, T. S., Alvarenge, J., Kreder, M. J., Adomo-Martinez, W. E. and Aizenberg, J. 2012 “Liquid-Infiltrated Nanostructured Surfaces with Extreme Anti-Ice and Anti-Frost Performance,” ACS Nano, Just Accepted Manuscript, DOI: 10.1021/nn302310q, 10, June 2012, http://pubs.acs.org on Jun. 11, 2012
[20] Kulinich, S. A., Farhadi, S. Nose, K. and Du, X. W. 2011. “Superhydrophobic surfaces: Are They Really Ice-Repellent?” Langmur, 27(1), 25-29,
[21] Kulinich, S. A. and Farzaneh, M. 2009. “How Wetting Hysteresis Influences Ice adhesion Strength on Superhydrophobic Surfaces,” Langmuir Letter, 25 (16), 8854-8856
[22] Ildyakov, A. V., Manakov, A. Yu. 2014. “Solubility of hydrogen in ice Ih at pressure up to 8 MPa,” Inter. J. Hydrogen Energy, 39(33), 18958-18961
[23] Laforte, C. and Beissuenger, A., 2005. “Icephobic Material Centrifuge Adhesion Tests,” IWAIS, XI, Montreal, June (2005)
[24] Land, M., Wit, C. A., Lousins, I. T., Herzke., D., Johansson, J., and Martin, J. W. 2015. “What is the effect of phasing out long chain per- and poly-fluoroalkyl substances on the concentrations or of perfluoroalkyl acids and their precursors in the environment? A systematic Review Protocol.” Environ. Evidence, 4, 3, 2047-2382
[25].Li, Z. J., Fan, X. B., Li, X. B., Li, J. X., Ye, C., Wang, J. J., Yu, S. Li. C. B., Gao, Y. J., M., Q. Y., Tung, C. H., and Wu, L. Z. 2014. “Visible Light Catalysis-Assisted Assembly of Niₕ-QD Hollow Nanospheres in Situ via Hydrogen Bubbles,” J. Am. Chem. Soc., 236 (23), 8261-8268
[26] Lindstrom, A. B., Strynar, M. J., and Libelo, E. L, 2011. “Polyfluorinated Compounds: past, present, and future,” Environ. Sci., Technol., 45, 7954-61
[27] Masuda, H. and Fukuda, K. 1995. “Ordered Metal Nanohole Arrays Made by a Two-Step Replication of Noneycorm Structures of Anodic Alumina,” Science, 268, 1466-1468
[28] Meuler, A. J., Smith, J. D., Varanasi, K. K., Mabry, J. M., McKinley, G. H. and Cohen, R. E. 2010. “Relationships between Water Wettability and Ice Adhesion,” ACS Applied Materials & Interfaces, 2 (11), 3100-3110.
[29] Polshettiwar, V., Cha, D.-K., Zhang, X.-X., and Basset, J. M. 2010. “High-Surface-Area Silica Nanospheres (KCC-1) with a Fibrous Morphology,” Angew. Chem., Int. Ed., 49, 9652-56
[30] Poyatos, M., Mata, J. A., Falomir, E., Crabtree, R. H., and Penis E. 2003. “New Ruthenium(II) CNC-Pincer Bis(carbine) Complexes: Synthesis and Catalytic Activity,” Organomet., 22(5), 1110-1114
[31] Reiter, G. 2012. “Visualizing Properties of Polymers at Interfaces,” Springer Reference, http://www.springerreference.com/index/chapterbid/78589, 3, February
[32] Subramanyam, S. B., Rykaczewski, K, Varanasi, K. K., 2013. “Ice Adhesion on Lubricant-Impregnated Textured Surfaces,” Langmuir, 29, 13414-13418
[33] Thangavel, B., Kumar, V., Bobji, M. S., Chajradhar, and Basu, B. J. 2014. “Effect of wettability and surface roughness on ice-adhesion strength of hydrophilic, hydrophobic and superhydrophobic surfaces,” Appl. Sur. Sci., 314, 241-250
[34] United State Environmental Protection Agency, EPA-821-R-00-16 Aug. 2000, Preliminary Data Summery, Airport Deicing Operations (Revised).
[35] U.S. Department of Transportation, Federal Aviation Administration Notice N9800.275, Revised FAA-Approved Deicing Program Update, winter 2014-2015
[36] Vananasi, K. K., Deng, T., Smith, J. D., Hsu, M. and Bhate, N. 2010, “Frost formation and Ice adhesion on Superhydrophobic Surfaces,” Appl. Phys. Lett., 97, 234102-1-234102-3
[37] Wong, T. S., Kang, S. H., Tang, S. K. Y., Smythe, E. J., Hatton, R. D., Grinthal, A., Aizenberg, J. 2011. “Self-Repairing Slippery Surfaces with Pressure-Stable Ominiphobicity,” Nature, 477 443-447
[38] Yang, D., Li, J., Xu, Y., Wu, D., Sun, Y., Zhu, H., Deng, F. 2006. “Direct formation of hydrophobic silica-based micro/mesoporous hybrids from polymethylhydrosiloxane and tetraethyoxysilane,” Microp. Mesop. Mater., 95, 180-186

### Books

[39] Ameduri, B. and Boutevin B. edited. 2004. “Well-Architectured Fluoropolymers: Synthesis, Properties and Applications,” Elsevier
[40] Cornils, B., Herrmann, W. A., Wong C. H., and Zanthoff H. W., Editors, 2013. “Catalysis from A to Z” 4 Volume Set, Wiley-VCH Verlag GmbH, Germany
[41] Cornils, B., Cornils, Boy, Herrmann, W. A. (2000) Applied Homogeneous Catalysis with Organometallic Compounds: A Comprehensive Handbook in Two Volumes, Wiley-VCH, Verlag GmbH, Germany
[42] Dong, H. Edited. 2010. “Surface Engineering of Light Alloys, Aluminum, Magnesium, and Titanium Alloys,” CRC Press, Woodhead Publishing Limited
[43] Feynman, R. P., Leighton, R. B., and Sands, M. 1964. “The Feynman: Lectures on Physics I,” Addison-Wesley Publishing Company, Reading, Mass.
[44] Grieco, P. A (Edit), 1998. “Organic Synthesis in Water,” Blackie Academic and Professional, London
[45] Harrats, C., Thomas, S., and Groeninckx, G., edited. 2006. “Micro- and Nanostructured Multiphase Polymer Blend Systems—Phase Morphology and Interfaces,” CRC Taylor & Francis, Boca Raton, Fla.
[46] Hartwing, J. F., 2010 “Organotransition Metal Chemistry form Bonding to Catalysis,” University Science Books, Mill Valley, Calif.
[47] Jones, R. G., Ando, W., & Chojnowski, J., edited. 2013. “Silicon-Containing Polymers: The Science and Technology of Their Synthesis and Applications,” Springer Science & Business Media
[48] Li, C.-J, Chen, T.-H (Edits), 1997. “Organic Synthesis in Water,” Wiley-Interscience, New York
[49] Marciniec, B., 2010. “Hydrosilylation: A Comprehensive Review on Recent Advances,” Springer Netherland
[50] Scheirs, J., John, edited. 1997. “Modern Fluoropolymers, High Performance Polymers for Diverse Applications,” Wiley & Sons

### FIELD OF THE INVENTION

The present invention relates to a coating composition that releases hydrogen via catalytic reactions. These reactions remain active under subzero temperatures, halt at near ambient temperatures, and are controlled by the availability of water molecules on the surface of the coating. Hydrogen is generated from immobilized catalytic centers on nanoparticles, which are suspended in a water-immiscible, low surface energy, low freezing-point liquid hydride polysiloxane reactant. Released hydrogen pushes against and detaches ice from the liquid hydride polysiloxane surface. The novel composition provides a transparent coating with protection against ice adhesion from which frozen contaminants automatically separate. The novel ice-release coating can be used on glass surfaces, such as windshields and windows, and other applications requiring optical clarity. It can also be applied to smooth, roughened, or porous surfaces. Said ice-release coating is self-cleaning, highly efficient, economical, environmentally friendly, and requires no pre-treatment of application surfaces.

### BACKGROUND OF THE INVENTION

There is an urgent need for a self-cleaning, transparent coating that prevents ice and snow adhesion and repels freezing rain and wet snow. The application fields for such a coating are broad, encompassing aviation, automotive, electric power transmission, rail, buildings and infrastructure, solar panels, and marine vessels, among others.

There are two distinct anti-icing methods: active (which include pneumatic, electro-thermal, bleed air, glycol based fluids, and electro-mechanical means) and passive (which rely solely upon natural forces such as wind, gravity, etc.). Existing active systems are costly to install and maintain, add significant weight or manufacturing complexity, are unreliable under certain conditions, reduce energy efficiency or cause significant harm to the environment. A completely passive technology that would prevent ice accretion is highly desired, but no known technique has reached a level of effectiveness, durability and cost-efficiency to merit commercialization. Additionally, there is no known icephobic coating that is completely transparent and preserves optical clarity.

Salts, methanol-based deicing fluids, ethylene glycol, and propylene glycol are well known and commonly used for deicing. These aforementioned de-icing agents are hydrophilic and water-soluble. By lowering the freezing point of water, they melt snow or ice that comes into contact. However, their disadvantages include: (1) environmental damage from being discharged into storm water [17, 34], (2) short duration of effect, which necessitates frequent reapplication [35], (3) significant costs associated with the storage, transport, application, maintenance, and reclamation of deicing fluids and salts, and (4) limited ability to prevent ice formation and accretion, thus rendering them ineffective for ice protection.

Efforts to increase the retention and longevity of deicing fluid on surfaces have led to the development of hydrophilic glycol-absorbing coatings and a bi-layer coating that secretes deicing fluid. However, these coatings lack transparency and optical clarity. Furthermore, due to their reliance on deicing fluids for their mechanism of action, they suffer from the same disadvantages as the fluids.

Low surface energy materials [39, 47, 50] are known to reduce ice adhesion by varying degrees. Long-chain perfluoroalkyl POSS has the lowest known surface energy. The lowest recorded ice adhesion strength for a solid coating was for a mixture of 80/20 PEMA/Fluorodecyl POSS that showed an ice adhesion strength of 165±27 kPa over seven rounds of ice adhesion tests [28].

Transparency and optical clarity are important factors for many anti-icing applications. Most fluoropolymers, such as polytetrafluoroethylene (PTFE), are opaque due to crystallization or microphase separation [50]. Only fluorinated polymethylmethacrylate, the copolymer of 2, 2-bistrifluoromethyl-4, 5-difluoro-1, 3-dioxole and tetrafluoroethylene are amorphous and transparent [50]. However, they do not exhibit satisfactory anti-icing capabilities and are also very expensive. Low surface energy materials such as polysiloxane (silicone), fluoropolymers, fluorinated copolymers, fluorinated silicones, block copolymers containing fluorinated and/or siloxane blocks, grafted copolymers bearing fluorinated or siloxane pendent groups, and fluorinated POSS have all been patented for anti-icing applications. For example, resins of polysiloxane have been claimed in U.S. Pat. No. 8,658,573 B2, U.S. Pat. No. 7,514,017 B2, U.S. Pat. No. 5,910,683 B2, U.S. Pat. No. 5,188,750, U.S. Pat. No. 5,187,015, U.S. Pat. No. 4,774,112 and Japan 0062575. However, no solid-state material that can ensure adequate protection against ice accretion has yet been identified [1, 7, 13, 23, 28].

Superhydrophobic nano/micro hierarchical structures based on the architecture of the lotus leaf have been studied extensively. Many superhydrophobic surfaces had been claimed as anti-icing coatings [see cited literature in U.S. Pat. No. 9,067,821 B2]. However, these fragile nano/micro hierarchical structures are very easily damaged, thereby leading to rapid performance deterioration after repeated icing cycles. Furthermore, atmospheric humidity leads to frost forming in and getting trapped into inter-asperity spaces of the hierarchical structures, creating high ice bonding forces. As soon as frost begins to form, solidification of the water droplet occurs, causing loss of superhydrophobicity and promoting the bonding of the frozen droplet to the surface [4, 10-13, 15, 20, 21, 33, 36]. Recent research has shown that the formation of frost on superhydrophobic surfaces actually promotes ice formation and increases ice bonding forces [4, 36].

Anti-icing methods using liquid siloxane (silicone oil) as a coating component were patented in U.S. Pat. No. 4,271,215, U.S. Pat. No. 4,301,208, U.S. Pat. No. 5,747,561, and Japanese Pat. 0062575. Jellinek claimed that the surface layer of silicone oil in his coating composition could be replenished via diffusion from the bulk areas of the coating. However, this claim is unsubstantiated. Silicone oil (polysiloxane) is immiscible in hydrocarbon polymers or in a hydrocarbon-silicone block copolymer. Microphase separation leads to a non-transparent morphology of silicone oil droplets dispersed throughout the hydrocarbon polymer matrix [45]. These droplets are isolated and cannot join to form continuous channels, nor can they travel across a solid matrix barrier to reach the surface. Furthermore, the diffusion coefficient is inversely proportional to the mass of the molecule and proportional to kT (k is Boltzmann constant, T is the temperature in Kelvin) [43]. The mass of silicone oil (polysiloxane) is high (>1000 g/mole). When temperature is at 0° C., the diffusion coefficient of a molecule of polysiloxane is negligibly small (3.77×10⁻¹⁷ cm² mol/sec). Thus, surface replenishment of silicone oil from bulk areas via diffusion would be impossible for the anti-icing composite described by Jellinek.

All existing patents that claim a composition that utilizes a low freezing-point liquid component, such as silicone oil or a fluorinated liquid, are inefficient for preventing ice adhesion or accretion due to their inability to maintain a continuous liquid film on the coating surface. This inability is caused by: (i) de-wetting zones [18, 31], (ii) droplet and matrix morphology that prevents liquids from migrating across the solid matrix barrier [45], (iii) inability to shield surface polar groups, and (iv) lack of a driving force and reliance on weak diffusion forces [43]. These challenges result in anti-icing composite surfaces that are only partially covered with discontinuous islands of liquid droplets, leading to ice bonding to the uncovered areas.

We previously discovered that superhydrophobic, superhydrophilic, or organometallized micro-roughened surfaces with a hydrophobic, low freezing-point liquid adsorbed onto surface asperities results in a durable, renewable anti-icing surface that could overcome the aforementioned challenges (US 2014/0127516 A1, US 2014/0234579 A1), However, these composites are non-transparent.

Aizenberg et al. [US 2014/0187666 A1, 19, 37] developed slippery liquid infiltrated porous surfaces (SLIPS) made by electrodepositing polypyrrole on aluminum substrates followed by treatment with a long chain fluorinated silane (tridecafluoro-1,1,2,2-tetrahydrooctyl trichlorosilane). The resulting textured surface is infused with a perfluorinated lubricating fluid (perfluoropolyether, Krytox®100, DuPont, or perfluorotripentylamine, FC-70, 3M). The reported ice adhesion force for SLIPS averages 15.6 kPa at −10° C. for five ice removals [19]. US Patent Application 2014/0147627 claimed a transparent self-healing SLIPS, described as roughened or porous surfaces featuring micro and nanoscale topographies that lock a lubricating fluid in place.

Chen at al.'s recent discovery of transparent SLIPS made with porous cellulose lauryl ester film infused with perfluoropolyether has been shown to delay ice nucleation [8] and enhance water condensation [3]. However, ice-adhesion force on SLIPS is dependent on the density and thickness of the lubricant fluid that is impregnated on the surface [32]. SLIPS technology requires nano/microporous surfaces, a long chain perfluoroalkyl silane, and a perfluorinated liquid (perfluoropolyether or perfluorotripentylamine). Perfluoropolyethers (PFPE) and perfluorotripentylamine are hydrophobic, chemically inert and stable perfluorinated liquids that have a low freezing-point, high density and no known mechanism for natural degradation. In Chen's invention, the substrate surface must be treated with a long chain perfluoroalkyl silane to create affinity for perfluoropolyether or perfluorotripentylamine. However, long chain perfluoroalkyl silanes, like other PFASs, are highly persistent, bio-accumulative, and very hazardous to humans and the environment [24, 26]. These PFASs [24, 26] are also prohibitively expensive which further constrains real world usage. Another obstacle for real world application is the difficulty in scaling the manufacture of nano-roughened or nano-porous surfaces for transparent SLIPS.

Dehydrogenetive condensation reactions between SiH/SiOH, or between SiH and alcohols have been described in various patents such as U.S. Pat. No. 8,623,985 B2, U.S. Pat. No. 8,470,899 B2, US 2007/0027286 A1, U.S. Pat. No. 6,610,872 B1, and U.S. Pat. No. 6,271,331B1. Methods such as hydrogen generation by water shift, hydrocarbon partial oxidation, and steam reforming of CO, natural gas, ethanol, or methanol typically employ a catalyst under high temperature conditions (>600° C.). Catalytic production of hydrogen by water-gas-shift reactions is classified as “low-temperature” at temperatures less than 80-150° C. (US 2003/0185749 A1). However, there is no known method for generating hydrogen gas under subzero temperatures.

After the initial isolation of stable N-hetero-cyclic carbine NHC [5], non-phosphine air stable ligands of CNC [30], CNN [6], NCN [2], NNN [14], and CCC have been developed. Transition metal complexes with pincer ligands can catalyze alkane dehydrogenation and release hydrogen at 190° C. [41]. However, a dehydrogenetive catalyst with pincer ligands active under subzero temperatures is unknown.

Water-tolerant Lewis acids Mⁿ(A₁)ₓ(A₂)ₙ₋ₓ have been used as catalysts for nitrating arene (U.S. Pat. No. 5,728,901), where M is selected from the group consisting of La, Pr, Nd, Sm, Eu, Gd, Dy, Ho, Er, Tm, Yb, Sc, Hf, Lu, and Li; and, A₁ and A₂ are independently selected from the group consisting of a perfluoroalkylsulfonate, a fluorosulfonate, a hexafluorophosphate or a nitrate. The preparation of alkylene glycols by catalytic hydration of alkylene oxide uses water-tolerant Lewis acids (U.S. Pat. No. 6,916,963 B2). These catalysts include triflate anions, cations from Group IIIB or Group IVB, and rare earth, lanthanide, or actinide. The catalysts may contain coordinated anions, non-coordinated anions, or weakly coordinated anions of Sc. Synthesis of para-xylene by cycloaddition of ethylene to DMF was reported using water-tolerant catalysts (U.S. Pat. No. 8,889,938 B2). Triflate of Bi, La and Nd have been used to synthesize dialkyl and trialkyl esters (U.S. Pat. No. 9,067,879 B2). However, the application of water-tolerant catalysts for the dehydrogenation or synthesis of hydride polysiloxanes is unknown.

Very recent research has shown that hollow nanospheres can be assembled by hydrogen nano-bubbles [25]. However, there is no literature reporting the use of hydrogen nano-bubbles to detach ice from surfaces or to switch off catalytic hydrogen generation reactions.

Techniques for nano roughening of glass surfaces are known (US 2013/0164521 A1, U.S. Pat. No. 8,741,158 B2, U.S. Pat. No. 7,258,731 B2). However, a composition for a transparent, anti-icing composite that does not require surface roughening or surface treatment with long chain perfluoroalkyl silane, PFPE or perfluorotripentylamine, or PFASs is unknown in patent or scientific literature.

### SUMMARY OF THE INVENTION

The present invention discloses a novel hybrid of active and passive technologies for ice release. This invention leverages the negligible solubility of hydrogen in ice [22] and uses this property as the basis for its ice release mechanism. The present invention discovered a mechanism for heterogeneous catalytic hydrogen generation, supported by a water immiscible, low surface energy hydrogen generation reactant that remains active under subzero-temperatures and halts under ambient temperatures. This unique composition enables low temperature catalytic hydrogen generation and provides an optically clear, low hysteresis, renewable, ice release coating on substrate surfaces. The invented ice-release composition comprises of (1) an ultrahigh activity catalyst that is immobilized on nanoparticle surfaces; said catalyst is active under subzero temperatures and inactive at temperatures much higher than subzero temperatures; and (2) a water immiscible, hydrophobic, low surface energy, low freezing-point hydride polysiloxane; said hydride polysiloxane serves multiple functions: (a) acts as a reactant in the hydrogen generation reaction, (b) forms nanobrushes that graft onto substrate surfaces, overcoming dewetting forces (see FIG. 1), and (c) transports water molecules from atmospheric humidity to immobilized catalytic centers on nanoparticle carriers (see FIG. 2).

The low surface energy hydride polysiloxane reactant is a medium molecular weight hydride polysiloxane that reacts with water to generate hydrogen when activated by a catalyst. The hydride polysiloxane is a hydrophobic, low surface energy, low freezing-point liquid that shows low ice adhesion properties. In the present invention, hydride polysiloxane forms nanobrushes that help overcome autophobicity and dewetting forces [18, 31]. A catalyst that is immobilized on nanoparticle carriers catalyzes the dehydrogenetive coupling reaction between hydride polysiloxane and water to generate hydrogen. The active catalyst is tolerant towards both water and oxygen under subzero temperatures. The hydrogen generation reaction is linked to temperature and to the concentration of water, which exponentially diminishes below the surface of the hydrophobic hydride polysiloxane layer. This unique deactivation mechanism is triggered by the production of hydrogen nano-bubbles on the interfaces of the immobilized catalytic centers. These bubbles block access to the catalytic centers, thereby starving the reactants of both water and hydride polysiloxane.

Due to very low water contact angle hysteresis, water droplets quickly run off from angled surfaces of the novel ice release coating. When water droplets freeze on treated horizontal surfaces, the frozen droplets automatically separate from the novel ice release coating. This phenomenon is a result of the released hydrogen gas, which physically separates the frozen droplets due to the negligible solubility of hydrogen in ice.

The present invention provides extremely active catalysts for the dehydrogenative coupling reaction between hydride polysiloxane and water, which generates hydrogen. The present invention also describes synthesis methods for medium-high and high molecular weight hydride polysiloxanes for use as reactants for hydrogen generation and grafting of molecular brushes. In addition, the present invention also provides methods for immobilizing a catalyst with ultrahigh hydrogen generation activity under subzero temperatures onto nanoparticle surfaces.

The discovered ice release coating has multiple advantages over existing technology including high performance, low manufacturing costs, environmentally friendly composition, and broad applicability. Application surfaces include both smooth and textured surfaces such as hierarchical micro/nano-roughened, micro/nanoporous, microporous, and nanoporous surfaces. For smooth glass surfaces requiring optical clarity, nano-roughening of the surface is not required. The invented composition can be applied to an unlimited number of substrates such as glass, metal, anodized aluminum alloys, solvent-borne paints, plastics, closed cell foams, and composites, among many others.

The anti-icing coating formulation described in the present invention can be adjusted depending upon application needs. For example, it can be formulated as a solvent-free virgin formulation, a solvent-containing formulation, a surfactant-free water emulsion, or a propellant-containing formulation for aerosol application.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 is a schematic of the anti-icing composition in accordance with certain embodiments with grafted polysiloxane nanobrushes.

FIG. 2 depicts a nanoparticle with immobilized catalysts in accordance with certain embodiments.

FIG. 3 is a schematic of the anti-icing composition in accordance with certain embodiments with a nanoporous base layer.

FIG. 4 is a schematic of the anti-icing composition in accordance with certain embodiments with anodic metal oxide.

Corresponding reference characters indicate corresponding components throughout the several views of the drawings. Skilled artisans will appreciate that elements in the FIGURES are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION OF THE INVENTION

A highly effective, low cost, easily applied, durable, non-toxic, environmentally friendly, transparent, thin coating that provides very low ice adhesion or ice release functionality is currently unknown. Accordingly, the primary objective of this invention is to provide a functional ice release composition that encompasses these qualities.

Ice strongly adheres to all solids, even to those composed of very low surface energy materials. The current literature provides evidence that solid surfaces composed of low surface energy material do not show durable and sustainable properties suitable for transparent, anti-icing applications [1, 7, 13, 23, 28, 33]. Roughness-induced superhydrophobic solid surfaces also display poor anti-icing performance due to frost accumulation in inter-asperity spaces, and lack durability and renewability due to fragile nano/micron hierarchical solid structures [4, 10-13, 15, 20, 21, 23, 33, 36].

It is commonly known that ice cannot bond to a liquid. Thus, the freezing point of a hydrophobic liquid candidate for anti-icing applications should be lower than the lowest temperature it will be subject to, in order to maintain its liquid state. To delay ice formation, reduce ice adhesion, facilitate ice removal, and provide durable, renewable surfaces, it is highly desirable to use a composition comprising of: (1) a low surface energy, low freezing-point, water immiscible, hydrophobic liquid that can bond to reactive groups, polar groups, and Lewis acid sites on a solid substrate, and (2) a solid substrate with a surface that has an affinity to said hydrophobic, low freezing-point liquid.

Inert, low surface energy, hydrophobic, water immiscible, low freezing-point liquids are known in the art, such as polysiloxane. Various anti-icing composites that use silicone oil (polydimethylsiloxane) or other hydrophobic, low surface energy, low freezing point liquids have been proposed. However, these composites face challenges due to: (1) autophobicity and dewetting forces [18, 31] that prevent the hydrophobic, low surface energy liquid from spreading evenly to form a continuous film, resulting in the formation of isolated islands and liquid-depleted de-wetted zones; since the coated surface is only partially covered with discontinuous islands of liquid droplets, ice will bond to the areas not covered with the hydrophobic liquid; (2) the impact of rain, which can penetrate through the hydrophobic liquid and chemically bond with polar groups on the substrate surface; and (3) rain erosion or repeated icing/ice removal cycles which strip the low surface energy liquid from the surface; as the low surface energy liquid is depleted from the surface, ice adhesion forces will increase.

The physics of ice adhesion is demonstrated in the following example. When a droplet of water freezes on a glass plate coated with a thin hydrophobic coating or liquid layer, it forms a hemispherical ice droplet with a bottom surface that is parallel to the glass plate. Assuming a zero adhesion force between the ice and the hydrophobic coating or liquid, the force required to remove the ice from the hydrophobic coating or liquid is equal to the atmospheric pressure pushing down on the ice droplet multiplied by the surface area of the bottom of the droplet. Thus, the theoretical minimum force required to remove the droplet of ice is 1.0 kgf/cm² or 1.0×10² kPa based on the assumption that the ice adhesion force is zero. If any ice adhesion force exists between the hydrophobic coating or liquid and the ice, the ice removal force will be greater than theoretical limit. The theoretical ice removal force is coincident with silicone grease, silicone lubricant, and lithium grease, which all show an ice removal force of about 1.0 kgf/cm² or 1.0×10² kPa as measured by centrifuge adhesion tests [7, 23].

Thus, the lowest limit for ice removal force is atmospheric pressure (1.0 kgf/cm²) for any low surface energy material, either solid or liquid. This limit applies to all passive hydrophobic low surface energy coatings [1, 7, 13, 23, 28], superhydrophobic surfaces [4, 10-13, 15, 20, 21, 33, 36], lubricants [3], SLIPS [8, 19, 32, 37], phase change materials [9, U.S. Pat. No. 7,514,017 B2] and active methods (include pneumatic, electro-thermal, heating, and electro-mechanical means). Any claim regarding ice removal forces lower than 1.0 kgf/cm² is highly doubtful.

Discovery: Hydrogen Generation can Detach Ice from Coated Surfaces

To overcome the atmospheric pressure pressing down on ice that has formed on substrates, the present invention chemically generates a layer of gas between the ice and substrate that creates sufficient pressure to separate the ice. The present invention utilizes hydrogen as the gaseous medium since it has the lowest solubility in ice among all gases (0.15 cm³ H₂/g•ice or 1.34×10⁻⁵ g H₂/g•ice −2° C., @ 18.75 atm. [22]; under one atmosphere of pressure and −2° C., hydrogen solubility in ice is 7.1×10⁻⁷ g H₂/g•ice [43]). To fully capture and utilize the pressure exerted by the generated hydrogen, the present invention describes a method to for maximizing the generation of hydrogen nano-bubbles along the interface of the ice and surface of the novel composition and prevents hydrogen from escaping through the liquid phase.

Hydrogen generation for fuel cells has attracted great interest due to possibilities for applications in clean energy. However, catalytic hydrogen generation methods using hydrocarbon, natural gas, ethanol, or methanol typically employ a catalyst that requires activation at high temperatures (>90° C.). Hydrogen-rich materials, such as LiBH₄, LiH, borane, ammonia borane, aminoborane, diborane, borazine, cyclotriborazane, iminoborane, and methylammonium borane are hydrophilic and have high solubility in water. Therefore, these agents will be easily washed away by precipitation. Thus, existing methods for generating hydrogen by employing the aforementioned hydrogen-rich materials are unpractical. There is no available research reporting hydrogen generation using catalytic processes under the extremely low temperatures required for our application.

The present invention discovered that hydride polysiloxane with a multifunctional hydride group, Si—H, is useful for hydrogen generation due to its high percentage of active hydrogen and its safety profile. When a linear chain, branched chain, or ring system is composed entirely of alternating silicon and oxygen atoms, the parent name of siloxane is used. Si—O bonds resist weathering and UV radiation and are highly thermally stable and transparent. Polysiloxane, a polymer of siloxane, can either take a polymer or an oligomer form. Polysiloxane molecules can have linear, branched, cyclic, or dendritic structures. Additionally, polysiloxanes can have linear alkyl, branched alkyl, cyclic, cycloalkyl, or aromatic R groups directly attached to silicon atoms. Polysiloxanes with aromatic groups directly attached to silicon atoms are unstable when exposed to UV or weathering, and thus are not useful in the present invention. Polysiloxanes tend to adopt a helical secondary conformation in which the alkyl and cycloalkyl groups are located on the outside of the helix, thereby shielding the Si—O polar bonds of siloxane. This shielding effect leads to low intermolecular forces between chains and confers properties of high elasticity, water immiscibility, low surface energy, flexibility, a low freezing point, hydrophobicity, and high compressibility.

There are numerous reactive siloxane polymers and oligomers having various reactive functional groups. However, very low molecular weight hydride siloxanes are volatile and have high vapor pressure. Thus, they are not suitable alone for generating hydrogen. On the other hand, hydride polysiloxanes are stable reduction agents. They can easily transfer hydrides to metal centers and are commonly used as reduction reactants in organic synthesis. Hydride polysiloxanes or polysiloxane with mixed hydride and silanol functional groups are hydrophobic, stable under a broad range of temperatures, non-toxic, environmentally friendly, inexpensive, easy to handle, commercially available and have low surface energy, a low freezing point, and low vapor pressure.

In the present invention, a catalytic dehydrogenative coupling reaction between hydride polysiloxane and water is used to generate hydrogen:

≡Si—H+HOH [symbol] ≡Si—OH+H₂↑ (1)

The byproduct silanol (≡SiOH) group participates in dehydrogenetive coupling with the hydride (≡SiH) group leading to the formation of a siloxane (≡Si—O—Si≡) group and generation of hydrogen:

≡Si—H+HO—Si≡ [symbol] ≡Si—O—Si≡+H₂↑ (2)

The net hydrogen generation by the dehydrogenetive reaction between hydride (Si—H) and water is:

2≡Si—H+HOH [symbol] ≡Si—O—Si≡+2H₂↑ (3)

The byproduct silanol (≡SiOH) group also can participate in the condensation reaction to yield water and a siloxane (≡Si—O—Si≡) group:

≡Si—OH+HO—Si≡ [symbol] ≡Si—O—Si≡+H₂O (4)

As the reaction runs its course, the water molecule will be totally converted to hydrogen, and the hydride group (≡Si—H) will become oxidized to a siloxane (Si—O—Si) group. As an example, if all the silicon-hydrogen (Si—H) bonds in a polymethylhydrosiloxane participate in dehydrogenative coupling reactions with water, the reactions can generate 3.3×10⁻² g H₂/g•polymethylhydrosiloxane, or 3.7×10² cm³ H₂/g•polymethylhydrosiloxane. This quantity can saturate 4.6×10⁴ g ice/g•polymethylhydrosiloxane. A layer of polymethylhydrosiloxane that is 0.10 mm thick can release enough hydrogen (3.3×10⁻⁴ g H₂/cm²) to detach 4.6×10² g ice/cm² or 4.6×10² cm of ice. In other words, a layer of the novel coating with the thickness of paper can release enough hydrogen to continuously separate layer after layer of ice up to a height of 4.6 meters.

In the present invention, the preferred reactive hydrogen-rich hydride siloxane includes reactive hydrogen-rich hydride polysiloxane and reactive hydrogen-rich hydride siloxane; said polysiloxane is selected from the group consisting of polydihydrosiloxane, poly(dihydrosiloxane-alt-methylhydrosiloxane), polymethylhydrosiloxane, poly(dihydrosiloxane-alt-ethylhydrosiloxane), polyethylhydrosiloxane, and a mixture thereof; said reactive hydrogen-rich hydride siloxane is selected from C(SiH₃)₄, CH(SiH₃)₃, H₃C(SiH₃)₃, cyclic (H₂SiO)ₘ, cyclic (H₂SiO-alt-MeHSiO)ₙ, cyclic (MeHSiO)ₘ, and a mixture thereof, wherein m is an integer equal to or greater than 2, and n is an integer equal to or greater than 3. Preferred reactive hydrogen-rich hydride siloxanes include preferred hydride polysiloxanes and preferred hydride siloxanes. In the present invention, the term “reactive hydrogen-rich hydride polysiloxanes” includes compositions that have reactive hydrogen-rich hydride polysiloxane as a main component, but may also contain reactive hydrogen-rich hydride siloxane as a minor component.

During the dehydrogenetive coupling reaction of hydride polysiloxane with water molecules, the hydride group (≡Si—H) converts to a silanol (≡Si—OH) group, and yields reactive polysiloxane having hydride (≡Si—H) and silanol (≡Si—OH) groups and a mixed hydride/silanol functional polysiloxane. Hydride groups (≡Si—H) can participate in the dehydrogenative reaction with water or with silanol (≡Si—OH) groups to generate hydrogen. The dehydrogenetive reaction of hydride (≡Si—H) with water yields silanol (≡Si—OH) groups, which convert to siloxane (Si—O—Si) groups via dehydrogenetive reactions to yield hydrogen or via condensation reaction to yield water.

When hydride polysiloxane participates in the dehydrogenative reaction, it may contain various percentages of mixed hydride (≡Si—H) and silanol (≡Si—OH) groups with various ratios of hydride (≡SiH) and silanol (≡SiOH) groups. Therefore, the ratio of hydride groups to silanol groups can vary from the start to the finish of the dehydrogenetive coupling reaction. For simplicity, any references to the hydride polysiloxane reactant refer to the material at the start of the reaction. Similarly, during dehydrogenetive reaction processes, the participating hydride polysiloxane may also contain various percentages of hydride and silanol groups in a mixed polyalkylhydrosilanolsiloxane. Thus, for simplicity, we use starting reactive hydride polysiloxane to elucidate the examples given in the present invention.

Discovery: Reactants for Hydrogen Generation with a Functional Secondary Helical Conformation

Hydride functional or mixed hydride/silanol functional polysiloxane can have various structures: alpha-terminated, alpha-, omega-, di-functional, t-branched trifunctional terminated, or pendant multi-terminated polysiloxane. Examples include mono-functional hydride or silanol, alpha-, omega-, difunctional, t-branched tri-functional, hydride/silanol polydimethylsiloxane; alpha-, omega-, difunctional, t-branched tri-functional hydride/silanol polydiethylsiloxane; and, alpha-, omega-, di-functional terminated, and t-branched tri-functional hydride/silanol dimethylsiloxane-diethylsiloxane copolymer, among others. However, mono-, di-, tri-terminal reactive hydride and mixed hydride/silanol polysiloxanes contain low percentages of Si—H reactive group(s) that are available for dehydrogenative coupling reactions and can generate only limited quantities of hydrogen gas. Therefore, they are not suitable for use in the present invention.

For the purpose of generating hydrogen by dehydrogenative reactions, the preferred hydride polysiloxane is selected from those with a high percentage of Si—H reactive groups, said preferred hydride polysiloxane is selected from the group consisting of trimethylsiloxy terminated polymethylhydrosiloxane homopolymer, triethylsiloxy terminated polymethylhydrosiloxane, tri(tert-butylsiloxy) terminated polymethylhydrosiloxane, trimethylsiloxy terminated dihydrosiloxane-methylhydrosiloxane copolymer, triethylsiloxy terminated dihydrosiloxane-methylhydrosiloxane copolymer, tri(tert-butylsiloxy) terminated dihydrosiloxane-methylhydrosiloxane copolymer, trimethylsiloxy terminated polyethylhydrosiloxane, triethylsiloxy terminated polyethylhydrosiloxane, trimethylsiloxy terminated dihydrosiloxane-ethylhydrosiloxane copolymer, triethylsiloxy terminated dihydrosiloxane-ethylhydrosiloxane copolymer, tri(tert-butylsiloxy) terminated dihydrosiloxane-ethylhydrosiloxane copolymer, and a mixture thereof. Trimethylsiloxy terminated hydride polysiloxanes, such as trimethylsiloxy terminated dihydrosiloxane-methylhydrosiloxane copolymer and trimethylsiloxy terminated polymethylhydrosiloxane homopolymer, have the highest percentage of hydride groups and can generate the most hydrogen. Therefore, they are the preferred hydride polysiloxane for hydrogen generation. In the present invention, preferred reactive hydride polysiloxane molecular structures include linear, branched, cyclic, and dendritic structures. The preferred reactive hydride polysiloxanes have monovalent radical groups directly attached to silicon atoms and the radical group includes linear alkyl, branched alkyl, cyclic, cycloalkyl, cyclohydroalkyl, and cycloalkylhydrodihydro groups.

Hydride polysiloxanes form secondary helical conformations in which the organic group, being oriented on the exterior of helix, can easily rotate around the backbone due to the flexible and high bond angle around the oxygen atom and low glass transition temperature (Tg −120° C.). A study of silica-based micro/mesoporous hybrids of polymethylhydrosiloxane and tetraethoxysilane revealed that a polymethylhydrosiloxane helix can form a polygon with 26 sides of Si—O bonds (with an average bond angle of 166°) and a pitch distance of ˜1.8 nm between the turns [38]. The reactive hydride groups H—Si can be oriented toward the exterior or interior of the helix. When Si—H groups are oriented toward the interior, they provide hydrogen affinity and facilitate hydrogen gas storage. However, since the Si—H bond has an affinity with water, it can quickly switch orientation toward either the interior or exterior of the helical structure, depending on the environment.

Normally, hydride polysiloxane helical conformations have hydrophobic properties due to the large alkyl group located outside the helix. The interior of the helix has hydrophilic properties due to the orientation of the Si—H group toward the interior. When the outside environment changes from hydrophobic to hydrophilic, the H—Si groups quickly switch orientation, such as in the case of contact with water. Under conditions of high atmospheric humidity, when hydride polysiloxane comes into contact with water or ice, the hydride polysiloxane can bring in water molecules and insert them into the interior of the helix via this dynamic switching phenomenon. Since the pitch of hydride polysiloxane is around 2 nanometers, water molecules, which have a diameter of about 0.31 nm, can easily enter between the turns and gain access to the interior of the helical hydride polysiloxane. Once the water molecule is inserted into the interior of helix, it is surrounded with stacked hydrogen silicon bonds in accordance to a “WenXiang Diagram” or helical wheel structure and is well protected from the outside environment. Water stored inside the helical hydride polysiloxane can move around the hydrophobic bulk phase because alkyl groups located outside the helical hydride polysiloxane are hydrophobic and protect the hydrophilic water molecules inside.

When hydride polysiloxanes diffuse from the surface into the bulk phase, water molecules that have been inserted into the interior of the hydride polysiloxane travel across the hydrophobic polysiloxane medium and can reach the catalytic centers on the nanoparticle carriers. Dynamic switching of the orientation of the Si—H group facilitates the transportation of water molecules from atmospheric humidity into the water immiscible, hydrophobic bulk phase. This mechanism makes it possible for water to be brought into the hydrophobic bulk phase and reach the hydrophilic catalytic centers to generate hydrogen, which then pushes against and separates ice from the surface.

Assuming an average bond angle of 166° and 26 sides of Si—O bonds, a polymethylhydrosiloxane helix with a molecular weight of 5K Dalton would have three complete turns. A minimum of three turns is required to store a water molecule in the interior of the helix. Thus, 5K Dalton is the minimum molecular weight for a polymethylhydrosiloxane that has the ability to store and transport a water molecule in a hydrophobic medium. This is consistent with the fact that a low molecular weight (2-3K Dalton) polymethylhydrosiloxane does not show anti-icing properties. A polymethylhydrosiloxane with five complete turns requires a molecular weight of 8 K Dalton. A polymethylhydrosiloxane of 10 K Dalton can have 6.4 helical turns. There is a trade-off between the molecular weight and the mobility of the polymethylhydrosiloxane. For the purposes of our invention, the length must be long enough to accommodate more helical turns without sacrificing mobility. Medium molecular weight hydride polysiloxanes offer an ideal compromise and thus, are preferred for the storage and transport of water molecules in the present invention.

There are at least two distinct considerations for the selection of hydride polysiloxanes in order to obtain optimal anti-icing performance: (1) as the reactant for hydrogen generation, a preferred polymethylhydrosiloxane will have a high mobility, high percentage of hydride (Si—H) functional groups, and a flexible molecular chain with small alkyl groups, which permits less steric hindrance and ease of access to catalytic centers; and (2) for the rapid transport of water molecules from the surface through the bulk phase to the catalytic centers, a preferred hydride polysiloxane will have a suitable helical structure with smallest possible size of alkyl groups to minimize steric hindrance and a medium molecular weight of around 5-12 K Dalton.

The rate of the dehydrogenetive coupling reaction of hydride polysiloxane to generate hydrogen is dependent on the available water that can reach the catalytic centers. The source of water can be from precipitation, such as snow and rain, or atmospheric humidity. Without precipitation or high levels of humidity, the shortage of water will shut down hydrogen generation, thereby preserving the hydride polysiloxane reactant. Thus, the hydrogenation reaction involving the catalytic centers on the nanoparticles is inactive under low atmospheric humidity.

At temperatures well above freezing, the rate of hydrogen generation will accelerate to a critical value, resulting in a rate of hydrogen generation that exceeds the rate of hydrogen dissolution in hydride polysiloxane. The excess hydrogen creates hydrogen nano-bubbles that accumulate on the surfaces of the immobilized catalyst on nanoparticle carriers. These hydrogen nano-bubbles block the hydride polysiloxane reactant and water molecules from accessing the catalytic centers, thus slowing down and then stopping hydrogen generation. This phenomenon provides a mechanism enabling the present invention to shut down hydrogenation under conditions of low humidity or ambient temperatures.

The two main types of atmospheric icing are: (1) precipitation icing (includes freezing precipitation and wet snow), and (2) in-cloud icing (includes clear or glaze, rime and mixed clear and rime icing). Most icing events occur between 0° to −20° C., with over 50% of icing occurring between −8° to −12° C. Freezing rain (supercooled raindrops which freeze upon impact with a cold surface) also occurs within this temperature range. At much lower temperatures, atmospheric humidity levels are very low and icing events are extremely rare; there is a steep drop off in the level of supercooled water in clouds at temperatures lower than −20° C. Thus, for icing to occur, a high level of relative humidity is critical.

There are several common icing scenarios: (1) freezing precipitation falls on a surface whose temperature was initially above freezing and then cools down to below freezing; (2) freezing precipitation falls on a surface whose initial temperature was below freezing; (3) in-flight icing which occurs when passing airframe surfaces seed supercooled droplets in clouds. The amount of accreted ice will depend mainly on humidity, air temperature and the duration of ice accretion. During prolonged exposure to freezing rain or snow, ice will eventually form even if the surface has been treated with a hydrophobic coating without crystallization centers. The adhesion strength of the ice depends on the type of ice. Glaze icing has the strongest bonds with surfaces. This type of icing is very difficult to remove and frequently requires heated glycol to melt. Hydrophobic surfaces without crystallization centers will also experience icing as a result of impact with supercooled water. The impinging of large supercooled water droplets on a solid surface will create crystallization centers via impact force.

For these common icing scenarios, delaying ice formation by eliminating crystallization centers on surfaces will not prevent ice accretion. The optimal coating for preventing ice accretion would separate the ice as soon as it has formed. In all icing events, when water freezes into ice, it can immediately be lifted and stay separated from a hydrogen-generating hydrophobic liquid surface. Wind shear or light mechanical forces can quickly and easily remove any ice that is floating on top of the anti-icing surface, thus requiring no chemical deicers and minimal energy input. Since hydrogen has such negligible solubility in ice, when ice forms, it is forcibly lifted and separated by the generated hydrogen. After separation, the ice is unable to reach the surface to bond again due to the layer of hydrogen that blocks access. For performance across all icing situations, fast hydrogen generation and rapid transport of water molecules to the catalytic centers are critical. Therefore, molecules with low steric hindrance from small alkyl groups and medium length helical configurations are preferred.

Polymethylhydrosiloxane has a long chain structure and a molecular weight between 5K-12K Dalton and is an ideal carrier for water transportation. It has a secondary helical conformation with a diameter of ˜2 to 3 nm and height of ˜5 to 12 nm depending upon molecular weight. Polymethylhydrosiloxane also has other valuable properties suitable for anti-icing applications: low temperature resistance, remains liquid up to a phase transition temperature of −119° C., stable viscosity even in low temperatures, very low thermal conductivity (about ¼ of water), low specific heat (about ⅓ of water), low surface tension, low surface energy, and high water repellency. It is also physiologically inert and environmentally friendly.

### Discovery: Highly Active Catalysts for Hydrogen Generation Under Subzero Temperatures

After many decades of research, homogeneous organometallic catalysis has experienced great advances due to the progress of molecular organometallic chemistry [40, 41, 46]. Homogeneous catalysis, unlike heterogeneous catalysis, has reached a stage of development in which a predictive approach can be utilized for a specific reaction system by well-defined catalytic species. However, since homogeneous catalysis accelerates hydrogen generation across the entire liquid phase, it cannot provide a controlled surface diffusion mechanism. Once a homogeneous catalyst is added into a system, it is very difficult to totally remove and thus can contaminate all surfaces it comes into contact with. Thus, homogeneous catalysts can lead to the instability of hydride polysiloxane. Furthermore, homogeneous catalysts also suffer loss through leaching.

In the present invention, catalytic dehydrogenetive reactions of hydride polysiloxane releases hydrogen that can provide the driving force to detach ice from coated surfaces. For anti-icing purposes, the catalytic dehydrogenative reaction must be carried out under subzero temperatures. Thus, catalysts with very high catalytic activity under subzero temperatures are required.

When atmospheric humidity is low and there is no rain or snow present, the dehydrogenative reaction between hydride polysiloxane and water will cease due to the lack of reactant and water. Under high humidity and temperatures well above 0° C., icing is not an issue. To avoid wasting the hydride polysiloxane reactant, a mechanism is required to stop the catalytic dehydrogenetive reaction when temperatures rise above 0° C. degrees. However, when temperatures increase, reaction rates of all chemical reactions increase due to positive activation energy. Thus, the reaction rates of catalytic reactions will accelerate due to reduced activation energy. A chemical reaction with negative activation energy is unknown.

Reversible heterogeneous catalysts that deactivate under warm temperatures and reactivate under subzero temperatures are desirable, but there is no supporting research or reported cases of their existence. Water solubility in liquid polysiloxane is very low (in the parts per trillion level) and the change in solubility due to temperature variations is negligible. Thus, it is not possible to manipulate the relationship between water solubility and temperature to create a mechanism to start and stop a reaction.

The present invention discovered that heterogeneous catalysis using controlled surface diffusion reactions can provide a constant generation of hydrogen on the interfaces between a reactive liquid and solid catalytic centers that are immobilized on nanoparticles. Water molecules from atmospheric humidity are transported from the coating surface to the hydrophobic bulk phase and finally to the catalytic centers by helical hydride polysiloxane. Since diffusion is inversely proportional to mass and hydride polysiloxane has a large mass, the transport of water molecules happens very slowly, especially at low temperatures. When the dissolution rate of hydrogen is equal to or less than the rate of hydrogen generation, the hydrogen generation is constant and the rate is controlled by the diffusion rate of water and the amount of hydride polysiloxane that reaches the catalytic centers. Thus, the rate of dehydrogenetive catalysis is controlled by the supply of water molecules, which are, in turn, controlled by the rate at which they are transported by the diffused hydride polysiloxane.

The present invention discovered a heterogeneous dehydrogenetive catalytic reaction that can be stopped even under conditions of high humidity and high temperatures. This mechanism circumvents the unnecessary waste of the hydride polysiloxane reactant and is based on these properties: (1) hydrogen solubility in liquid polysiloxane decreases when temperature increases, (2) when temperatures rise, the rate of hydrogen generation is exponentially accelerated and exceeds its rate of dissolution in the liquid phase, creating nano hydrogen bubbles on the surfaces of the catalytic centers, and (3) these hydrogen bubbles separate the catalytic centers from the liquid phase of hydride polysiloxane. Thus, the heterogeneous catalysis reaction stops due to the starvation of reactants. This mechanism provides a temperature-induced “valve” to shut down heterogeneous catalysis and avoid waste of hydride polysiloxane reactant.

Si—H bonds that are activated by noble metals and transition metals are known [40, 46, 49]. The active catalysts are limited: titanocene, bis(cyclopentadienyl)titanium (IV) dichloride, zerconocene, Cp₂ZrCl₂, Cp₂Ti(OPh)₂, magnesium oxide, calcium oxide, Wilkinson's catalyst, Ru(CO)₄, Pt(0)•tetramethyldivinylsiloxane, H₂PtCl₆, [Rh(PPh₃)₃Cl], Pd(PPh₃), Cu(PPh₃)₃, Mo(PMe₃)₆, B(C₆F₅)₃, and [(1,2-bis(diphenylphosphino)ethane)Ni(μ-H)]₂. All of the aforementioned catalysts are active under room temperature, but most organometallic catalysts and ligands are air sensitive. Furthermore, dehydrogenative coupling or dehydrogenetive condensation that can be activated under subzero temperatures is unknown.

The present invention discovered that single-atom or nanocluster of metal, metal hydride, dihydrogen complex of metal, metal boride, and Fe, Co, Ni, Cu, Ru, Ir, Pt, and Os with pincer ligands are highly active dehydrogenetive catalysts under subzero temperatures. Said metal in single-atom or nanocluster of metal, metal hydride, dihydrogen complex of metal, or metal boride is selected from the group consisting of platinum, palladium, ruthenium, rhodium, platinum-palladium (Pt—Pd), iridium, osmium, and a mixture thereof.

The present invention discovered that some metal-containing catalysts are also highly active for dehydrogenetive reactions of hydride polysiloxane. The metal-containing catalyst is selected from the group consisting of Lewis acids based on metal salts, metal atom, metal nano-cluster, dihydrogen complex of metal, metal organic, metal acetate, metal benzoate, metal borate, metal boride, metal bromide, metal carbonate, metal chloride, metal citrate, metal fluoride, metal fluoroalkylsulfonate metal formate, metal hexafluorophosphate, metal hexanoate, metal oxide chloride, metal hydride, metal hydroxide, metal iodide, metal lactate, metal maleate, metal malonate, metal molybdate, metal nitrate, metal oleate, metal oxide, metal oxide with reduced valence, metal nitrate, metal oxalate, metal oxide, metal oxide nitrate, metal perchlorate, metal perfluoroalkylsulfonate, metal phosphate, metal salicylate, metal sebacate, metal selenide, metal stearate, metal sulfate, metal sulfide, metal tartrate, metal teflate, metal telluride, metal tetrafluoroborate, metal tetrakis(pentafluorophenyl)boranate [B(C₆F₅)₄]⁻, metal triflate (trifluoromethanesulfonate), metal tungstate, and a mixture thereof; said metal element is selected from the group consisting of Sc, Y, La, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and a mixture thereof. Electron-deficient boranes, such as tris(pentafluorophenyl)borane B(C₆F₅)₃, are able to catalytically activate Si—H bonds through η¹ coordination and are also useful catalysts without metal elements. Since single-atom or nanocluster catalysts have high dispersion, a very small amount of catalyst can cover a large surface area. Thus, it can be economic to use higher priced catalysts such as noble metals.

### Discovery: Highly Active Catalytic Centers for Hydrogen Generation on Highly Dispersed Inorganic Nanoparticle Carriers

Due to high specific surface area, highly dispersed inorganic nanoparticles are well suited as carriers for immobilizing highly active and stable catalytic centers. There are two types of methods for nanoparticle synthesis that are low-cost, high yielding, simple and continuous: gas (vapor) phase spray pyrolysis and liquid phase sol-gel and solvothermal synthesis. Commercial nanoparticle products are produced by the ton. The particle size distribution, geometry, final particle size after de-agglomeration, surface area, uniformity, and dispensability all depend on the nature of the powder and the manufacturing methods.

Typically, commercially available fine powders are agglomerated nano/micro particles. Most nano-scale metal oxides produced by pyrogenic processes are particle aggregates of primary nanoparticles within the size range of 10-200 nm. Amorphous metal oxide powders made by the hydrolysis of vaporizable metallic precursors in an oxyhydrogen flame can produce very fine metal oxide powders called fumed oxides. Amorphous silicon oxide made by hydrolysis of silicon tetrachloride in a hydrogen/oxygen flame is called fumed silica. For example, EVONIK provides fumed alumina, fumed titanium, fumed zirconia, and fumed cerium oxide under Aeroxide® and fumed silica under Aerosil® trade names. Aeroxide® aluminum oxide Alu C has a specific surface area of 100 m²/g and Alu 130 has a specific surface area of 130 m²/g. Aeroxide® titanium oxide P90 has a specific surface area of 90±20 m²/g and primary particle size of approximately 14 nm; Arosil® 380 has a specific surface area of 380 m²/g; Arosil® 200 has a specific surface area of 200 m²/g and an average primary nanoparticle size of 12 nm, with an average aggregate size of 10.5 nm.

Top-down attrition/milling of naturally occurring mineral sediment produces a broad particle size distribution, varied particle shape or geometry, and a high level of impurities. Thus, these products are very difficult to utilize in a transparent composition and are not preferred in the present invention. A transparent composition with optical clarity can be achieved if the sizes of catalyst carrier can be dispersed to 10-20 nm by de-agglomeration. For high quality fumed metal oxides, the de-agglomeration process is very easy or oftentimes unnecessary. High shear energy breaks down agglomerated particles into primary nano/micro-particles with high efficiency. Preferred de-agglomeration methods include, but are not limited to, wet mills (including bead, ball, stirred media, centrifugal and jet mills), high-pressure homogenizers, ultrasonication baths, ultrasound probe sonication, and ultrasonic disruptor sonication.

A fibrous silica nanosphere was very recently discovered that uses a liquid phase synthesis method [29, U.S. Pat. No. 8,883,308 B2]. This spherical nanoparticle has a high specific surface area and comprises of a plurality of silica fibers that are radially oriented around the nanoparticle. It can be conveniently prepared in laboratory settings and has the advantages of a high percentage of accessible surface area and high mechanical, thermal and hydrothermal stability. However, since the synthesis method uses surfactants, a calcination step is required to remove surfactant contamination for use in the present invention. After calcination, silica nanoparticle surfaces will be densely covered with hydroxyl groups; at least 5 different types of hydroxyl Si—(OH)ₙ groups, Si—O—Si bridges, and Lewis acid sites will be left on the surfaces. Such highly dense surface hydroxyl groups react very actively with organometallic complexes.

The present invention discovered that highly active heterogeneous catalytic centers for dehydrogenetive coupling of hydride polysiloxane can be prepared by immobilizing a metal-containing compound on a highly dispersed nanoparticle in a suitable medium. Nanofibers made by various methods, such as electrospinning, with nanometer (<20 nm) diameters can also be used for immobilizing catalyst carriers.

In the present invention, a suitable nanoparticle to serve as a catalyst carrier can be selected from the group consisting of fumed aluminum oxide (Al₂O₃), fumed cerium oxide (Ce₂O₃), fumed ferric oxide (Fe₂O₃), fumed lanthanum oxide (La₂O₃), fumed magnesium oxide (MgO), fumed silica (SiO₂), fumed titanium oxide (TiO₂), fumed zirconium oxide (ZrO₂), fibrous silica nanospheres, alumina nanofibers, lithium titanate nanofibers, silica nanofibers, titania nanofibers, zirconia nanofibers, cellulose nanofibers, collagen nanofibers, chitosan nanofibers, gelatin nanofibers, elastin nanofibers, silk fibroin nanofibers, wheat protein nanofibers, and a mixture thereof.

A useful reaction medium for immobilizing the metal-containing catalyst onto the surface of the nanoparticle carrier can be selected from the group consisting of water, aqueous alcohol, denatured alcohol, acetone, methyl acetate, tert-butyl acetate, methylene chloride, methyl chloroform, parachlorobenzotrifluoride, acetonitrile, acetophenone, amyl acetate, benzyl benzoate, bis(2-ethylhexyl) adipate, butanone, butyl acetate, sec-butyl acetate, tert-butyl acetate, n-butyl propionate, gama-butylolactone, chloroform, cyclohexanone, cyclopentanone, dichloromethane, diethyl carbonate, diethyl ketone, diisobutyl ketone, dimethoxyethane, dimethyl ether, dimethylglycol dimethyl ether, dimethyl cellosolve, dimethyl carbonate, N,N-dimethylacetamide, N,N-dimethylformamide, dimethyl sulfoxide dioctyl terephthalate, 1,4-dioxane, 2-ethoxyethyl ether, ethyl acetoacetate, ethyl butyrate, ethyl lactate, ethylene carbonate, cyclobutanone, cyclohexanone, cyclopentanone, ethyl isopropyl ketone, hexyl acetate, isoamyl acetate, isobutyl acetate, isobutyl isobutyrate, isopropyl acetate, isophorone, methyl acetate, methyl amyl acetate, methyl butyl ketone, methyl chloroform, methyl isoamyl ketone, methyl isobutyl ketone, methyl isopropyl ketone, methyl propyl ketone, 1-metal-2-pyrrolidinone, octyl acetate, parachlorobenzotrifluoride, perchloroethylene, 3-pentanone, n-pentyl propionate, beta-propyolactone, tetrahydrofuran, toluene, delta-valerolactone, xylene, cyclic methylated siloxanes, branched methylated siloxanes, linear methylated siloxanes, tetrahydrofuran, N,N-dimethylformamide, N,N-dimethylacetamide, 1-methyl-2-pyrrolidone, and a mixture thereof. Type 3A molecular sieves, dried silica, or dried alumina can be used to dry dehydration solvents. To obtain a solvent without trace water content, distillation in the presence of metal sodium, calcium hydride (CaH₂), or tetra phosphorus decaoxide is required. The useful concentration of reactive organometallics in the reaction medium ranges between 0.001 to 5 moles.

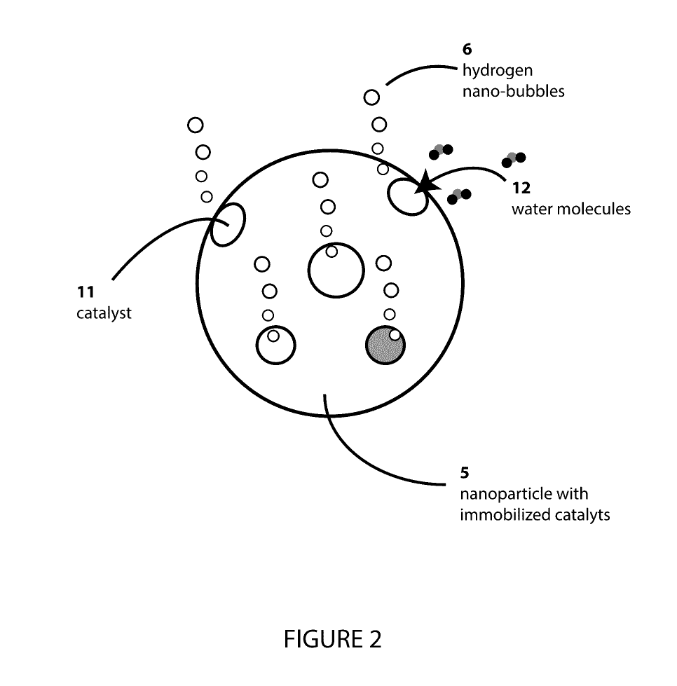

In the present invention, said immobilized catalysts are catalysts immobilized on a nanoparticle carrier (see FIG. 2), said catalyst is selected from the group consisting of metal atom, metal nano-cluster, dihydrogen complex of metal, metal organic, metal acetate, metal benzoate, metal borate, metal boride, metal bromide, metal carbonate, metal chloride, metal citrate, metal fluoride, metal fluoroalkylsulfonate, metal formate, metal hexafluorophosphate, metal hexanoate, metal oxide chloride, metal hydride, metal hydroxide, metal iodide, metal lactate, metal maleate, metal malonate, metal molybdate, metal nitrate, metal oleate, metal oxide, metal oxide with reduced valence, metal nitrate, metal oxalate, metal oxide, metal oxide nitrate, metal perchlorate, metal perfluoroalkylsulfonate, metal phosphate, metal salicylate, metal sebacate, metal selenide, metal stearate, metal sulfate, metal sulfide, metal tartrate, metal teflate, metal telluride, metal tetrafluoroborate, metal tetrakis(pentafluorophenyl)boranate [B(C₆F₅)₄]⁻, metal triflate (trifluoromethanesulfonate), metal tungstate, and a mixture thereof; and said metal element is selected from the group consisting of Sc, Y, La, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and a mixture thereof.

The catalyst can be immobilized onto nanoparticles surfaces by (1) heating the nanoparticle carrier in a vacuum to remove adsorbed water, (2) saturating the nanoparticle with amine or ammonia, (3) treating the amine or ammonia saturated nanoparticle with a volatile metal halide, metal hydride, or an organometallic, and (4) reduction by heating using hydrogen, hydride, LiBH₄, NH₃BH₃•borane, or hydride siloxane.

Heterogeneous catalytic centers can also be formed on nanoparticles surfaces using a liquid phase impregnation process. An example of grafting a heterogeneous catalyst on a nanoparticle carrier using a liquid phase treatment involves: (1) de-agglomerating the nanoparticle carrier in a dried solvent to remove adsorbed water, (2) impregnating the solution with a metal-containing catalyst, (3) removing excess solution, and (4) reduction by heating using hydrogen, hydride, LiBH₄, NH₃BH₃, borane, or hydride siloxane.

Heterogeneous Lewis acid catalytic centers on metal oxide nanoparticle surfaces are also highly active dehydrogenetive coupling catalysts for hydride polysiloxane under subzero temperatures. Such Lewis acid catalytic centers on highly dispersed inorganic carriers can be prepared by impregnating metal oxide nanoparticles with a metal salt solution in a solvent or in water followed by drying under reduced pressure or a vacuum to remove the volatile water or solvent. An example for grafting heterogeneous Lewis acid catalytic centers on metal oxide nanoparticle surfaces using a liquid phase treatment involves: (1) de-agglomerating the nanoparticle carrier in water or a solvent, (2) impregnating the solution with a metal-containing catalyst, (3) removing excess solution, and (4) activating the Lewis acid under air, oxygen, or an inert atmosphere using mild heating.

In the present invention, a preferred immobilized catalyst is a water tolerant, Lewis acid catalyst based on a metal salt that is immobilized on a nanoparticle carrier, said metal salt is selected from metal acetate, metal bromide, metal borate, metal chloride, metal oxide chloride, metal citrate, metal fluoroalkylsulfonate, metal fluoride, metal fluoroalkylsulfonate, metal formate, metal hexafluorophosphate, metal hexanoate, metal iodide, metal lactate, metal maleate, metal malonate, metal nitrate, metal oxide nitrate, metal oleate, metal oxide, metal perchlorate, metal perfluoroalkylsulfonate, metal salicylate, metal sebacate, metal stearate, metal sulfate, metal tartrate, metal teflate, metal tetrafluoroborate, metal tetrakis(pentafluorophenyl)boranate [B(C₆F₅)₄]⁻, metal triflate (trifluoromethanesulfonate), and a mixture thereof, said metal element in the metal salt is selected from the group consisting of Sc, Y, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and a mixture thereof.

Organometallic complexes comprise of a vast array of metals, metals in different oxidation states, and ligands. Typically, organometallic complex catalysts have a reaction center of a metal atom (ion) coordinated with ligands (“spectator ligands” or “control ligands”). Varying these ligands by tuning the electronic and/or steric relationship at the reaction center can optimize catalysis with respect to activity, selectivity and stability.

In the present invention, organometallic complexes can also serve as highly active catalysts for dehydrogenetive reactions of hydride polysiloxane when immobilized on a nanoparticle carrier. Said organometallic complex catalyst comprises of a metal element atom (ion) coordinated with at least a ligand, said metal element is selected from the group consisting of Ru, Rh, Pd, Os Ir, Pt, Sc, Y, Ti, Zr, Hf, V, Nb, Ta, Cr, Mo, W, Mn, Fe, Co, Ni, Cu, Ag, Au, Zn, Sn, lanthanides (La, Ce, Pr, Nd, Pm, Sm, Eu, Gd, Tb, Dy, Ho, Er, Tm, Yb, Lu), and a mixture thereof said ligand is selected from the group consisting of H, Cl, F, OH, OR, CN, CH₃, CR₃, NO, NO₃, CO, PR₃, NH₃, CRR′ (carbine), CNR, ═O, ═S, ≡N, η³-C₃H₅ (π-allyl), CR (carbyne), acetyl, acetonitrile, acetylene, acetylacetonate, acetylacetonato, acetylacetone, acetyl, acyl, adamantyl, alkyl, allyl, aryl, η³-benzyl, biarylmonophosphine, biguanide, BINAP, BINOL, binaphthyl monophosphine, biphynylphosphino-2,2-binaphthyl, 2,2′-dibypyridine, 2,2′-bipyridine-based [16], bis(arylphosphane), 1,2-bis(dimethylphosphino)ethane, 1,2-bis(diphenylphosphino)methane, bis(phosphane), chiral bis(phosphane), chiral bis(phosphane/phosphite), bis(phosphinite), 1,2-bis(diphenylphosphino)ethane, bis(diphynylphosphino)methane, 1,3-bis(diphenylphosphino)propane, 2,6-bis(imino)pyridine, bis(phospholane), N,N′-bis(salicylidene)ethylenediamine, 9-borabicyclo[3,3,1]]nonane, buta-1,3-diene, tert-butyldimethylsilyl, carbene pincer ligands [5], carbonyl, corrole, crown ether, η⁴-cyclopentadienone, η⁵-C₅H₅ (cyclopentadienyl), η⁶-C₆H₆ (benzene), η⁷-C₇H₇ (cycloheptatrienyl), cyclohexyl, cycloocta-1,5-dienene, cyclododeca-1,5,9-triene, diaminocyclohexane, dialkyl tartrate, diaza, dibenzylideneacetone, dicyclopentadiene, diethylenetriamine, dimethylglyoxime, dimethylglyoximato, 1,2-divinylcyclobutane, (S,S)-Diop, diop, 2,2′-dipyridine, dppb, dppe, dppf, dppn, dppp, dppx, dppdpe, dppn, H₂C═CH₂ (ethylene), divinyltetramethyldisiloxane, Duphos, EDTA, ethylenediamine, ethylenediaminetetraacetic acid, hyrdido tris(3,5-dimethylpyrazolyl) borate, hydrido tris(pyrazolyl) borate, N-hetrocyclic carbine, hexamethylphosphoric acid triamide, η⁵-hydroxycyclo tris(pentafluorophenyl), η⁵-indenyl, isothiocyanate, mesityl, oxalate, oxalate, η⁵-C₅Me₅ (pentamethylcyclopentadienyl), phen, 1-, 10-phenanthrolin, phenoxy-imine, phosphine, phthalocyanine, phosphane/phophite, 2-(phosphinophenyl)oxazoline, pincer ligand: (CCC, CCN, CNC [30], CNN [6], CNO, NCN [2], NCP, NNN [14], NHC[5], NNO, ONO, PCP, PNP, PSiP, SCS, SNS), propylenediamine, pyridine, (R,R)-DIPAMP, 4,4′-tert-butyl-2,2′-bipyridine, tolyl, p-toluenesulfonic acid, trifluorosulfonic acid, tertamethyldivinylsiloxane, 2,4,6,8-tetramethyl-2,4,6,8-tetravinylcyclotetrasiloxane, N,N,N″,N″-tetramethylethylenediamine, 4,4′-tert-butyl-2,2′-bipyridine, thiazolidine, thiourea, TACN, TMEAA, TMEDA, TPZ, triaminotriethyamine, triehtylenetetramine, triphenyl phosphine, tris(3,5-dimethylpyrazolyl) borate, tris(pentafluorophenyl) borane, 1,2,3-tris(pentafluorophenyl)-4,5,6,7-tetrafluoro-1-boraindene, tris(oxazolinyl)phenyl borate, tris(pyrazolyl)borate, 4-vinylcyclohex-1-ene, TTCN, urea, xantphos and a mixture thereof.

Surface bonding by impregnation is a simple technique for immobilizing transition metal complexes. It can be done either in vapor phase or in liquid phase. Vapor phase saturation utilizes a volatile metal complex. The following method can be utilized: (1) evacuation of a nanoparticle carrier under a vacuum to expedite the total penetration into porous surfaces of nanoparticles, (2) saturating nanoparticles with a metal complex in the vapor phase, (3) drying under an inert atmosphere, and (4) activating the catalyst.

Liquid phase impregnation uses a non-volatile metal complex. The following steps may be followed: (1) de-agglomerating in a solvent, (2) impregnating nanoparticles with a metal complex solvent solution, (3) removing excess solution, (4) drying under an inert atmosphere, and (5) activating the catalyst.

Since inorganic oxides, such as Al₂O₃, Ce₂O₃, Fe₂O₃, MgO, SiO₂, TiO₂, and ZrO₂, have high concentrations of surface hydroxyl groups, metal complexes will lose ligands and the metal atom will directly bond to the oxide, thereby altering catalytic activity. Due to the high density of hydroxyl groups on the metal oxide surface, coordination spheres around the central metal atom of the organometallic complex will vary according to the different types of active surface hydroxyl groups, Me-O-Me bridges, and Lewis acid sites. When surface hydroxyl groups react with the organometallic complex, ligand(s) of the organometallic complex will be partially lost and metal atoms of the organometallic complex will directly bond to the surface oxygen atoms to form an immobilized organometallic complex on the surface. The fragments of the immobilized organometallic complex on the nanoparticle surface will act as “catalytic centers”. During catalytic dehydrogenetive reactions in the presence of hydride polysiloxane, the “catalytic centers” may convert to immobilized “catalytic centers” of a metal hydride complex if the ligand undergoes reduction, hydrosilylation or hydrogenation reactions.

There are several methods for immobilizing a metal-containing catalyst on nanoparticle surfaces including: (1) Direct reaction with metal-containing catalyst precursor or metal-containing salt solution by impregnation, followed by a chemical or heat treatment; and, (2) a silane mediated method by modifying hydroxyl groups on nanoparticle surfaces with a silane coupling agent first, followed by reacting with a metal-containing salt solution. For example, metal carbonyl complexes can be immobilized on metal oxide surfaces by direct impregnation. Hydrogenation of metal carbonyl using hydride siloxane will convert it into a “catalytic center” of metal hydride.

Surface silylation is a useful surface treatment method in the present invention. The preferred surface treatment agent is functional silane or functional polysiloxane. Functional silanes, as coupling agents, contain two types of functional groups: 1) silicon bonded hydrolyzable group or methoxy, ethoxy, or acetoxy groups, shown as Si—(OR)₃, Si—(OR)₂, or Si—OR, and 2) hydrocarbon linker bonded organofunctional groups. Each Si—OR bond hydrolyzes readily with water from humidity or from a reaction medium, resulting in a silanol group. Acids and alkalis accelerate the rate of hydrolysis. Hydrolysis of hydrolysable silane requires water, which can be obtained from the addition of water, moisture in the atmosphere, or an existing concentration of water in solvents. Silanol functional groups can condense (via coupling) with surface hydroxyl Me-(OH)ₙ groups in metal oxides. The condensed silanol groups react with hydroxyl surface groups to form two dimensional (2D) siloxane Si—O-Me surface bonds. Condensation reactions of silanol groups are catalyzed by organometallics, such as titanate and tin complex. The silanol condensation, polymeric 2D or 3D siloxane networks, and thickness of siloxane networks vary depending on the reactive medium, water content, pH value, temperature, substrate, silane substitutes, and catalysts.

Immobilizing heterogeneous catalytic centers on metal oxide nanoparticle surfaces can be done sequentially using the following steps: (1) heating nanoparticles under a vacuum to remove adsorbed water, (2) treating nanoparticles with gas phase amine or ammonia, (3) reacting the amine or ammonia saturated nanoparticles with a liquid phase hydrolyzable silane solution, (4) treating silylated nanoparticles with liquid phase organometallic, and (5) heating under an inert or hydrogen atmosphere.

In preparation for the immobilization of organometallic complexes to create the desired catalytic centers, the first step is surface coupling using a silane with organofunctional ligands to convert hydroxyl Me-OH groups, Me-O-Me bridges, and Lewis acid sites to the desired ligands. A coupling silane having a hydrolyzable —Si(OR)₃ group and a desired ligand with a hydrocarbon linker to connect to a —Si(OR)₃ group can be used for the desired coupling reaction; for example: B(C₆F₅)₃, cyclopentadienyl, a pentamethylcyclopentadienyl ligand, a bipyridine ligand, a CNN-pincer ligand, a NCN-pincer ligand, or a triphenylphosphine ligand having a hydrocarbon linker bonded to Si(OCH₃)₃. Treatment of metal oxide nanoparticles with a silane coupling agent and then reacting via ligand exchange with an organometallic complex results in organometallic catalysts that can perform the required catalytical dehydrogenative reaction of hydride polysiloxane.

A general method for obtaining an immobilized organometallic complex with desired ligands on a metal oxide nanoparticle surface is as follows: 1) synthesize a silane having a desired ligand as the terminal group, 2) treat metal oxide nanoparticles with the synthesized silane, and 3) react silane treated metal oxide nanoparticle surfaces with an organometallic complex via ligand exchange.

This process provides an immobilized organometallic catalyst having a central atom (ion) with a well-defined ligand coordination sphere around the metal and a siloxane bridged ligand group bonded to the metal oxide surface. The resulting uniformly distributed, immobilized organometallic catalyst species is attached to the substrate surface through linkers and provides predictable repeated catalytic activity with selectivity and longevity.

The reactive group of a hydrocarbon linker of an air and water stable ligand can be designed to react with functional silane to form a chemical bond. For example, a CNN-pincer ligand with a C₃-C₈ hydrocarbon linker with end hydroxyl groups can react and bond to isocyanate functional silane silylated nanoparticles. Another example is a pentamethylcyclopentadienyl ligand having a C₃ hydrocarbon linker with end amino groups that can react and bond to glycidoxypropyl functional silane silylated nanoparticles.

A convenient method for obtaining an immobilized organometallic complex with desired ligands on a metal oxide nanoparticle surface is as follows: 1) synthesize a ligand with a hydrocarbon linker having an end reactive group, 2) select a silane having a terminal group designed to react with the reactive group on the ligand and use this selected silane to treat metal oxide nanoparticles, and 3) react the silane treated metal oxide nanoparticle surfaces with a metal complex containing the synthesized ligand.

The specific silane bearing a desired reactive group with a hydrocarbon linker can be selected for reacting with a reactive end group of a synthesized ligand. The silane could also be selected for synthesizing a ligand-bearing silane with hydrolyzable silane groups. For example, the following functional silanes can be used to synthesize ligand-bearing silanes by undergoing a coupling reaction: allyl, acrylyl, acryloxy, methacrylyl, methacryloxy, styryl, and vinyl, which all have the most active unsaturated groups. Amino is a versatile reactive group. For example, amine undergoes Michael addition with acrylate. The amine group reacts with halogen and forms imino coupling. Acyl halide or acid anhydride reacts with amine to give amide. Aldehyde and ketone reacts with primary or secondary amine to form imine. Amine reacts with a carboxylic acid derivative to give amide. The amino group in aminoalkyl silane or siloxane reacts with an isocyanato group to form a urea link. Epoxies, such as glycidoxypropyl, epoxycyclohexyl, are also versatile reaction groups. Epoxy undergoes cationic ring opening addition activated by hydrogen to produce a new chemical bond and hydroxyl group. Amines, hydroxy acids, anhydrides, Lewis acids, imidazoles and imides are common active hydrogen reactants. Silanol reacts with hydride, acetoxy, enoxy, oxime, alkoxy, and amine to form siloxane links. Silanol also undergoes dehydrogenative coupling with the hydride functional group of silane or siloxane. Isocyanato groups are also very active. They form urethane with hydroxyl groups and form urea with primary and secondary amines.

There are thousands of functional silanes that are commercially available. Silanes with many different hydrocarbon linker bonded organofunctional groups are readily available, such as acrylate, methacrylate, acryloxy, aldehyde, allyl, anhydride, amino, alkanolamino, anhydride, azide, azolyl, carbene, carbinol, carboxy, chloro, cyclopentadienyl, diamino, dihydroimidazole, diimino, dipodalamino, epoxy, ester, glycidoxy, halogen, hydroxyl, isocyanato, mercapto, methacryloxy, phosphine, phosphate, phosphonate, porphyrin, silanol, solfido, sulfine, sulfur, sulfonate, tertiaryamino, triamino, vinyl, and vinylide.

The preferred silanes for the present invention are the following: allyltrimethoxysilane, allyltriethoxysilane, 3-acryloxypropyl trimethoxysilane, 3-aminopropyltrimethoxysilane,4-aminobutyl triethoxysilane, 3-aminopropyl tris(methoxyethoxyethoxy)silane, 11-amino-undecyl triethoxysilane, 3-aminopropylmethyl dimethoxysilane, 3-aminopropyldiisopropyl ethoxysilane, N-(2-aminoethyl)-3-aminopropyl trimethoxysilane, N-(2-aminoethyl)-11-aminoundecyltrimethoxysilane, N-(2-aminoethyl)-3-aminoisobutylmethyldimethoxysilane, N-(2-aminoethyl)-3-aminopropylmethyldimethoxysilane, N-(2-aminoethyl)-3-aminopropyltrimethoxysilane, N-(6-aminohexyl) aminopropyltrimethoxysilane, m-aminophenyltrimethoxysilane, p-aminophenyltromethoxysilane, 3-aminopropyltrimethoxysilane, 1,2-bis[(trimethoxysilyl)propyl]ethylenediamine, azidosulfonylhexyl triethoxysilane, bis(trimethoxysilyl) octane, bis(trimethoxysilylpropyl) amine, N-butylaminopropyl trimethoxysilane, 3-chloropropyl triethoxysilane, 3-chloropropyl trimethoxysilane, N-cyclohexylaminopropyl trimethoxysilane, N-ethylaminoisobutyl trimethoxysilane, 3-glycidopropyl trimethoxysilane, 2-(3,4-epoxycyclohexyl)ethyl trimethoxysilane, 2-(3,4-epoxycyclohexyl)ethyl trimethoxysilane, (3-glycydoxypropyl) triethoxysilane, (3-glycydoxypropyl) trimethoxysilane, hexenyltriethoxysilane, N-(hydroxyethyl)-N-methylaminopropyl trimethoxysilane, bis(2-hydroxyethyl)-3-aminopropyl triethoxysilane, 3-hydroxypropyl trimethoxysilane, 3-isocyanatopropyl triethoxysilane, 3-isocyanatopropyl trimethoxysilane, 3-methacryloxypropyl trimethoxysilane, N-methylaminopropyl trimethoxysilane, 3-mercaptopropyl trimethoxysilane, 3-thioisocyanatopropyl trimethoxysilane, bis(triethoxysilyl)ethane, bis-(trimethoxysilylpropyl)amine, bis-[3-(triethoxysilyl)propyl]tetrasulfide, bis(trimethoxysilylpropyl)amine, 3-(triethoxysilyl)propyl succinic anhydride, ureidopropyl triethoxysilane, ureidopropyl trimethoxysilane, vinyltriacetoxysilane, vinyltriethoxysilane, vinyltrimethoxysilane, (aminoethylamino)-3-isobutyldimethylsilane, isobutyldimethylmethoxysilane, 5-(bicycloheptenyl)trimethoxysilane, 3-bromopropyltrimethoxysilane, 11-bromoundecyltrimethoxysilane, N-cyclohexylaminopropyltrimethoxysilane, [2-(3-cyclohexyl)ethyl]trimethoxysilane, (3-glycidoxypropyl)trimethoxysilane, 3-(2-imiddazolin-1-yl)propyltrimethoxysilane, 3-mercaptopropyltrimethoxysilane, 7-octenyltrimethoxysilane, N-phenylaminopropyltrimethoxysilane, o-(propargyloxy)-N-(triethyxysilylpropyl)urethane, 2-(4-pyridythyl)triethyxysilane, 3-thiocyanatopropyltriethoxysilane, (3-triethoxysilylpropyl)-t-buthycarbamate, (triethoxysilylpropyl)dihydro-3,5-furandione, 7-triethoxysilylpropoxy-5-hydroxyflavone, N-(3-triethoxysilylpropyl)-4,5-dihydroimidazole, N-(3-triethoxysilylpropyl)-4-hydroxybutyramide, N-(3-triethoxysilylpropyl)gluconamide, N-triethoxysilylpropyl)dansylamide, and N-triethoxysilylpropyl-O-quinine urethane, or a mixture thereof.

The following are useful siloxanes or polysiloxanes for immobilizing organometallics in the present invention: alpha, omega-di-[(N-ethyl)amino(2-methyl)propyl]polydimethylsiloxane; alpha, omega-di[(N-methyl)amino(2-methyl)propyl]polydimethylsiloxane, epoxypropoxypropyl terminated polydimethylsiloxanes; (epoxypropoxypropyl methylsiloxane)-dimethylsiloxane copolymer; (epoxycyclohexylmethylsiloxane)-dimethylsiloxane copolymer; epoxycyclohexylethyl terminated polydimethylsiloxane; hydroxypropyl terminated polydimethylsiloxanes; methacryloxypropyl terminated polydimethylsiloxane; 3-acryloxy-2-hydroxypropoxypropyl terminated polydimethylsiloxane; acryloxypropylmethylsiloxane-dimethylsiloxane copolymer; succinic anhydride terminated polydimethylsiloxane; carboxyalkyl terminated polydimethylsiloxane, mercaptopropylmethylsiloxane-dimethylsiloxane copolymer, chloromethyl terminated polydimethylsiloxane, and chloropropylmethylsiloxane-dimethylsiloxane copolymer, or a mixture thereof.

The following are useful organtitanates for immobilizing metal-organic complexes in the present invention: titanium di-n-butoxide (bis-2,4-pentanedionate), titanium diisopropoxide (bis-2,4-pentanedionate), titanium diisopropoxide bis(ethylacetoacetate), titanium (bis-2,4-pentanedionate), titanium (bis-2,4-pentanedionate), titanium 2-ethylhexoxide, and titanium trimethylsiloxide. The following are examples of useful organozirconates for the present invention: zirconium tetrakis(2,4-pentanedionate) complex and dialkylzirconium dionate, or a mixture thereof. The following are useful organoaluminates for immobilizing metalorganics in the present invention: aluminum dionate, aluminum tris(2,4-pentanedionate) complex, or a mixture thereof.

### Discovery: Grafted Nanobrushes can Overcome Autophobicity and Dewetting Forces

It is known that autophobicity and dewetting forces are obstacles that prevent low surface energy liquids from spreading evenly across solid surfaces to form a continuous film. Many commercial glass surfaces have been treated with a non-functional alkyl or fluoroalkyl silane to increase hydrophobicity, which creates a glass surface with high autophobicity. Commonly used silanes for hydrophobic surface treatments are tert-butyldimethylchlorosilane, tert-butylmethyldichlorosilane, tert-butyltrichlorosilane, tert-butyldimethylmethoxysilane, tert-butyldimethylethoxysilane, tert-butylmethyldimethoxysilane, tert-butyltrimethoxysilane, (3-heptafluoroisopropoxy) propyltrichlorosilane, nonafluorohexyltrichlorosilane, nonafluorohexyltrimethoxysilane, pentafluorophenyldimethylchlorosilane, pentafluorophenyltichlorosilane, pentafluorophenylpropyldimethylchlorosilane, pentafluorophenylpropyltrichlorosilane, pentafluorophenylpropyltrimethoxysilane, perfluorohexylethyltriethoxysilane, and p-trifluoromethyltetrafluorophenyltriethoxysilane. The most durable hydrophobic surface treatments use tert-butyldimethylchlorosilane or tert-butyldmethylmethoxysilane. Alkyl silane residue on glass surfaces is very difficult to remove and high molecular weight polysiloxanes cannot be grafted onto treated surfaces until all traces of silane residue is completely removed.

The present invention discovered that 2D alkyl or fluoroalkyl silane surface networks can be removed by treating with an alkali alcohol solution made by saturating solid KOH with an aqueous alcohol, such as aqueous ethanol or various denatured industrial alcohols which are mixtures of ethanol with methanol, isopropanol, acetone, methyl ethyl ketone, or methyl isobutyl ketone. One method of removing surface silanes is by soaking the surface in an alkali alcohol solution for about one hour, followed by rinsing with water. A second method is treatment with an absorbent alkali paste and comprises of the following steps: (1) create the alkali paste by mixing solid absorbents such as diatomaceous earth with KOH, NaOH, potassium triphosphate, or sodium triphosphate and adding water until it reaches a paste-like consistency; (2) thoroughly cover treatment surfaces and allow to sit for at least 24 hours; and (3) rinse treatment surfaces with water. After removing surface alkyl or fluoroalkyl silane residue, the surface will change from being autophobic to hydrophilic, allowing it to be used as a substrate for the ice release composition of this invention.

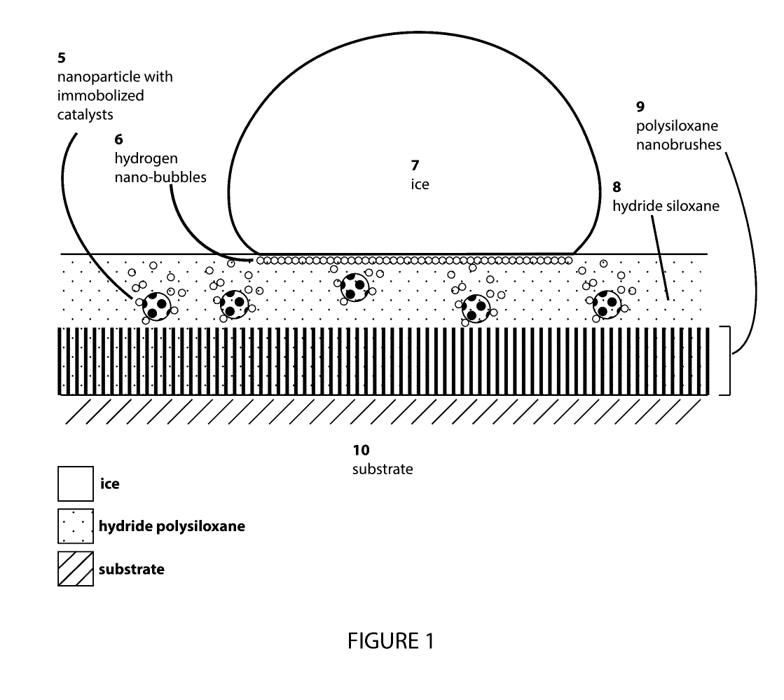

The present invention discovered that high molecular weight, reactive polysiloxane can form high molecular weight polysiloxane brushes on clean substrate surfaces (see FIG. 1). These grafted high molecular weight polysiloxane brushes can hold on to liquid phase hydrophobic hydride polysiloxane through intermolecular helix-helix interactions, thereby overcoming autophobicity and dewetting forces to allow for a continuous hydride polysiloxane surface film.

Glass, metal oxide, and many other inorganic substrates have a high concentration of reactive or polar groups, which serve as strong ice bonding sites, such as hydroxyl Me-OH (isolated), HO-Me-O-Me-OH (vicinal), HO-Me-OH (germinal), Me-O-Me (bridge), and Lewis acids sites, where Me represents metal atoms such as Si, Al, Mg, Fe, Ca, etc. The reactive groups in functional polysiloxane undergo many reactions accelerated by metallic salts, organometallics, acids, or alkalis.

There are two preparation methods for grafting high molecular weight, end-grafted polysiloxane brushes on substrate surfaces: (1) direct reaction of high molecular weight reactive polysiloxane with reactive groups on substrate surfaces in the presence of a catalyst, or (2) modification of the reactive group on substrate surfaces with a functional silane coupling agent, followed by reacting with a high molecular weight, reactive polysiloxane with silane functional groups. The grafting of high molecular weight polysiloxane nanobrushes on substrates can be done as a separate step before the application of the anti-icing composition.

The substrate for the novel transparent anti-icing coating is treated with a reactive linear polysiloxane to form nanobrushes which are end-grafted on the substrate (see FIG. 1), said reactive linear polysiloxane is selected from the group consisting of polysiloxane with an alpha-monofunctional reactive group, polysiloxane with a plurality of alpha-, omega-difunctional reactive groups, polysiloxane with a plurality of pendant multi-functional reactive groups, and mixture thereof, said reactive group is selected from the group consisting of acetoxy, alkoxy, alkylamino, alkanolamino, carbinol, chloro, dicarbinol, epoxy, hydride, polyaspartic ester amine, mercapto, silanol, and a mixture thereof.

Examples of preferred polysiloxanes are silanol terminated polydimethylsiloxane, hydroxypropyl terminated polydimethylsiloxanes, hydroxyethyoxypropyl terminated polydimethylsiloxane, hydroxyhexyl terminated polydimethylsiloxane, hydroxybutyl terminated polydimethylsiloxane, hydroxyhexyl terminated polydiethylsiloxane, aminopropyl terminated polydimethylsiloxanes, aminohexyl terminated polydimethylsiloxane, (N-ethyl)amino(2-methyl)propyl terminated polydimethylsiloxane, [(N-methyl)amino(2-methyl)propyl] terminated polydimethylsiloxane, epoxypropoxypropyl terminated polydimethylsiloxanes, (epoxypropoxypropyl methylsiloxane)-dimethylsiloxane copolymer, (epoxycyclohexylmethylsiloxane)-dimethylsiloxane copolymer, epoxycyclohexylethyl terminated polydimethylsiloxane, mercaptopropylmethylsiloxane-dimethylsiloxane copolymer, chloromethyl terminated polydimethylsiloxane, chloropropylmethylsiloxane-dimethylsiloxane copolymer, 2,4,6,8,10-pentamethylcyclopentasiloxanesiloxy terminated polydimethylsiloxane, 2,4,6,8-tertamethycyclotetrasiloxanesiloxy terminated polydimethylsiloxane, 2,4,6-trimethylcyclotrisiloxanesiloxy terminated polydimethylsiloxane, and a mixture thereof. A reactive polysiloxane with hydrolyzable functional groups at terminal locations can also be used. Hydrolyzable siloxanes can be mono functional, di-functional, or tri-functional and react with water to produce silanol groups in the presence of an acid or alkali. The following are preferred hydrolyzable functional groups: chlorine, triacetoxysilyl, triethoxysilyl, diethoxysilyl, ethoxysilyl, trimethoxysilyl, dimethoxysilyl, or methoxysilyl.

As previously mentioned, polyalkylsiloxanes can form helical conformations in which reactive Si—H functional groups can be either facing the interior or exterior of the helix. H—Si groups have affinity to and react with hydroxyl, silanol, metal oxide groups and Lewis acid sites on a substrate. Si—H bonds can change orientation to the exterior of the helix in order to facilitate bonding with polar hydroxyl, silanol, silicon oxide, and Lewis acid sites. In the presence of a catalyst, Si—H groups of hydride polysiloxane react with surface hydroxyl on the substrate to form a siloxane bond. The Si—H groups located near the terminal location of hydride polysiloxane or terminal reactive polysiloxane participate in reactions with reactive groups on the substrate surface and thereby, are grafted onto the surface. In the presence a catalyst, hydride groups at terminal locations in a helical conformation of hydride polysiloxane react with surface hydroxide, forming siloxane bonds to create end-grafted helical polymer brushes.

Reactive groups of polysiloxane can also end-graft onto substrate surfaces indirectly through silane-mediated reactions. The present invention discovered that high molecular weight, reactive polysiloxane can react with silane-treated surfaces to form the desired high molecular weight end-grafted polysiloxane brushes. Thus, surface silylation provides a useful surface treatment method. A preferred surface treatment agent for the present invention is functional silane. Silanol can condense with surface hydroxyl, silanol, metal oxide bridge, and Lewis acids sites. The condensed silanol group reacts with hydroxyl surface groups to form two-dimensional siloxane Si—O-Me surface bonds. Such chemical bonds are preferred due to their stability during hydrolysis and UV, chemical and heat resistance.

As previously stated, functional silanes can bond metal organic surfaces. It is important to use functional silanes instead non-functional silanes, such as alkyl silane or fluoroalkyl silane. Preferred functional groups in silanes with hydrocarbon-linker linked functional groups are acrylate, methacrylate, acryloxy, aldehyde, allyl, anhydride, amino, alkanolamino, anhydride, azide, azolyl, carbene, carbinol, carboxy, chloro, cyclopentadienyl, diamino, epoxy, ester, glycidoxy, halogen, hydroxyl, isocyanato, mercapto, methacryloxy, silanol, solfido, sulfine, sulfur, sulfonate, tertiaryamino, triamino, and vinyl. Silane functional groups are selected by matching with compatible reactive functional groups of long chain high molecular weight polysiloxane. For example, a silanol group can react with hydride, acetoxy, enoxy, oxime, alkoxy, and amine to form siloxane links.

The hydride functional group, Si—H, undergoes catalytic dehydrogenetive coupling with silanol to form a siloxane link that can be catalyzed by many organometallics, including organotitanate, organozirconate, organotin, or organozinc. The hydrosilylation addition of a Si—H bond catalyzed by a platinum complex across unsaturated vinyl groups will form a Si—C bond.

Under ambient temperature and in the presence of a catalyst, high molecular weight reactive polysiloxanes form nanobrushes by grafting onto a substrate surface via direct chemical bonds. The grafting process eliminates reactive groups, polar groups, and Lewis acid sites on a substrate surface, which results in the removal of bonding sites for ice. Since the end-grafted high molecular weight hydride polysiloxane has a similar chemical structure to free hydride polysiloxane, it allows for helical-helical interactions between the grafted nanobrushes and the non-grafted liquid phase hydride polysiloxanes, resulting in a hydride polysiloxane layer with high affinity to the substrate surface. As a result, the long chain nanobrushes on the substrate surface generate resistance against autophobicity and dewetting forces.

The present invention discovered that for increasing helical-helical interactions between non-grafted hydride polysiloxane with end-grafted nanobrushes anchored on the substrate surface, it is preferable to use a high molecular weight hydride polysiloxane to build the end-grafted molecular brushes. For example, if a hydride polysiloxane with a molecular weight in the range of 10 K Dalton is used, the helical nanobrushes will have a height around 12 nm. If the selected hydride polysiloxane molecule is about 50 K Dalton, the height can reach 60 nm. To increase the thickness of surface grafted hydride polysiloxane molecular brushes, a molecular weight in the range of 20 K to 50 K Dalton is desired.

The present invention discovered that a plurality of reactive linear polysiloxane nanobrushes can be end-grafted onto a substrate, wherein said reactive linear polysiloxane is selected from the group consisting of polysiloxane with an alpha-reactive group, polysiloxane with alpha-, and omega-reactive groups, and polysiloxane with a plurality of pendant reactive groups; said reactive group is selected from the group consisting of acetoxy, alkoxy, alkylamino, alkanolamino, carbinol, chloro, dicarbinol, epoxy, hydride, polyaspartic ester amine, mercapto, silanol, and a mixture thereof.

In the presence of a catalyst, long chained polysiloxanes with terminal reactive groups, such as alpha-, sigma-difunctional, and/or t-branched tri-functional reactive polysiloxanes, react to form a siloxane chain in a polysiloxane liquid. This reaction can form flexible nano cage-like structures (hereby referred to as “nano-cages”) of polysiloxane that interpenetrate end-grafted polysiloxane brushes on the solid surfaces of the nanoporous layer. For the preparation of these nano-cages, the preferred co-reactant siloxanes include di-functional terminated, and t-branched tri-terminated reactive siloxanes. Preferred co-reactant siloxane chains can be linear or t-branched. The following reactive siloxanes with high molecular weights are examples of useful co-reactants with hydride polysiloxanes: terminal di-functional or t-branched trifunctional siloxane having acetoxy, acryloxy, allyl, alkylamino, alkoxy, carbinol, epoxy, silanol, or vinyl functional groups. It is preferable that the functional group or groups of reactive siloxane be in the terminal locations. Examples of useful reactants include alpha-, omega-, di-silanol functional terminated polydimethylsiloxane, t-branched tri-functional silanol polydimethylsiloxane, alpha-, omega-, di-functional silanol terminated polydiethylsiloxane, t-branched tri-functional silanol terminated polydiethylsiloxane, alpha-, omega-, di-functional silanol terminated polymethylethylsiloxane, t-branched tri-functional silanol terminated polymethylethylsiloxane, alpha-, omega-, di-functional silanol terminated dimethylsiloxane-diethylsiloxane copolymer, and t-branched tri-functional silanol terminated dimethylsiloxane-diethylsiloxane copolymer, among others.

The present invention found that a network of flexible nano-cages can form when nano-cages interpenetrate with end-grafted nanobrush reaction products of alpha-, omega-difunctional, and/or t-branched terminal reactive polysiloxane. This novel flexible network of nano-cages can easily bend and flex in all directions. Polymethylhydrosiloxane has the highest compressibility among fluids (9.32% at 20,000 PSI). Its high compressibility and helical configuration make hydride polysiloxane ideal for shock absorption. By dampening impinging precipitation and absorbing the impact energy, the novel coating composition can also provide rain erosion resistance. The flexible, densely grafted high molecular weight hydride polysiloxane and nano-cage network, along with the helix-helix interactions of the large scale assemblies of helical hydride polysiloxane macromolecules, work in conjunction to hold polysiloxane liquids on the substrate surface, overcome dewetting forces and provide impact resistance.

In present invention, a general procedure for creating the novel anti-icing coating comprises of: (1) removing surfactant contamination from substrate surface, (2) removing two-dimensional alkyl or fluoroalkyl silane surface networks from substrate surface, (3) grafting polymethylhydrosiloxane nanobrushes on substrate surface, and (4) applying polymethylhydrosiloxane infused with nanoparticles with immobilized catalysts.

Discovery: Novel Two-Component Cross-Linkable Siloxane Resin System without Isocyanate

Rain erosion and repeated ice removals result in the loss of liquid hydride polysiloxane. To extend the longevity of liquid hydride polysiloxane on substrate surfaces without sacrificing optical clarity, a transparent nanoporous base layer that can be grafted onto treatment surfaces is desired.

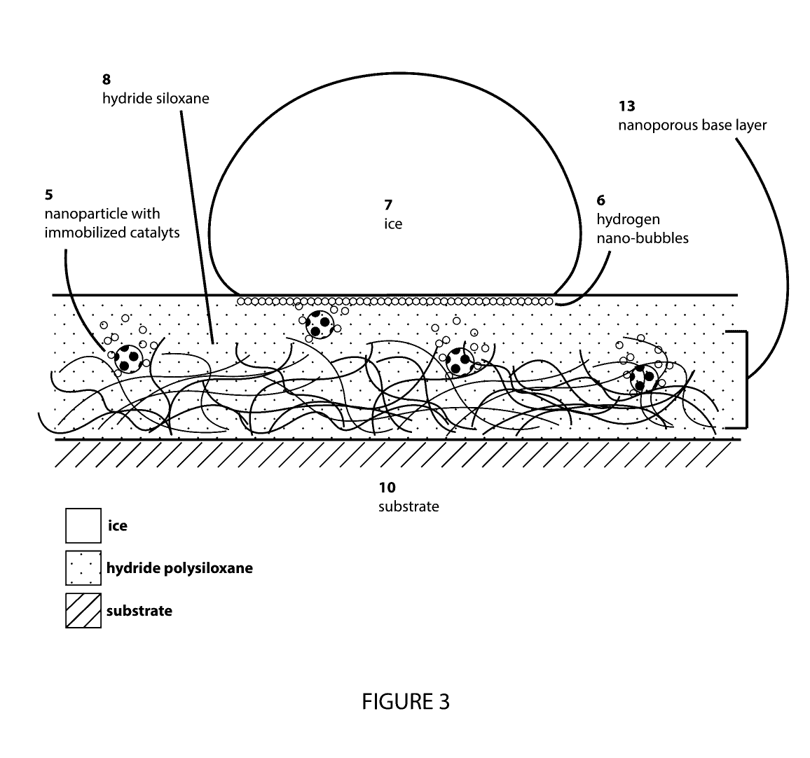

The present invention discloses a nanoporous base layer that can store liquid hydride polysiloxane and be used to replenish the surface (see FIG. 3). There are two basic methods for the synthesis of said nanoporous layer: (1) selective controlled etching with etchant on a substrate or on a specially treated substrate, and (2) coating a nanoporous layer on a substrate. U.S. Pat. No. 7,258,732 B2 and U.S. Pat. No. 8,741,158 B2 disclosed a phase separating glass capable of non-nucleated spinodal decomposition using thermal processes, followed by etching to generate an optically clear, nanoporous glass surface with porosity features smaller than 20 nm. US2013/0164521 A1 discloses the use of an alkali bath solution (KOH, NaOH, or LiOH) at high temperatures for several hours to obtain nanoporous, optically clear glass surfaces. While these methods can be utilized at the manufacturer level, they cannot be employed for existing glass surfaces already in use (windshields, windows, etc.) due to special heating processes and etching vessel requirements.

The known methods for producing nanoporous coatings involve the use of roughened polymers, sol-gel, spray-on powder, and self-assembly. These methods are encumbered by the following challenges in practice: low mechanical strength, processes requiring high temperatures, lack of optical clarity due to light scattering, poor homogeneity, and elaborate, expensive, or non-scalable production processes.

Compared to other available methods, spray application has the advantage of simplicity and scalability. However, commercially available nanoparticle sprays show poor chemical resistance, low mechanical strength, and lack of optical clarity. To improve chemical resistance and mechanical strength, a two-component (2K) resin should be used and the nanoparticles should be premixed in the resin rather than spayed onto a wet coating, which results in non-transparency.

The dominant 2K resin coating systems on the market are 2K aromatic polyurethane foams, 2k aliphatic polyurethane paints, 2K polyurea, and 2K epoxy coatings. Polyisocyanate or isocyanate prepolymer based cross-linkers are highly toxic and moisture sensitive and deteriorate quickly after exposure to air. Polyurethane, polyurethane-urea, and polyurea use polyisocyanate or isocyanate prepolymers as a cross-linker. Epoxy requires highly toxic polyamine as a cross-linker. Siloxanes with isocyanate functional groups are commercially available, but they are also toxic and moisture sensitive. Therefore polyurethane/polyurea siloxanes are not preferred for the present invention.

The main obstacles for the use of aliphatic polyurethane/polyurea or epoxy in the present invention are immiscibility and phase separation with siloxane. Phase separation with morphology greater than visible light wavelengths causes light scattering and results in opaqueness. To produce an ideal nanoporous base layer for the purposes of this invention, the ideal 2K resin system should be transparent, miscible to siloxanes, non-toxic, non-flammable or have a high flash point, not sensitive to moisture, easy to store and transport, and have a controlled curing speed. The cured product should have high bonding strength, high chemical and UV resistance, and high mechanical strength. The present invention discovered that a two-component (2K) siloxane coating can satisfy all of these technical requirements as well as eliminate the need for an isocyanate cross-linker.

In the present invention, suitable cross-linkers include small hydride siloxane molecules (linear or cyclic) and hydride polysiloxane (linear or cyclic) with low to medium molecular weight, said siloxane cross-linker is selected from alkylhydrosiloxane, polyalkylhydrosiloxane, alkylhydrosilanolsiloxane, polyalkylhydrosilanolsiloxane, and a mixture thereof. In the presence of water, the hydride group (≡Si—H) converts to a silanol (≡Si—OH) group, and yields a cross-linker having hydride (≡Si—H) groups and silanol (≡Si—OH) groups. The hydride siloxane cross-linker has a mixed hydride/silanol functional polysiloxane. The cross-linking reactions involve the specific reactions of both the hydride (≡Si—H) group and silanol (≡Si—OH) groups. The terminal multi-functional siloxane for the cross-linking reaction includes di-functional, tri-functional, and quad-functional siloxanes. The reaction groups in terminal multi-functional siloxane can be single type or mixed type. Useful cross-linkable siloxanes include: acetoxy terminal siloxane, enoxy terminal siloxane, epoxy terminal siloxane, silanol terminated siloxane, oxime terminal siloxane, polyaspartic ester amine terminal siloxane, alkylamino terminal siloxane, and alkoxy terminal siloxane; said alkoxy includes methoxy, ethoxy, propoxy, butoxy, and a mixture thereof. Terminal functional groups with less steric hindrance provide faster reactions.

If a hard 2K coating is required, said multi-functional reactive siloxane should have a small molecular weight. The present invention discovered that a small molecular weight, multi-functional polyaspartic ester amine terminated siloxane or mixed polyaspartic ester amine functional silane with alkoxy groups react with polyalkylhydrosilanolsiloxane to form a hard coating. Said mixed polyaspartic ester amine with alkoxy groups is comprised of: 1) silicon bonded hydrolyzable group or groups such as methoxy, ethoxy, acetoxy, acryloxy, alkoxy, carbinol, or silanol, and 2) hydrocarbon linker bonded polyaspartic ester amine functional groups.

If an elastomeric 2K coating is required, said multi-functional polysiloxane should have a low to medium molecular weight. An alpha, omega-, di-functional polyaspartic ester amine terminated polysiloxane with low polydispersity is preferred. In a preferred embodiment, a secondary amine of the siloxane reactant—polyaspartic ester amine terminated siloxane is selected as the reactive polyfunctional siloxane. Secondary amine groups in polyaspartic ester amine terminated siloxane react with polysiloxane with mixed hydride and silanol groups as cross-linkers to form cross-linked siloxane macromolecular networks with a controlled curing rate under ambient to subzero temperatures.

The novel coating composition has numerous advantages that contribute to its ease of use, broad applicability, and safety and performance profile. The novel 2K coating is environmentally friendly and does not contain any toxic or hazardous components. For example, hydride polysiloxane is commonly used to impart water repellency to glass, fabric, leather, paper, floor surfaces, gypsum board, and powders. Aminoalkyl siloxane is used for making contact lenses, hair and fabric conditioner, and cosmetic and personal care products. The composition is not sensitive to moisture and is water immiscible. Since it has a high flash point, it can be safely transported without restrictions under the Federal Code of Transportation. The 2K system has low viscosity and can be manually applied using conventional spray equipment. Automated application methods, such as airless, electrostatic, and electric fan can also be used. It has the ability to cure under a broad range of temperatures, ranging from ambient (or higher) to subzero. The gel time is about 5-10 minutes, and curing time is 4-8 hours. The cured coating is resistant to acids, alkalis, organic solvents, corrosion and UV. The coating is extremely durable and can bond to all solid substrates, including glass, aluminum, iron, metal, alloy, metal oxide, painted surfaces, paper, plastics, and wood, among others. Another benefit is the ability to adjust the hardness of the coating according to specific needs. For example, formulations can range from a coating with hardness higher than aluminum to an elastomeric coating similar to rubber. This flexibility further broadens the range of substrate materials and application fields.

### Discovery: Synthesis Method for Polyaspartic Ester Amine Terminated Siloxane

Commercially available aliphatic polyaspartic ester amines are based on O,O′-bis(2-aminoethyl)octadecaethylene glycol, 1,3-bis(aminomethyl)cyclohexane, 1,2-diaminopropane, 1,4-diaminobutane, 1,6-diaminohexane, 2,5-dimethylhexane, 1,11-diaminoudecane, 1,12-diaminododecane, polypropylene oxide diamine, 4,4′-methylenebis(cyclohexyl amine), 3,3′-dimethyl-4,4′-didiaminocyclohexyl methane, isophorone diamine (1-amino-3-aminomethyl-3,5,5-trimethyl-cyclohaxane), hexamethylene diamine, tetrahydro-2,4-diaminotuluene, tetrahydro-2,6-diaminotuluene, polyamidopolyoxyalkylene diamine, bis(4-aminocyclohexyl)methane adduct, bis(4-amino, 3-methylcyclohexyl)methane, 3,4-aminomethyl-1-methylcyclohexylamine, or 2,2,4(2,4,4)-trimethyl-1,6-hexanediamine. However, these hydrocarbon aliphatic polyaspartic ester amines cannot provide a transparent, optically clear coating due to phase separation when mixed with polysiloxanes. The present invention discloses a polyaspartic ester amine with a siloxane main chain that is not commercially available and is unknown in literature.

The present invention discovered a polyaspartic ester amine with a siloxane main chain that can be synthesized via Michael addition and accelerated by catalysts on nanoparticle carriers. The present invention also discloses a synthesis method for said polyaspartic ester amine terminated siloxane. The polyaspartic ester amine functional siloxane can be synthesized by reacting alpha-, omega-di-aminoalkyl siloxane, tri-aminoalkyl terminated t-branched siloxane, aminoalkyl functional silane, or pendent multi-aminoalkyl polysiloxane with excess dialkyl fumarates or dialkyl maleates via Michael addition. A polyaspartic ester amine functional silane can be synthesized by a reaction of amine functional silane with excess dialkyl fumarates or dialkyl maleates via Michael addition. Suitable amine functional silanes include, but are not limited to those with: 1) silicon bonded hydrolyzable group or groups such as methoxy, ethoxy, acetoxy, acryloxy, alkoxy, carbinol, or silanol, and 2) hydrocarbon linker bonded amine functional groups.

Suitable dialkyl maleates include, but are not limited to, diethyl maleate, dipropyl maleate, dibutyl maleate, methyl propyl maleate, and ethyl propyl maleate. Suitable dialkyl fumarates include, but are not limited to, diethyl fumarate, dipropyl fumarate, dibutyl fumarate, methyl propyl fumarate, and ethyl propyl fumarate. Suitable di-, tri-, and multi-, amino-functional siloxanes or polysiloxanes include, but are not limited to aminoalkyl terminated siloxanes such as: alpha-, omega-, bis(3-aminoalkylpropyl) 1,1,3,3-tetramethyldisiloxane; alpha-, omega-, bis(3-aminopropyl) polydimethylsiloxane; alpha, omega-bis(3-aminopropyl) polydiethylsiloxane; t-branched tris(3-aminopropyl) polydimethylsiloxane; pendant multi-terminated (3-aminopropyl) polydimethylsiloxane, alpha, omega-, bis(3-aminopropyl) polymethylethylsiloxane; alpha-, omega-, bis(3-aminopropyl) polycyclohexylmethylsiloxane; alpha-, omega-, bis(3-aminopropyl) dimethylsiloxane-diethylsiloxane copolymer; 3-aminopropyltriethoxysilane; 3-aminopropyltrimetoxysilsane; 4-aminobutyltriethoxysilane; and 4-aminobutyltrimethoxysilane. Since Michael addition involves resonance-stabilized carbon ions, both acids and bases can catalyze the addition reaction. Suitable catalysts include heterogeneous catalytic centers on metal oxide nanoparticles surfaces and Lewis acids or bases on highly dispersed carriers. Said Lewis acid or Lewis base catalytic centers on highly dispersed inorganic carriers can be prepared by impregnating metal oxide nanoparticles with a metal salt solution in a solvent, followed by drying and calcining at 200-400° C. Suitable metal oxide nanoparticles include fumed alumina, fumed titania, fumed silica, and fibrous silica nanospheres.

The grafting of immobilized catalysts composed of Lewis acids or Lewis bases on metal oxide nanoparticle surfaces involves: (1) de-agglomerating the nanoparticle carrier in a solvent, (2) impregnating the mixture with a metal containing salt in a solvent solution, (3) removing excess solution, and (4) activating the catalyst under air, oxygen, or an inert atmosphere by calcination at 200-400° C. The metal salt is selected from metal borate, metal chloride, metal oxide chloride, metal fluoroalkylsulfonate, metal fluoride, metal oxide fluoride, metal hexafluorophosphate, metal hydroxide, metal maleate, metal nitrate, metal oxide nitrate, metal oxide, metal perchlorate, metal perfluoroalkylsulfonate, metal teflate, metal tetrafluoroborate, metal tetrakis(pentafluorophenyl)boranate [B(C₆F₅)₄]⁻, metal triflate (trifluoromethanesulfonate), and a mixture thereof. Said metal element in metal salt is selected from the group consisting of Li, Na, K, Sc, Y, Ti, Zr, Hf, V, Nb, Ta, Cr, Mo, W, Mn, Cu, Ag, Au, Zn, Sn, lanthanides (La, Ce, Pr, Nd, Pm, Sm, Eu, Gd, Tb, Dy, Ho, Er, Tm, Yb, Lu), and a mixture thereof.

A typical preparation method is as follows: (1) adding a small amount of dialkyl fumarates or dialkyl maleates drop-wise into a mixture of aminoalkyl terminated siloxane with a catalyst while stirring; said aminoalkyl terminated siloxane is selected from the group consisting of alpha-, omega-di-aminoalkyl siloxane, tri-aminoalkyl terminated t-branched siloxane, pendent multi-aminoalkyl polysiloxane, aminoalkyl functional silane, and a mixture thereof; (2) while stirring, slowly raising the temperature to 60-80° C. and holding for 16 to 24 hours; (3) vacuuming distillate to remove carboxylic esters; and (4) using a centrifuge to separate and remove the catalyst, resulting in the end product of polyaspartic ester amine terminated siloxane.

### Discovery: A Nanoporous Base Layer for the Storage and Replenishment of Liquid Hydride Polysiloxane

The present invention discovered a nanoporous base layer that can serve as a storage reservoir for hydride polysiloxane liquid and allow for surface replenishment. The process for forming the novel nanoporous base layer is as follows: (1) mix nanoparticles and/or nanofibers into a solvent diluted with the previously described novel multi-functional terminated siloxane; (2) mix with a hydride polysiloxane cross-linker, and (3) spray the final mixture onto a substrate, such as glass. After cross-linking with the novel 2K cross-linkable siloxane resin system, said nanoporous base layer will be formed on the substrate. This base layer extends the duration of anti-icing performance by allowing for the renewal of the hydride polysiloxane liquid on the surface. Said nanoporous layer can be prepared using nanoparticles with dehydrogenetive catalytic centers or with a mixture of nanoparticles with dehydrogenative catalytic centers and virgin nanoparticles without catalytic centers such as fumed alumina, fumed titania, fumed silica, or fumed zirconia.

Cellulose nanofibers from various origins, such as cotton, wood, or biomass can serve as nanoparticles for use in the preparation of said nanoporous layer. Nanofibers produced by electrospinning of organic polymers and chitosan can be used after a surface silane treatment. Other suitable nanoparticles include, but are not limited to, inorganic nanofibers such as ceramic nanofibers, and metal oxide nanofibers, such as alumina nanofibers, titania nanofibers, or zirconia nanofibers. Inorganic nanofibers have a high concentration of hydroxide reaction groups and can be homogeneously suspended in alcohol.

Nano-celluloses obtained via sulfuric acid or hydrochloric acid hydrolysis of wood fibers are generally contaminated with lignin and glycose. Such nano-celluloses can be dispersed in water, but flocculate in solvent. Obtaining a homogeneous suspension requires: (1) repeated cycles of exchanging suspension medium from water to solvent, followed by centrifuging to remove dissolved impurities, and (2) surface treatment of nanofibers with alkyl silane to enable homogeneous suspension in siloxane containing solvents and to increase effective reservoir capacity. Silanes with short alkyl groups provide autophobic properties inside the capillary channels formed by the nanofibers. Autophobicity forces help push hydride polysiloxane out of the capillaries and allow for the renewal of hydride polysiloxane on the surface. Useful silanes for surface treatment include tert-butyldimethylchlorosilane, tert-butylmethyldichlorosilane, tert-butyltrichlorosilane, tert-butyldimethylmethoxysilane, tert-butyldimethylethoxysilane, tert-butylmethyldimethoxysilane, and tert-butyltrimethoxysilane.

To prepare the nanoporous base layer, a mixture of nanofibers and nanoparticles having active dehydrogenetive catalytic centers is preferred. Using nanofibers facilitates the assembly of highly porous reservoirs. Nanoparticles having dehydrogenetive catalytic centers will enable the dehydrogenetive reaction to generate hydrogen. The present invention discovered that hydrogen nano bubbles released from the catalytic reaction of hydride polysiloxane with water molecules creates hydraulic pressure. The rate of reaction is controlled by the availability of water molecules, which are transported by hydride polysiloxane from atmospheric humidity to the nanoparticles with immobilized catalysts (see FIG. 2) suspended around and inside the nanoporous base layer (see FIG. 3). The amount of hydrogen generated self-adjusts depending on the level of atmospheric humidity. If atmospheric humidity is low and there is no precipitation on the hydride polysiloxane surface, water molecules will not be transported to catalytic centers in the nanoporous layer so no hydrogen will be generated. During a precipitation event, the water concentration will increase in the liquid phase hydride polysiloxane and the rate of hydrogen generation will increase.

The present intention discloses the preparation method for a nanoporous coating composition comprising of: (a) a plurality of nanoparticles, said nanoparticles are selected from the group consisting of a nanoparticle with an immobilized catalyst, fumed aluminum oxide (Al₂O₃), fumed cerium oxide (Ce₂O₃), fumed ferric oxide (Fe₂O₃), fumed lanthanum oxide (La₂O₃), fumed magnesium oxide (MgO), fumed silica (SiO₂), fumed titanium oxide (TiO₂), fumed zirconium oxide (ZrO₂), fibrous silica nanospheres, alumina nanofibers, lithium titanate nanofibers, silica nanofibers, titania nanofibers, zirconia nanofibers, cellulose nanofibers, collagen nanofibers, chitosan nanofibers, gelatin nanofibers, elastin nanofibers, silk fibroin nanofibers, wheat protein nanofibers and a mixture thereof; (b) 2K cross-linkable siloxane, said 2K cross-linkable siloxane consists of multifunctional siloxane and siloxane cross-linker, said multifunctional siloxane is a siloxane with reactive multifunctional groups, said reactive group is selected from the group consisting of acetoxy, alkoxy, amine, aspartic ester amine, butoxy, enoxy, epoxy, methoxy, ethoxy, oxime, propoxy, secondary amine, silanol, and a mixture thereof; said siloxane cross-linker is selected from alkylhydrosiloxane, polyalkylhydrosiloxane, alkylhydrosilanolsiloxane, polyalkylhydrosilanolsiloxane, and a mixture thereof; and (c) a solvent.

During precipitation events, water molecules will land on the surface of the thin film of nanoparticle-infused hydride polysiloxane that rests on the nanoporous base layer. The rate of the dehydrogenetive reaction is controlled by the availability of water molecules, which are transported by hydride polysiloxane from the surface through the hydrophobic hydride polysiloxane film to catalytic centers on nanoparticle surfaces in the nanoporous base layer. The concentration of water in the hydride polysiloxane layer exponentially decreases as a function of distance from surface, due to nature of the hydrophobic hydride polysiloxane. Thus, if the hydride polysiloxane film layer is thick, the amount of water molecules that can penetrate to gain access to the nanoporous base coating is low. This would result in very low amounts of hydrogen generation. If the hydride polysiloxane film layer is very thin, water molecules can easily be brought into the nanoporous base layer. As the supply of water molecules to the immobilized catalytic centers increases, hydrogen generation increases. The generated hydrogen creates nano bubbles, which create pressure that acts as the driving force to push hydride polysiloxane from arrays of capillaries in the nanoporous base layer, thus supplying and replenishing depleted hydride polysiloxane on the composite surface. The novel nanoporous base layer can hold a high volume of reactive hydride polysiloxane liquid, while retaining transparency and optical clarity. Additionally, its self-renewal mechanism enables continued anti-icing performance, even after repeated cycles of rain erosion or ice removals.

Discovery: A Nanoparticle-Infused Hydride Polysiloxane that Enhances Anti-Icing Performance and Provides Low Water Contact Angle Hysteresis

Superhydrophobic “lotus leaf” structures show a high water contact angle and low water contact angle hysteresis. However, a high contact angle can coexist with high contact angle hysteresis, leading to a strong adhesive force with water on solid superhydrophobic surfaces known as the “petal effect”. Superhydrophobic properties are based on the Cassie-Baxter state: (1) contact line forces overcome body forces of the weight of an unsupported water droplet and (2) microstructures are tall enough to prevent the water that bridges over the top from touching the base of microstructures. Up until now, all superhydrophobic surfaces were based on solid nano/micro hierarchical structures. A nanoparticle-infused liquid surface with low water contact angle hysteresis properties not based on hierarchical structures is unknown in the art.

The present invention found that a plurality of floating nanoparticles on the surface of a liquid hydride polysiloxane can be used to create a novel coating with low water contact angle hysteresis. Nanoparticles that are at least partially covered with immobilized dehydrogenetive catalytic centers are buoyed by the hydrogen nano-bubbles produced by these catalytic centers under conditions of high humidity.

The novel nanoparticle-infused liquid surface with low water contact angle hysteresis also satisfies the Cassie-Baxter state: (1) a water droplet has a nano/micro menisci surface between nanoparticles floating on the hydride polysiloxane liquid, (2) the contact line forces between the floating and submerged nanoparticles (supported by hydrogen nano-bubbles) overcome body forces created by weight of the water droplet, and (3) the floating nanoparticles are densely packed enough to prevent the water that bridges on top from touching the base of hydride polysiloxane liquid.

The novel nanoparticle-infused hydride polysiloxane liquid has a high water contact angle, low water contact angle hysteresis, and therefore, a very low sliding angle. Its very low contact angle hysteresis is due to the negligible amount of friction generated by the nanoparticles floating in the hydride polysiloxane. A water droplet will rapidly roll off coated angled surfaces if the diameter of the water droplet is greater than the critical diameter value, which is determined by water contact angle hysteresis; the smaller the critical diameter value, the lower the contact angle hysteresis. The present invention measured that a water droplet with volume of around 4 microliters starts to roll with a very slight tilt to the substrate surface, which indicates that the critical water droplet diameter is around 1 mm. Thus, the novel coating will maintain a surface that is free from water droplets with diameters greater than the critical value when the surface is tilted or exposed to wind shear.

The ability of the novel composite to increase the velocity of water runoff is extremely useful for low temperatures applications. Since the novel surface lacks crystallization centers, if a supercooled water droplet lands on the surface under subzero conditions, it will remain in a liquid state until a small force from wind shear or gravitational pull (when tilted) causes it to roll off. Under most conditions, the novel coating will delay ice crystal formation by long enough to allow for the water to be removed before it can freeze. Since the concentration of water is highest near the surface of the hydride polysiloxane film, this region also generates the most hydrogen. Thus, even if ice eventually forms, it cannot bond to the novel surface due to constant generation of hydrogen, which will push against and separate the ice.

In addition, the novel low hysteresis, low freezing-point, nanoparticle-infused hydride polysiloxane liquid surface resists environmental and mechanical damage such as repeated icing/ice removal cycles due to: (1) its ability to self-renew by replenishing depleted nanoparticle-infused hydride polysiloxane liquid stored in the nanoporous base layer, (2) the replacement of any sheared floating nanoparticles by submerged nanoparticles that are dispersed throughout the novel liquid, (3) erosion resistance provided by the interpenetrated nano-cages and end-grafted high molecular weight polysiloxane nanobrushes on the nanoporous base layer, and (4) the high storage capacity of the nanoporous base layer for the novel liquid. In contrast to the renewability of the novel anti-icing composite, solid superhydrophobic surfaces suffer irreversible destruction after ice removals due to the fragility of the very thin nano/micron hierarchical structures, which cannot be renewed.

### Discovery: Synthesis of a High Molecular Weight Hydride Polysiloxane, Including Polydihydrosiloxane, Poly(Dihydrosiloxane-Alt-Methylhydrosiloxane), and Polymethylhydrosiloxane

A hydrogen-rich hydride polysiloxane is desired for the present invention.

Polymethylhydrosiloxane contains 1.67% active hydrogen, poly(dihydrosiloxane-alt-methylhydrosiloxane) contains 2.83% active hydrogen, and polydihydrosiloxane contains 4.35% of active hydrogen. Since each silicon-hydrogen (Si—H) bond generates one molecule of hydrogen in dehydrogenative coupling reactions with water, the theoretical maximum values of hydrogen generation from a typical hydride polysiloxane are as follows: 3.3×10⁻² g H₂/g•polymethylhydrosiloxane, or 3.7×10² cm³ H₂/g•polymethylhydrosiloxane; 5.6×10⁻² g H₂/g•poly(dihydrosiloxane-alt-methylhydrosiloxane), or 6.3×10² cm³ H₂/g•poly(dihydrosiloxane-alt-methylhydrosiloxane), and 8.7×10⁻² g H₂/g•polydihydrosiloxane, or 9.7×10² cm³ H₂/g•polydihydrosiloxane. However, both poly(dihydrosiloxane-alt-methylhydrosiloxane) and polydihydrosiloxane do not exist on the market.

The major industrial manufacturing method for the production of linear polysiloxane is hydrolysis of dichloroalkylsilanes followed by condensation to yield a highly complex mixture of linear and cyclic polysiloxanes [47]. Fractionation of the complex mixture is performed by fractional distillation. A more effective fractionation method that uses supercritical fluid (CO₂) extraction is currently under development. Medium to high molecular weight polyalkylhydrosiloxanes with narrow molecular weight distributions are very difficult to produce using the available methods. As a result, only low molecular weight polyalkylhydrosiloxanes are available as commercial products. The laboratory scale preparation method is based on ring-opening polymerization (ROP) of cyclosiloxanes to yield either kinetically or equilibrium controlled mixtures of linear and cyclic polysiloxanes [47]. Commercially available cyclic methylhydrosiloxanes include 2,4,6-trimethylcyclotrisiloxane (D₃^{H}) and 2,4,6,8-tetramethylcyclotetrasiloxane (D₄^{H}). Other cyclic alkylhydrosiloxanes, such as D₅^{H}, D₆^{H}, D₇^{H}, D₈^{H}, and D₉^{H} can be prepared by hydrolysis of dichloroalkylsilanes. An improved synthesis method for hydrogen-rich cyclosiloxane of (H₂SiO)ₙ (n=3, 4, 5, 6) was discovered recently (U.S. Pat. No. 7,655,206 B2), denoted as D₃^{2H}, D₄^{2H}, D₅^{2H}, D₆^{2H}. Currently, there are no commercial products that contain hydrogen-rich cyclic dihydride siloxane.

ROP of a mixture of Dₘ^{2H} and Dₙ^{H}, or Dₙ^{2H} and Dₙ^{H} will produce dihydrosiloxane-co-methylhydrosiloxane block copolymer (m and n denote an integral). The Si—H groups of dihydrosiloxane units in the block dihydrosiloxane-co-methylhydrosiloxane copolymer are not shielded by alkyl groups. Thus, the dihydrosiloxane-co-methylhydrosiloxane block copolymer will have stability problems. To improve copolymer stability, alternating (H₂SiO) and (CH₃HSiO) units in a long chain hydride polysiloxane is desired.

The present invention discovered that a cyclic hydrosiloxane (H₂SiO-alt-CH₃HSiO)ₙ with alternating (H₂SiO) and (CH₃HSiO) units can be prepared by hydrolysis of an equal molar mixture of dichlorosilane and dichloromethylsilane utilizing a metal carbonate in an anhydrite aprotic solvent, wherein the n=2, 3, 4, 5, 6, 7, 8, and 9. The preferred aprotic solvent is selected from the group consisting of amyl acetate, butanone, butyl acetate, sec-butyl acetate, tert-butyl acetate, n-butyl propionate, gama-butylolactone, chloroform, cyclobutanone, cyclohexanone, cyclopentanone, dichloromethane, diethyl carbonate, diethyl ketone, diisobutyl ketone, dimethyl carbonate, dimethyl cellosolve, dimethyl ether, dimethoxyethane, dimethylglycol dimethyl ether, 1,4-dioxane, 2-ethoxyethyl ether, ethyl acetate, ethyl acetoacetate, ethyl butyrate, ethyl formate, ethyl isopropyl ketone, ethylene carbonate, hexane, hexyl acetate, isoamyl acetate, isobutyl acetate, isobutyl isobutyrate, isophorone, isopropyl acetate, methyl acetate, methyl amyl acetate, parachlorobenzotrifluoride, pentane, perchloroethylene, 3-pentanone, n-pentyl propionate, petroleum ether, beta-propyolactone, tetrahydrofuran, toluene, delta-valerolactone, xylene, and a mixture thereof 3A molecular sieves, dried silica, or dried alumina can be used to dry dehydration solvents. The suitable metal carbonate is selected from the group consisting of magnesium carbonate, calcium carbonate, zinc carbonate, lithium carbonate, and a mixture thereof.

There are two types of ROP of cyclic siloxanes: anionic and cationic. The Si—H bond is susceptible to base cleavage and is attacked under conditions of anionic ROP. Cationic ROP, however, yields a broad molecular weight distribution. Under optimum conditions, the polydispersity (Mw/Mn) will be in the 1.6-2 range due to side reactions such as: condensation, backbiting, reverse chain-end reactivation, redistribution, chain transfer and cross-linking Impurities such as water, alcohol, acid, and ester reduce molecular weight.

Cationic catalysts are protonic and include Brönsted and Lewis acids, such as carborane acid, H(CHB₁₁Cl₁₁), trifluoromethanesulfonic acid (triflic acid, CF₃SO₃H), HClO₄, RSO₃H, linear phosphonitrilic chlorides (Cl₃P(NPCl₂)₂PCl₃)PCl₆, BF₃, AlCl₃, FeCl₃, SnCl₄, etc. Homogeneous catalysis leads to catalyst contamination in the product, which is difficult to separate and remove. If all traces of catalysts cannot be totally removed, the final product will be unstable. Heterogeneous catalysts such as cation-exchanged sulfonic acid resin and acidified clay have been developed. A recent development is micro-emulsion polymerization using dodecylbenzyl sulfonic acid as a catalyst/surfactant, which yields 1.8×10⁵ g/mol at 60-90° C. [47]. Using sodium dodecylbenzenesulfonate acidification by HCl to pH 5 yields a polymer with a molecular weight of 1.6 10⁴ g/mol and polydispersity of 1.6. However, surfactants in the final product are difficult to remove. Recent research reported a surfactant-free aqueous emulsion using tris(pentafluorophenyl)borate. Solid phase ROP has also been reported. However, it yields a solid product with very broad polydispersity and very high molecular weight with unreacted cyclo monomers [47].

Water is generally avoided in organic synthesis because it can deactivate catalysts. Common Brönsted and Lewis acids catalysts are very sensitive to moisture and are deactivated under very low concentrations of water. The discovery of water-tolerant Lewis acids has attracted great interest due to the safety and cost efficiency of using water as a solvent [44, 48]. Reported water-tolerant Lewis acids are Group I metals, rare earth metals or transition metal salts of perfluoroalkylsulfonate, fluorosulfonate, and hexafluorophoshate. A recent publication described polycondensation of siloxane in a surfactant-free aqueous emulsion using (C₆F₅)₃B as the water-tolerated Lewis acid to generate linear polymers with molar masses ranging from 30-80,000 g/mol that bear a silanol end-group.

The present invention discovered that high molecular weight linear hydride polysiloxane can be synthesized by water-tolerant Lewis acid catalyzed ROP from a cyclic hydride siloxane such as: polydihydrosiloxane, poly(dihydrosiloxane-alt-methylhydrosiloxane), or polymethylhydrosiloxane. In the present invention, a preferred water-tolerant Lewis acid catalyst is based on a metal salt, said metal salt is selected from metal acetate, metal bromide, metal borate, metal chloride, metal oxide chloride, metal citrate, metal fluoroalkylsulfonate, metal fluoride, metal fluoroalkylsulfonate, metal formate, metal hexafluorophosphate, metal hexanoate, metal iodide, metal lactate, metal maleate, metal malonate, metal nitrate, metal oxide nitrate, metal oleate, metal oxide, metal perchlorate, metal perfluoroalkylsulfonate, metal salicylate, metal sebacate, metal stearate, metal sulfate, metal tartrate, metal teflate, metal tetrafluoroborate, metal tetrakis(pentafluorophenyl)boranate [B(C₆F₅)₄]⁻, metal triflate (trifluoromethanesulfonate), and a mixture thereof; said metal element in the metal salt is selected from the group consisting of Sc, Y, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and a mixture thereof. The cation-exchanged resins: Amberjet™ 1200, Amberlyst®-15, Amberlyst®-35, Purolite® CT175 also display high catalytic activity for sulfonic acid catalytic ROP. The preferred water-tolerant Lewis acid ROP solvents are water or an aqueous solvent. Said aqueous solvent is selected from the group consisting of acetone, butanone, butyl acetate, sec-butyl acetate, tert-butyl acetate, n-butyl propionate, gama-butylolactone, cyclobutanone, cyclohexanone, cyclopentanone, diethyl ether, diethyl ketone, diisobutyl ketone, dimethyl carbonate, dimethyl ether, 1,4-dioxane, 2-ethoxyethyl ether, ethyl acetate, ethyl acetoacetate, ethyl butyrate, ethyl formate, ethyl isopropyl ketone, ethylene carbonate, hexane, hexyl acetate, isobutyl acetate, isobutyl isobutyrate, isophorone, isopropyl acetate, methyl acetate, pentane, 3-pentanone, propylene carbonate, beta-propyolactone, tetrahydrofuran, and a mixture thereof.

Polydihydrosiloxane can be synthesized by water-tolerant Lewis acid catalyzed ROP from a cyclic dihydrosiloxane D₃^{2H}, D₄^{2H}, D₅^{2H}, D₆^{2H}, D₇^{2H}, D₈^{2H}, and D₉^{2H}. Poly(dihydrosiloxane-alt-methylhydrosiloxane) can be synthesized by water-tolerant Lewis acid catalyzed ROP from a cyclic alternating hydride siloxane: (H₂SiO-alt-CH₃HSiO)ₙ, wherein the n=2, 3, 4, 5, 6, 7, 8, and 9. Polymethylhydrosiloxane can be synthesized by water-tolerant Lewis acid catalyzed ROP from a cyclic hydride siloxane: D₃^{H}, D₄^{H}, D₅^{H}, D₆^{H}, D₇^{H}, D₈^{H}, and D₉^{H}. Hexamethyldisiloxane, hexaethyldisiloxane, or hexa(tert-butyl) disiloxane can be used as an end blocker. A high percentage yield of high molecular weight (5,000-100,000 g/mol) linear hydride polysiloxane with reasonably narrow polydispersity (within the Mw/Mn range) can be achieved using water-tolerant Lewis acid catalyzed ROP. Removal of the catalyst from the final product is easy, since water-tolerant Lewis acid catalysts cannot dissolve in high molecular weight siloxane products. Due to its low boiling point, cyclic hydride siloxane can be vacuum distillated and recovered.

In the present invention, the hydride polysiloxane used in the transparent ice-separating composition is hydrophobic, water immiscible, and highly compressible with a low freezing-point and low surface energy; said hydride polysiloxane is selected from the group consisting of polydihydrosiloxane, poly(dihydrosiloxane-alt-methylhydrosiloxane), polymethylhydrosiloxane, poly(dihydrosiloxane-alt-ethylhydrosiloxane), polyethylhydrosiloxane, C(SiH₃)₄, CH(SiH₃)₃, H₃C(SiH₃)₃, cyclic (H₂SiO)₃, cyclic (H₂SiO)₄, cyclic (H₂SiO)₅, cyclic (H₂SiO)₆, cyclic (H₂SiO)₇, cyclic (H₂SiO)₈, cyclic (H₂SiO)₉, cyclic (H₂SiO-alt-MeHSiO)₂, cyclic (H₂SiO-alt-MeHSiO)₃, cyclic (H₂SiO-alt-MeHSiO)₄, cyclic (H₂SiO-alt-MeHSiO)₅, cyclic (H₂SiO-alt-MeHSiO)₆, cyclic (MeHSiO)₃, cyclic (MeHSiO)₄, cyclic (MeHSiO)₅, cyclic (MeHSiO)₆, cyclic (MeHSiO)₇, cyclic (MeHSiO)₈, cyclic (MeHSiO)₉, trimethylsiloxy terminated polydihydrosiloxane, triethylsiloxy terminated polydihydrosiloxane, tri(tert-butylsiloxy) terminated polydihydrosiloxane, trimethylsiloxy terminated polymethylhydrosiloxane, triethylsiloxy terminated polymethylhydrosiloxane, tri(tert-butylsiloxy) terminated polymethylhydrosiloxane, trimethylsiloxy terminated poly(dihydrosiloxane-alt-methylhydrosiloxane), triethylsiloxy terminated poly(dihydrosiloxane-alt-methylhydrosiloxane), tri(tert-butylsiloxy) terminated poly(dihydrosiloxane-alt-methylhydrosiloxane), trimethylsiloxy terminated polyethylhydrosiloxane, triethylsiloxy terminated polyethylhydrosiloxane, trimethylsiloxy terminated poly(dihydrosiloxane-alt-ethylhydrosiloxane), triethylsiloxy terminated poly(dihydrosiloxane-alt-ethylhydrosiloxane), tri(tert-butylsiloxy) terminated poly(dihydrosiloxane-alt-ethylhydrosiloxane), and a mixture thereof.

### Discovery: Anodic Porous Metal Oxide Substrate

Nano-, meso- and macro-porous materials are known. They are widely used in filtration, chromatography, catalytic, and biomedical fields. However, there are unresolved obstacles due to difficulties with economical scale-up of production.

The present invention discovered that porous anodic metal oxide film grown on a metal, alloy, or composite containing boride, carbide, or nitride can be utilized as a substrate for the transparent ice-separating composition. Anodic metal oxide films have the advantages of excellent mechanical properties and economical scale-up. It is known that valve metals react with oxygen to form a dense, protective, and passive layer of oxide film. Valve metals include silver (Ag), aluminum (Al), bismuth (Bi), iron (Fe), hafnium (Hf), magnesium (Mg), niobium (Nb), antimony (Sb), silicon (Si), tin (Sn), tantalum (Ta), titanium (Ti), tungsten (W), vanadium (V), zinc (Zn), and zirconium (Zr). Many other metals, such as cobalt (Co), chromium (Cr), molybdenum (Mo), nickel (Ni), and manganese (Mn) can also be anodized to form anodic oxide film using various anodization processes. Metals and alloys with anodized surfaces have been used extensively in aerospace, automotive, marine, chemical, architectural, machinery, food, medical, and consumer products. Metals and alloys which can be surface anodized include metals made using wrought, sheeting, plating, forging, extrusion, casting, cladding, surface plating, electro forming, coating by thermal spray (plasma spray, arc spray, combustion spray, high velocity oxy-fuel spray (HVOF), cold spray, laser cladding) methods or produced by powder metallurgy. For example, the metals commonly found in the cold section of aircraft turbine engines (including inlet, fan, compressor, and casing) include aluminum alloys, titanium, titanium alloys, titanium inter-metallic (Ti₃Al₄, Ti-6A1-4V), titanium matrix with SiC fibers, and Ti/SiC composites. Helicopters and rotorcraft use thermal sprayed tungsten carbide-cobalt (WC—Co) on the leading edges of blades and thermal sprayed niobium on the aft of noses for rain erosion and sand abrasion protection. The surfaces of all of these materials can be electrochemically anodized.

Electrochemical anodic oxidation of aluminum, magnesium, titanium alloys in various electrolytes is a well-established surface technology [42]. Anodization involves electrochemical surface oxidation with a metal serving as the anode. The process is commonly carried out in an electrochemical cell or bath, which usually has an anode and cathode with the optional addition of a third reference Ag/AgCl electrode. When a voltage is applied between immersed electrodes, a current passes through an electrolyte between the immersed electrodes. The electrochemical reactions in combination with field-driven ion diffusion lead to the release of hydrogen on the surface of the cathode (negative electrode), and the release oxygen on the surface of anode (positive electrode), thereby creating an oxide layer on the anode surface.

For example, the main chemical reactions for the anodization of aluminum are:
At the Al/Al₂O₃ interface:

Al⇄Al³⁺+3e⁻

At the Al₂O₃/electrolyte interface:

2H₂O⇄2O²⁻+4H⁺⇄O₂↑+4H⁺+4e⁻

O²⁻ ions migrate from Al₂O₃/electrolyte interface toward Al/Al₂O₃ interface:

2Al³⁺+3O²⁻⇄Al₂O₃

The main chemical reactions for anodization of titanium are:
At the Ti/TiO₂ interface:

Ti⇄Ti⁴⁺+4e⁻

At the TiO₂/electrolyte interface:

2H₂O⇄2O²⁻+4H⁺⇄O₂↑+4H⁺+4e⁻

O²⁻ ions migrate from TiO₂/electrolyte interface toward Ti/TiO₂ interface:

Ti⁴⁺+2O²⁻⇄TiO₂

The required voltage may vary according to differing electrolyte compositions, and range from 1 to 300 V direct current (DC), with the most common range between 12 to 24 V DC. The anodizing current varies from 20 to 300 amperes/m². Under the proper anodization conditions, metals can form anodic oxide films that have an interpore (or intertube) domain surface, dense arrays of nanopore/nanotubes, and an impervious barrier layer. Hereafter, any references to “nanotubes” are inclusive of nanopores. “Nanotube” refers to a nanotube diameter between 10 nm to 800 nm and the depth of nanotube is between 0.25 to 50 micrometers.

By using a suitable composition and concentration of electrolytes and additives, and controlling anodizing voltage, pH values, current density, and solution temperature, a dense anodic oxide film with hexagonal nanotubes arrays can be obtained instead of a microporous anodic oxide film. For example, Type I chromic acid anodization produces thinner (0.5 to 18 micrometers) and more opaque films. Type II sulfuric acid anodization forms films in the range of 1.8 to 25 micrometers. Type III hardcoat or hard anodization processes result in films with a thickness above 25 micrometers. Thicker films require more process control and higher voltage, and are produced in a refrigerated tank at temperatures near the freezing point of water. Type IC anodizing uses weak organic acids, such as acetic acid, malic acid, or oxalic acid, and uses high voltage, high current density and refrigeration. It can produce films up to 50 micrometers in thickness.

Matsuda et al. invented a two-step anodization method [27]. The initial anodization results in a porous surface, which is exposed via chemical etching. Removal of the initial anodic metal oxide layer forms perfectly ordered pores due to the self-assembled mask provided by the first anodization. After etching, the aluminum substrate acts as a self-assembled grid for a subsequent anodization, leading to a honeycomb-like pattern of nanotubes under carefully controlled anodizing conditions. Further research is being conducted to explore the anodization parameters required to produce anodic aluminum oxide films with dense hexagonal nanotube arrays.

There is extensive literature on aluminum anodization. Research and patent literature have also reported anodization of other metals, alloys, and even metal matrixes with carbide, boride, and nitride composites to produce anodic oxide films with nanotube or micropore arrays. For example, anodic titanium oxide films, which generate interference colors, have been used in art and jewelry. Phosphoric acid, sulfuric acid, and acetic acid have been used as electrolytes for anodizing titanium. Acidic electrolytes, especially sulfuric and phosphoric acid can produce a thick (tens of microns), microporous oxide layer under high voltages. In contrast, fluoride solutions were found to be able to produce anodic oxide films with nanotubes. Some examples of electrolytes for producing anodic titanium oxide films with nanotubes are: a solution of KF or 4.5% NaF in DMSO at 25 V, which results in a pore diameter of 115 nm and depth of 4.4 microns after 20 hours; 0.5-1.5% HF at 20 V, which produces a pore diameter of 60 nm and depth of 0.20 microns after 20 minutes; acetic acid and 4% HF at 20 V, which produces a pore diameter of 60 nm and depth of 2.3 microns after 70 hours; 1M H₂SO₄ and 0.15% HF at 30 V, which produces a pore diameter of 140 nm and depth of 0.54 microns after 24 hours; acetic acid and 0.5% NH₄F at 20 V, which produces a pore diameter of 30 nm and depth of 0.2 microns after 1 hour; 1M (NH₄)H₂PO₄; 1M H₃PO₄ and 0.5 HF at 20 V, which produces a pore diameter of 50 nm and depth of 4.1 microns after 40 hours.

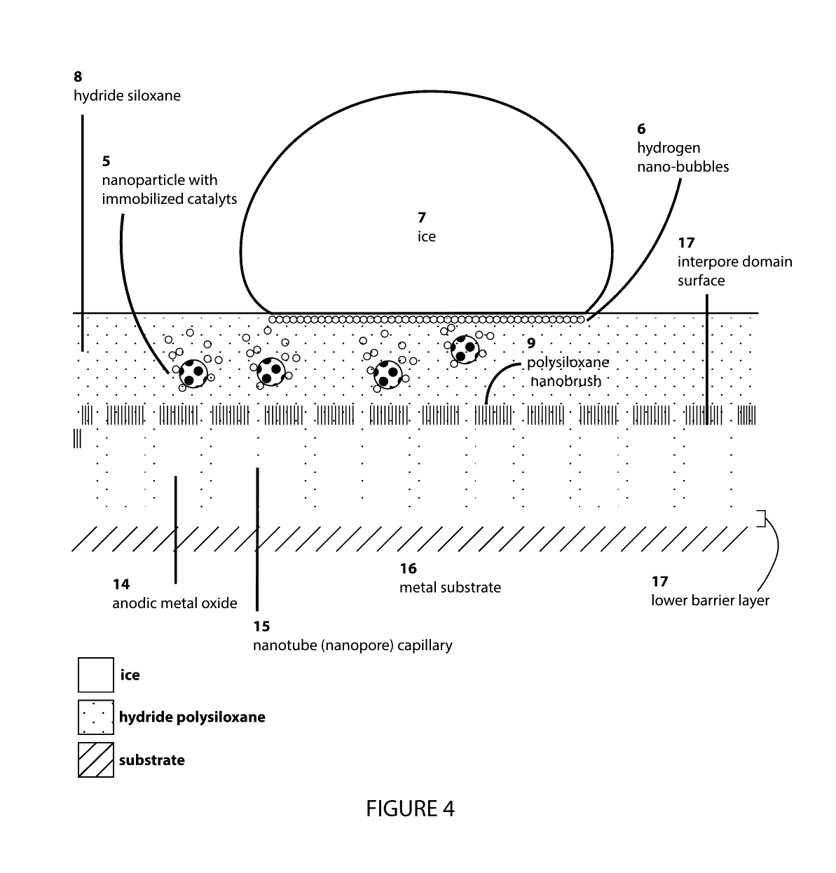

An anodic metal oxide film grown on a metal or a metal alloy provides nanoporous surfaces with a plurality of arrays of nanotubes. The nanotubes arrays can serve as channels to store and supply nanoparticle-infused hydride polysiloxanes from the bulk phase to the surface. The present invention discloses an ice-separating composition on a nanoporous substrate, said nanoporous substrate is an anodized metal oxide film grown on a metal or a metal alloy (see FIG. 4). Said anodized metal oxide film grown on a metal or metal alloy results from anodizing a substrate having a metal surface using an electrochemical anodization process to form an anodic metal oxide film on said metal surface. The anodic metal oxide film consists of: a) an interpore domain surface, b) a plurality of nanotube arrays having nanotube capillaries, and c) a lower barrier layer (see FIG. 4). Reactive polysiloxane can react with hydroxyl groups on the metal oxide surface to form a layer of end-grafted nanobrushes on interpore domain surfaces and nanotube capillary surfaces. The end-grafted polysiloxane nanobrush layer on interpore domain surfaces can overcome autophobicity and dewetting forces, thus enabling the formation of a continuous, low surface energy, non-wetting, low freezing-point, highly compressible, nanoparticle-infused hydride polysiloxane film on said nanoporous anodic metal oxide film substrate. This nanobrush layer also allows said hydride polysiloxane to penetrate into said plurality of nanotube arrays via capillary force.

When water molecules from the environment penetrate into the nanotube arrays to reach the immobilized catalysts on the surfaces of nanoparticle carriers, they react with hydride polysiloxane, resulting in the generation of hydrogen nano-bubbles. The hydrogen nano-bubbles create pressure to push hydride polysiloxane out of the nanotube capillary arrays, thus supplying the liquid to said surface of interpore domain.

In the present invention, the nanoporous substrate is an anodic metal oxide film. Said anodic metal oxide film can serve as the nanoporous substrate for the novel transparent ice-separating composition. Said anodic metal oxide film comprises of: (a) an interpore domain surface and (b) a plurality of nanotube capillary arrays; said anodic metal oxide film is grown on a metal or a metal alloy by electrochemical anodic oxidation, said metal element is selected from the group consisting of aluminum (Al), bismuth (Bi), cobalt (Co), chromium (Cr), hafnium (Hf), iron (Fe), magnesium (Mg), manganese (Mn), molybdenum (Mo), nickel (Ni), niobium (Nb), antimony (Sb), silicon (Si), tin (Sn), tantalum (Ta), titanium (Ti), vanadium (V), tungsten (W), zinc (Zn), zirconium (Zr), and a mixture thereof.

### Solid Substrates for Novel Ice-Release Composition Include Elastomers

In the present invention, the ice-separating composition can be applied to any solid surface including transparent materials and non-transparent materials such as: metals, alloys, ceramics, glass, elastomers, elastomeric polyurethane, elastomeric polyaspartic ester urea, foamed polyurethane, foamed polyethylene, polyurethane coating, polyaspartic ester urea coating, polyurea coating, polyethylene, polypropylene, polyvinyl chloride, fiberglass reinforced polyester resin, fiberglass reinforced epoxy resin, thermoplastic, thermoset, closed-cell foamed elastomer, microcellular closed-cell foamed elastomer, thermoplastic elastomer, fiber-reinforced polymer composite, and surfaces created by injection molding, casting, vacuum casting, centrifugal casting, reaction injection molding (RIM), structural reaction molding (SRIM), and reinforced reaction molding (RRIM), among others.

In the present invention, the substrate for the transparent ice-separating composition can be selected from a transparent or non-transparent material with an impermeable surface. Said material can be selected from the group comprising various glasses such as soda-lime-silica glass, borosilicate glass and architectural glass, Cer-Vit, Pyrex, Vycor, aluminum oxynitride, metal, alloy, metal oxide, plastics, polymethylmethacrylate, polycarbonate, polyethylene terephthatate, polyactic acid, polyethylene, and a mixture thereof.

In the present invention, a preferred substrate for the ice-separating composition is an elastic material. Preferred elastomers have a high value of elongation at break and low Glass Transition Temperature (Tg). Preferred substrates for the ice-separating composition are selected from the group comprising spray elastomeric polyurea (Tg between −50° C. to −60° C.), spray elastomeric polyurethane (Tg between −40° C. to −50° C.), natural rubber, fluorinated silicone rubber, styrene butadiene rubber, butadiene acrylonitrile rubber, isoprene rubber, butadiene rubber, chloroprene rubber, butyl rubber, silicone rubber, urethane rubber, thiokol rubber, fluoroelastomer, acrylate rubber, ethylene-propylene rubber, epoxide rubber, polypentenomer, alternating rubber, and a mixture thereof.

In the present invention, a preferred elastomer as substratum material is thermoset or vulcanization elastomer; said thermoset or vulcanization elastomer is selected from the group consisting of polyurea elastomer, polyurethane elastomer, nature polyisoprene, cis-1,4-polyisoprene (natural rubber NR), trans-1,4-polyisoprene (gutta-percha), synthetic polyisoprene (IR), polybutadiene rubber (BR), chloroprene rubber (Neoprene, CR), poly(isobutylene-co-isoprene) (Butyl rubber, IIR), chlorobutyl rubber (CIIR), nitrile rubber (NBR), hydrogenated nitrile rubber (HNBR), ethylene propylene rubber (EPM), ethylene propylene diene rubber (EPDM), epichlorohydrin rubber (ECO), polyacrylic rubber (ACM, ABR), silicone rubber (VMQ), polyether block amide (PEBA), chlorosulfonated polyethylene (CSM), polysulfide rubber, fluorosilicone rubber (FVMQ), fluoroelastomer (FKM and FEPM), perfluoroelastomer (FFKM), polybutadiene-acrylonitrile, Tiokol, fluoroelastomer, polypentenomer, alternating rubber, polystyrene, polyether ester, polysulfide, and a mixture thereof. A preferred thermoplastic elastomer as substratum material is selected from the group consisting of polystyrenic block copolymer, polyolefin blend, elastomeric alloy (TPE-v, TPV), thermoplastic polyurethane, thermoplastic copolyester, thermoplastic polyamide, and a mixture thereof.

In the present invention, a preferred substrate for the ice-separating composition is a fiber-reinforced polymer composite; said fiber is selected from the group consisting of glass fiber, carbon fiber, Aramid® fiber, wood fiber, and a mixture thereof.

In the present invention, a preferred substrate for the ice-separating composition is a polymer; said polymer is selected from the group consisting of unsaturated polyester (UP, UPE), epoxy (EP), polyamide (PA, Nylon), vinyl ester, polyoxymethylene (POM), polypropylene (PP), polyethylene (PE), high density polyethylene (HDPE), polycarbonate (PC), acrylonitrile-butadiene-styrene (ABS), polyvinyl chloride (PVC), polyethylene terephthalate (PET), polybutylene-terephthalate (PBT), polylactic acid (PLA), vinyl ester (VE), and a mixture thereof.

In this invention, the most preferred elastic substratum is a closed-cell foamed elastomer or closed-cell microcellular foamed elastomer made with a low Tg elastomer material using spray coating, casting, vacuum casting, centrifugal casting, molding, injection molding, reaction injection molding, and reaction injection molding processes.

In the present invention, a preferred solvent-borne coating as a substrate material is selected from the group consisting of oxidative drying resin, amino resin, unsaturated polyester, epoxide, radiation curing, electron beam curing, vinyl polymer, alkyd resin, oligoethylene, oligopropylene, hydrocarbon resin, oligoether, oligoester, polyurethane, polyurea, epoxy, polyacrylic, polyamide, polyimide, polycarbonate, polydiene, polyester, polyether, polyfluorocarbon, polyolefin, polystyrene, polyvinyl acetal, polyvinyl chloride, polyvinylidene chloride, polyvinyl ester, polyvinyl ether, polyvinyl ketone, and a mixture thereof.

In the present invention, a preferred substrate is a thermoplastic. The preferred thermoplastic is selected from the group consisting of high density polyethylene (HDPE), low density polyethylene (LDPE), polyethylene (PE), polyvinyl chloride (PVC), polypropylene (PP), polyethylene terephthalate (PET), polymethylmethacrylate (PMMA), polycarbonate (PC), acrylonitrile-butadiene-styrene (ABS), polyamide (Nylon 6), polyimide (PI), polysulfone (PSF), polyamide-imide (PAI), polyetherimide (PEI), polyether ether ketone (PEEK), polyaryletherketone (PEAK). cyclic olefin copolymer (COC), ethylene-vinyl acetate (EVA), polyoxymethylene (POM), polyacrylate (Acrylic), polyacrylonitrile (PAN), polybutadiene (PBD), polybutylene (PB), polycaprolactone (PCL), polyester (PE), polyurethane (PU), polyurea, polyvinylidene chloride (PVDC). polyolefin, polyolefin blend, poly(ethylene-co-propylene), PP/EPDM, polystyrene (PS), polybutylene-terephthalate (PBT), polyphenylene ether (PPE), polyvinyl acetate (PVA), polyacrylethersulphone (PAES), polyphenylene sulfide, Liquid Crystal Polymer (LCP), and a mixture thereof.

### EXAMPLES

The objectives, advantages and embodiments of this invention are further illustrated by the following examples. However, the particular materials and amounts recited thereof in these examples, as well as other conditions and details, should not be construed to unduly limit this invention. These examples are merely for illustrative purposes only and are not to limit the scope of the appended claims.

### Example 1 (Preparation of Glass Surface Silane Residue Remover)

Ethanol (reagent grade, denatured) and potassium hydroxide (reagent grade) were purchased from Aldrich. 10 g of potassium hydroxide (10 g, 0.178 mol) and 48 g of ethanol were added to a 125 ml narrow-mouth Erlenmeyer flask and stirred for 4 hours. The appearance of the alkali solution of KOH-saturated ethanol changed from colorless and transparent to a dark brown liquid.

### Example 2 (General Procedure for Anti-Icing Tests)

Clean soda-lime-silica watch glasses (diameter ˜82 mm) were used as substrates. Any traces of alkyl silane 2D surface networks on watch glass surfaces were removed using a treatment with the solution obtained in Example 1, wherein the watch glasses were immersed in the solution for one hour, followed by rinsing in distilled water. The residue-free watch glasses were then dried in a Blue M® gravity convection oven at 110° C. for 2 hours and cooled to room temperature. The resulting watch glass surfaces were hydrophilic.

Anti-icing tests were conducted under −20 to −30° C. in a Thermo Scientific Revco® Ultima upright freezer. Distilled water with a volume of 47 microliters and a contact surface of around 0.25 cm² was dripped onto each watch glass. After freezing, a force gauge (Shimpo FGV-50XY or Shimpo FGV-5XY) was used to measure ice removal force.

### Example 3 (Anti-Icing Tests: Polydimethylsiloxane Coated Watch Glass)

Trimethylsiloxy terminated polydimethylsiloxane was purchased from Gelest, Inc. Inert polydimethylsiloxanes (CAS: 9016-00-6) with an average molecular weight of 550 (DMS-T03), 2,000 (DMS-T12), 28,000 (DMS-T31), 204,000 (DMS-T53), and 423,000 (DMS-T63) were each coated onto the five sets of watch glasses using Kimwipes®. The thicknesses of the polysiloxane coatings were in the range of 0.75-2.5 microns. No samples showed ice removal forces smaller than 1.0 kg·f/cm².

### Example 4 (Anti-Icing Tests: Polymethylhydrosiloxane and Polymethylhydrosiloxanes-Co-Dimethylsiloxane Copolymer Coated Watch Glasses)

Trimethylsiloxy terminated polymethylhydrosiloxane and trimethylsiloxy terminated methylhydrosiloxanes-co-dimethylsiloxane copolymer were purchased from Gelest, Inc. Trimethylsiloxy terminated polymethylhydrosiloxane (CAS: 63148-57-2) with an average molecular weight of 1,400-1,800 (HMS-991), 1,800-2,100 (HMS-992), and 2,100-2,400 (HMS-993), were each coated onto five sets of watch glasses using Kimwipes®. The thickness of the polysiloxane coating ranged from 0.75 to 2.5 microns.

Trimethylsiloxy terminated methylhydrosiloxanes-co-dimethylsiloxane copolymers (CAS: 68037-59-2) with average molecular weights of 900-1,200 (HMS-501), 1,900-2,000 (HMS-301), 5,500-6,500 (HMS-082), and 55,000-65,000 (HMS-064) were each coated onto five sets of watch glasses using Kimwipes®. The thicknesses of the polysiloxane coatings ranged from 0.75 to 2.5 microns. No samples showed ice removal forces smaller than 1.0 kg·f/cm².

### Example 5 (Surface Treatment: Tert-Butyldimthylsilyl Silane Treated Nano-Cellulose Fibers)

Cellulose nanofibrils (3% solid slurries) was purchased from the University of Maine. Tert-butyldimthylsilyl chloride (97%, reagent grade), triethylamine (reagent grade 99.5%), methanol (reagent grade), ethanol (reagent grade, denatured), and acetone (reagent grade) were purchased from Aldrich.

A 500 ml Pyrex five-neck round-bottom flask was immersed in an ice bath. 6 g of cellulose nanofibrils and 200 ml of distilled water were added to the flask. One liquid dripping funnel was filled with a solution of 2% tert-butyldimthylsilyl chloride in 20 ml of methanol and another dripping funnel was filled with a solution of 10% triethylamine in 20 ml of methanol. The mixture was stirred for 5 minutes to form a suspension of cellulose nanofibrils in water. While stirring, the tert-butyldimthylsilyl chloride methanol solution was added drop-wise. The pH of the suspension was kept close to 8 (as measured by a pH meter) by dripping triethylamine into the suspension. The addition was finished in about one hour and then stirred for additional 2 hours.

The contents of the flask were poured into sixteen (16) 25 ml Kimax® centrifuge tubes and placed into a Dupont® Servall® Refrigerated Centrifuge to separate the cellulose nanofibrils from the water. Upon separation, the water layer was discarded. The centrifuging process was repeated 5 more times to clean the cellulose nanofibrils, with the addition of fresh distilled water each time. The centrifuging process was then repeated 5 times with acetone. After each round, the separated acetone layer was discarded and fresh acetone added in. Finally, the centrifuging process was repeated 3 times with ethanol to obtain 6.8 g of tert-butyldimthylsilyl grafted cellulose nanofibrils in the form of a wet slurry with ethanol. The final product was stored in a sealed glass bottle for further use.

### Example 6 (Preparation of KF-La₂O₃—HSbF₆ Catalyst on Titanium Oxide Nano-Particle Carriers)

Fumed Aeroxide® titanium oxide P90 with a specific surface area of 90±20 m²/g and a primary particle size of approximately 14 nm was purchased from Evonik. Fluoroantimonic acid hexa-hydrate, lanthanum nitrate hexa-hydrate (99.9%), ethanol (reagent, denatured), and ammonium fluoride (ACS reagent, >98%) were purchased from Aldrich.

The equipment used in this example includes a 500 ml borosilicate flask that was internally coated with fluorinated polyurethane, a clamp, a 4-neck head equipped with a mechanical stirrer in the central neck and a thermocouple, pressure balance, and ultrasonic horn (probe) in the side necks. A 600-watt high intensity ultrasonic processor supplied 20 kHz of electricity into the horn. The flask was placed in an ice water bath (at 0° C.).

100 ml of distilled water was added into the flask. While stirring, 40 g of fumed Aeroxide® titanium oxide P90 was slowly poured into the flask. The contents were cooled until the temperature reached 4° C. 0.42 g of ammonium fluoride in 20 ml of distilled water was added. The mixture was sonicated with an ultrasound probe (set at 50% pulse mode) for 3 minutes. Lanthanum nitrate hexa-hydrate (1.44 g) dissolved in 50 ml of distilled water and fluoroantimonic acid hexa-hydrate (3.45 g) dissolved in 50 ml of distilled water were added into the flask. The mixture was sonicated with an ultrasound probe (set at 50% pulse mode) for 15 minutes. After the completion of ultrasonic sonication, the mixture was heated to 90° C. for 4 hours and then cooled to room temperature. A solution of potassium hydroxide (1%) in water was used to adjust the system pH to 8 and the mixture was stirred for 1 hour. The contents were poured into sixteen (16) 25 ml Kimax® centrifuge tubes and centrifuged in a Dupont® Servall® refrigerated centrifuge to separate titanium oxide nanoparticles from water. The layer of water was discarded. This centrifuge process was repeated twice to wash the deposited titanium oxide nanoparticles with fresh distilled water. The resulting wet paste of titanium oxide nanoparticles was removed and placed on a glass tray to air dry overnight. The dried product was placed into porcelain crucibles and calcined in a Thermolyne® muffle furnace at 380-400° C. for 4 hours. After cooling to room temperature, the mixture was crushed into small particles using a pestle and mortar and then ground into a fine powder. The aggregated 37 g of catalyst was stored in a desiccator for further use.

### Example 7 (Preparation of ZrO₂—La₂O₃—Y₂O₃ Catalyst on Silicon Oxide Nanoparticle Carriers)

Aerosil® 380 with a specific surface area of 380 m²/g was purchased from Evonik. Zirconium oxynitrate hydrate (technical grade), lanthanum nitrate hexa-hydrate (99.9%), yttrium nitrate hexa-hydrate (99.9%), ethanol (reagent, denatured), and nitric acid (ACS reagent, 70%) were purchased from Aldrich.

100 ml of ethanol was added to the flask. While stirring, 40 g of Aerosil® 380 fumed silica was slowly poured into the flask. The contents were cooled until the temperature reached 4° C. The mixture was sonicated with an ultrasound probe (set at 50% pulse mode) for 5 minutes. After sonication, zirconium oxynitrate hydrate (2.3 g) dissolved in 40 ml of ethanol, lanthanum nitrate hexa-hydrate (3.2 g) dissolved in 60 ml of ethanol, and yttrium nitrate hexa-hydrate (0.95 g) dissolved in 20 ml of ethanol were added into the flask. The mixture was sonicated with an ultrasound probe (at 50% pulse mode) for 5 minutes. The contents were removed and placed into sixteen (16) 25 ml Kimax® centrifuge tubes, and centrifuged using a Dupont® Servall® refrigerated centrifuge. The ethanol layer was separated and removed. 0.01 N nitric acid was added into the tubes and centrifuged to separate the titanium oxide nanoparticles from the 0.01 N nitric acid, which was then discarded. The wet paste of titanium oxide nanoparticles was placed on a glass tray and allowed to air dry overnight. The resulting 38 g of catalyst was stored in a desiccator for further use.

### Example 8 (Preparation of Ru (II) Carbine Complex of NCN-Pincer 1,3-Bis(2-Pyridylmethyl)-1H-4-Methyl Siloxypropyl Imidazolium Immobilized on Aluminum Oxide Nanoparticle Carriers)

Aeroxide® aluminum oxide Alu 130 with a specific surface area of 130±20 m²/g was purchased from Evonik. 3-Isocyanatopropyl trimethoxysilane was purchased from Gelest, Inc. 4-imidazolemethanol hydrochloride (98%), 2-(chloromethyl) pyridine hydrochloride (98%), ruthenium (III) chloride, ethylene glycol (99.8%), potassium carbonate (ACS reagent >99%), sodium hydrogen carbonate (reagent >98%), potassium hexafluorophosphate (98%), tin (IV) bis(acetylacetonate) dichloride (98%), dichloromethane (HPLC, 99.9%), acetonitrile (HPLC grade, 99.9%), diethyl ether (ACS reagent 98%), chloroform (HPLC, 99.9%), ethanol (anhydrous, denatured), nitric acid (ACS reagent, 70%), and acetic acid (anhydrous, ACS reagent, 99.5%) were purchased from Aldrich.

A 250 mL, four-neck round-bottom glass flask having a heating jacket and equipped with a stirrer, thermocouple, nitrogen inlet, liquid dripping funnel, and condenser was pre-dried. 4-imidazolemethanol hydrochloride (2.0 g, 14.56 mmol), 2-(chloromethyl) pyridine hydrochloride (3.7 g, 22.16 mmol), and NaHCO₃ (4.5 g, 52.5 mmol) were stirred into 80 ml of ethanol and refluxed for 3 days. The mixture was cooled to −30° in a freezer and the solvent was removed. The deposited gummy mass was treated 4 times with 25 ml dichloromethane each time and filtered to remove the NaCl and NaHCO₃. The volume of the reddish solution was reduced to about 10 mL by evaporation, added to 10 mL of diethyl ether, and crystallized. The ligand percentage yield was 65%.

A 25 ml round-bottom single neck glass flask having a heating jacket and equipped with a condenser was pre-dried. A mixture of RuCl₃ (0.10 g, 0.45 mmol), the previously obtained ligand (0.2 g, 0.85 mmol), and K₂CO₃ (0.2 g, 1.31 mmol) in 10 mL of ethylene glycol was heated to 160° C. for 6 hours. After cooling to room temperature, KPF₆ (0.18 g, 0.99 mmol) saturated in 5 ml of dichloromethane was added. The mixture was cooled in a freezer until it reached a temperature of −20° C. and greenish-yellow crystals were obtained. The crystals were filtered and re-crystallized using ethyl ether. The percentage yield of Ru(II) carbine complex of NCN-pincer 1, 3-bis(2-pyridylmethyl)-1H-4-methanolbenzimidazolium was 65%. The product was dissolved in 50 ml of chloroform-acetonitrile (in the ratio of 2:1).

A 500 ml borosilicate flask with a clamp and a 4-neck head equipped with a mechanical stirrer in the central neck and a thermocouple, pressure balance, and an ultrasonic horn (probe) in the side necks was pre-dried. A 600-watt high intensity ultrasonic processor supplied 20 kHz of electricity to the horn. The flask was placed in an ice water bath (at 0° C.) and 100 ml of ethanol was added to the flask. While stirring, 40 g of Aeroxide® aluminum oxide Alu 130 was slowly poured into the flask. The contents were cooled until the temperature reached 4° C. The mixture was sonicated with an ultrasound probe (set at 50% pulse mode) for 5 minutes.

In a 25 ml test tube, 3-Isocyanatopropyl trimethoxysilane (0.2 g, 1.00 mmol) was dissolved in 10 ml of ethanol. Two drops of acetic acid were added and the mixture was allowed to sit for one hour. The test tube contents were then added into the 500 ml flask and the mixture was sonicated for 5 minutes and stirred for 2 hours. Two drops of tin (IV) bis(acetylacetonate) dichloride were added into flask while stirring. After 5 minutes, Ru(II) carbine complex of NCN-pincer 1, 3-bis(2-pyridylmethyl)-1H-4-methanolbenzimidazolium (0.29 mmol) in 50 ml of chloroform-acetonitrile (in the ratio of 2:1) was added in. The mixture was stirred continuously for one hour. The contents were removed and placed into sixteen (16) 25 ml Kimax® centrifuge tubes and centrifuged using a Dupont® Servall® refrigerated centrifuge. The ethanol layer was separated and discarded. The deposited aluminum oxide nanoparticles were washed three times by centrifuging with fresh ethanol. The resulting 38 g of dried Ru (II)NCN-pincer complex grafted on aluminum oxide nanoparticles was stored in a desiccator for further use.

### Example 9 (Synthesis of Low Molecular Weight Polyaspartic Ester Amine-Functional Siloxane)

Alpha, omega-bis (3-aminopropyl) tetramethyldisiloxane (CAS 2469-55-8, C₁₀H₂₈N₂OSi₂, FW 248.52, 98%) was purchased from a commercial source and diethyl maleate (CAS: 141-05-9, C₈H₁₂O₄, FW 172.18, 97%) was purchased from Aldrich.

A 1,000 ml five-neck round-bottom glass flask having a heating/cooling jacket and equipped with a stirrer, thermocouple, nitrogen inlet, liquid dripping funnel, and a condenser connected to a vacuum line was pre-dried. Alpha, omega-bis (3-aminopropyl) tetramethyldisiloxane (127 g, 0.5 mol) and the KF-La₂O₃—HSbF₆ catalyst grafted on titanium oxide nanoparticle carriers obtained in Example 6 (0.254 g) were charged in. While slowly stirring, nitrogen was bubbled into the solution for 20 minutes. The system temperature was kept at 15° C. Diethyl maleate (186 g, 1.05 mol) was slowly dripped into the stirred solution via the dripping funnel over a period of 2 hours under nitrogen aeration. The system temperature was kept at 40° C. After the addition of the diethyl maleate, the reaction mixture in the flask was heated to 70° C. for 8 hours, then to 80° C. for 16 hours, and finally to 95° C. for 24 hours, under continuous aeration with nitrogen. The resulting contents were removed and placed into a Büchi rotary evaporator to remove unreacted diethyl maleate. A total of 296 g of polyaspartic ester siloxane amine based on bis(3-aminopropyl) tetramethyldisiloxane was obtained. The polyaspartic ester amine functional polydimethylsiloxane had a solids content of 99%, NH content of 5.1%, and equivalent weight of 297.

### Example 10 (Synthesis of Medium Molecular Weight Polyaspartic Ester Amine-Functional Siloxane)

Alpha, omega-bis (3-aminopropyl) polydimethylsiloxane (CAS 106214-84-0, F.W. 850-900), was purchased from a commercial source, and diethyl maleate (CAS: 141-05-9, C₈H₁₂O₄, F.W. 172.18, 97%) was purchased from Aldrich. A 1,500 ml five-neck round-bottom glass flask having a heating/cooling jacket and equipped with a stirrer, thermocouple, nitrogen inlet, liquid dripping funnel, and a condenser connected to a vacuum line was pre-dried.

Alpha, omega-bis (3-aminopropyl) polydimethylsiloxane (438 g, 0.5 mol) and the KF-La₂O₃—HSbF₆ catalyst grafted on titanium oxide nanoparticle carriers obtained in Example 6 (2.15 g) were charged in. Nitrogen was bubbled into the solution under slow stirring for 20 minutes. The system temperature was kept at 15° C. Diethyl maleate (186 g, 1.05 mol) was slowly dripped into the stirred solution via the dripping funnel over a period of 2 hours under nitrogen aeration. The system temperature was kept at 40° C. After the addition of the diethyl maleate, the reaction mixture in the flask was heated to 70° C. for 8 hours, then to 80° C. for 16 hours, and finally to 95° C. for 24 hours, under continuous aeration with nitrogen. The resulting contents were removed and placed into a Büchi rotary evaporator to remove unreacted diethyl maleate. A total of 616 g of polyaspartic ester siloxane amine based on bis(3-aminopropyl) tetramethyldisiloxane was obtained. The polyaspartic ester amine functional polydimethylsiloxane had a solids content of 99%, NH content of 2.4%, and equivalent weight of 610.

### Example 11 (Synthesis of Cyclic (Dihydrosiloxane)ₙ)

Dichlorosilane (CAS: 4109-96-0, >97%, FW 101.01), 1,4-Dioxane (CAS: 123-91-1, ACS reagent >99%), and calcium carbonate (>99%, FW 100.09) were purchased from Aldrich.

A 1,000 ml five-neck round-bottom glass flask having a heating/cooling jacket and equipped with a stirrer, thermocouple, nitrogen inlet, Ace® powder dispensing funnel, and a condenser connected to a vacuum line was pre-dried. Calcium carbonate was kept in Wheaton Dry-Seal® vacuum desiccator over P₂O₅ before use.

500 ml of 1,4-dioxane was loaded in the 1,000 ml flask. 41.6 g of dichlorosilane (0.40 mol) was mixed in. The contents were cooled to 0° C. under stirring and under a nitrogen atmosphere. 41.0 g of calcium carbonate (0.405 mol) was slowly added through a powder dispensing funnel under stirring. The CO₂ evolution was progressed slowly over the course of 2 hours and the mixture was kept at temperatures below 20° C. After the CO₂ evolution ceased, the contents were vacuum filtrated through a Buchner funnel with a removable frit to remove solid calcium chloride and unreacted calcium carbonate. The solution was concentrated by a Büchi rotary evaporator under a vacuum. 16.1 g of cyclic hydrosiloxane (H₂SiO)ₙ was recovered (n=2-6). The yield was 87.5%. This synthesis process were repeated 10 times, yielding a total of 175 g of cyclic (dihydrosiloxane)ₙ.

### Example 12 (Synthesis of Cyclic (Dihydrosiloxane-Alt-Methylhydrosiloxane)ₙ)

Dichlorosilane (CAS: 4109-96-0, >97%, FW 101.01), dichloromethylsilane (CAS: 75-54-7, 99%, FW 115.03), calcium carbonate (>99%, FW 100.09), and hexane (CAS: 110-54-3, reagent plus >95%) were purchased from Aldrich. A 1,000 ml five-neck round-bottom glass flask having a heating/cooling jacket and equipped with a stirrer, thermocouple, nitrogen inlet, Ace® powder dispensing funnel, and a condenser connected to a vacuum line was pre-dried.

Calcium carbonate was kept in Wheaton Dry-Seal® vacuum desiccator over P₂O₅ before use.

500 ml of hexane was loaded in the 1,000 ml flask. 23.2 g of dichloromethylsilane (0.20 mol), and 20.8 g of dichlorosilane (0.20 mol) were mixed in. The contents were cooled to 0° C. under stirring and under a nitrogen atmosphere. 41.5 g of calcium carbonate (0.41 mole) was slowly added through powder dispensing funnel under stirring. The CO₂ evolution was progressed slowly over the course of 2 hours and the mixture was kept below 20° C. After the CO₂ evolution ceased, the contents were vacuum filtrated through a Buchner funnel with a removable frit to remove solid calcium chloride and unreacted calcium carbonate. The solution was concentrated by a Büchi rotary evaporator under a vacuum. 18.5 g of cyclic hydrosiloxane (H₂SiO-alt-CH₃HSiO)ₙ with alternating (H₂SiO) and (CH₃HSiO) units was recovered (n=2-6). The yield was 87%. This synthesis process were repeated 10 times, yielding a total 192 g of cyclic (dihydrosiloxane-alt-methylhydrosiloxane)ₙ.

### Example 13 (Synthesis of High Molecular Weight Poly(Dihydrosiloxane) from Ring Opening Polymerization of Cyclic (Dihydrosiloxane)ₙ Catalyzed by Water Tolerant Lewis Acid Catalyst ZrO₂—La₂O₃—Y₂O₃ Immobilized on Silicon Oxide Nanoparticle Carriers)

Hexamethyldisiloxane (CAS 107-46-0, (CH₃)₃SiOSi(CH₃)₃, FW 162.38, >98%) was purchased from commercial source. Ethyl Propionate (CAS 105-37-3, 99%, FW 102.13) was purchased from Aldrich. The ZrO₂—La₂O₃—Y₂O₃ catalyst on silicon oxide nano particle carriers was obtained from Example 7 and cyclic (dihydrosiloxane)ₙ was obtained from Example 11. A 500 ml borosilicate flask, a clamp, a 5-neck head equipped with a mechanical stirrer in the central neck and a thermocouple, liquid dripping funnel, condenser with pressure balance, and a nitrogen bubbler was pre-dried.

The flask was placed in an ice water bath (at 0° C.). 100 ml of ethyl propionate and 1.6 g of Lewis acid ZrO₂—La₂O₃—Y₂O₃ immobilized catalyst on silica nanoparticles were added into the flask. Under nitrogen bubbling and stirring, the cyclic (dihydrosiloxane)ₙ (D₄₋₆²¹¹, 162 g) was dripping into the flask very slowly over the course of 2 hours. The contents were kept between 5-15° C. The temperature of the contents was then raised to 30-35° C. and hexamethyldisiloxane (2.30 g, 13.3 mmol) was slowly dripped into the flask from the dripping funnel over the course of one hour. The ring opening polymerization was continued under stirring and under a nitrogen atmosphere at 40° C., while continuously monitoring gas chromatography for any residual monomer. After the disappearance of Dₙ^{2H}, the system was brought to room temperature. The contents were vacuum filtrated through a Buchner funnel with a removable frit to remove solid nanoparticles with immobilized catalysts. The solution was concentrated by a Büchi rotary evaporator under a vacuum. 148 g of polydihydrosiloxane was recovered. The obtained polydihydrosiloxane had an average molecular weight of ˜12,000 Dalton as measured by GPC.

### Example 14 (Synthesis of High Molecular Weight Poly(Dihydrosiloxane-Alt-Methylhydrosiloxane) by Catalytic Cationic Ring Opening Polymerization of Cyclic (Dihydrosiloxane-Alt-Methylhydrosiloxane)ₙ)

Hexamethyldisiloxane (CAS 107-46-0, (CH₃)₃SiOSi(CH₃)₃, FW 162.38, >98%) and zirconium oxynitrate hydride (CAS 14985-18-3, ZrO(NO₃)₂. xH₂O, FW 231.23 technical grade) were purchased from commercial sources. Cyclic (dihydrosiloxane-alt-methylhydrosiloxane)ₙ was obtained from Example 11. A 500 ml borosilicate flask, a clamp, a 5-neck head equipped with a mechanical stirrer in the central neck and a thermocouple, liquid dripping funnel, condenser with pressure balance, and an ultrasonic horn (probe) in the side neck were assembled. A 600-watt high intensity ultrasonic processor supplied 20 kHz of electricity to the horn.

100 ml of distilled water and zirconium oxynitrate hydride catalyst (0.232 g, 1.0 mmol) were added into the flask. After stirring for 10 minutes, the zirconium oxynitrate was dissolved and 182 g of cyclic (dihydrosiloxane-alt-methylhydrosiloxane)ₙ was added into the flask. The contents were cooled to 12° C. The mixture was sonicated using an ultrasound probe (set at 50% pulse mode) for 3 minutes under stirring to form a fine emulsion. Under stirring, the temperature was raised to 40° C. and hexamethyldisiloxane (3.3 g, 20.0 mmol) was slowly dripped into the flask from the dripping funnel over the course of 2.5 hours. The ring opening polymerization was continued under stirring at 40° C., while continuously monitoring gas chromatography for any residual monomer. After the disappearance of cyclic (dihydrosiloxane-alt-methylhydrosiloxane)ₙ, the stirring was stopped and the system was brought to room temperature. The water phase was separated and removed using a Pyrex® Squibb separator funnel. 168 g of raw product was recovered. The residual water was further removed by drying the product with an activated 3A molecular sieve. The obtained poly(dihydrosiloxane-alt-methylhydrosiloxane) had an average molecular weight of ˜8,600 Dalton as measured by GPC.

### Example 15 (Synthesis of High Molecular Weight Polymethylhydrosiloxane by Catalytic Cationic Ring Opening Polymerization of D₄^{H})

2,4,5,8-Tetramethylcyclotertasiloxane (D₄^{H}, CAS 2370-88-9, (HSiCH₃O)₄ FW 240.15, 99.5%), Hexamethyldisiloxane (CAS 107-46-0, (CH₃)₃SiOSi(CH₃)₃, FW 162.38, >98%), and zirconium oxynitrate hydride (CAS 14985-18-3, ZrO(NO₃)₂. xH₂O, FW 231.23 technical grade) were purchased from commercial sources. A 500 ml borosilicate flask, a clamp, a 5-neck head equipped with a mechanical stirrer in the central neck and a thermocouple, liquid dripping funnel, condenser with pressure balance, and an ultrasonic horn (probe) in the side necks was pre-dried. A 600-watt high intensity ultrasonic processor supplied 20 kHz of electricity to the horn.

Hexamethyldisiloxane was added to the liquid dripping funnel. 65 ml of distilled water and zirconium oxynitrate hydride catalyst (0.325 g, 1.4 mmol) were added into the flask. After stirring for 10 minutes, the zirconium oxynitrate was dissolved and tetramethylcyclotertasiloxane (D₄^{H}, 200 g, 0.83 mol) was added into the flask. The contents were cooled to 8° C. The mixture was sonicated using an ultrasound probe (set at 50% pulse mode) for 3 minutes under stirring to form a fine emulsion. Under stirring, the temperature was raised to 40° C. and hexamethyldisiloxane (4.13 g, 25 mmol) was slowly dripped into the flask from the dripping funnel over the course of 3 hours. The ring opening polymerization was continued under stirring at 40° C., while continuously monitoring gas chromatography for any residual monomer. After the disappearance of D₄^{H}, the system was brought to room temperature. The water phase was separated and removed using a Pyrex® Squibb separator funnel. 187 g of raw product was recovered. The residual water was further removed by drying the product with an activated 3A molecular sieve. The obtained polymethylhydrosiloxane had an average molecular weight of ˜8,000 Dalton as measured by GPC.

### Example 16 (Preparation of Anti-Icing Coating Composition #1)

0.0471 g of the ZrO₂—La₂O₃—Y₂O₃ catalyst on silicon oxide nanoparticle carriers obtained in Example 7; 9.794 g of polydihydrosiloxane (MW ˜8,600 Dalton) obtained in Example 13; 9.865 g of poly(dihydrosiloxane-alt-methylhydrosiloxane) (MW ˜8,600 Dalton) obtained in Example 14; and 30.103 g of polymethylhydrosiloxane (MW ˜8,000 Dalton) obtained in Example 15 were added into a 100 ml glass bottle. The mixture was stirred with a glass rod to formulate Anti-icing Coating #1.

### Example 17 (Preparation of Anti-Icing Coating Composition #2)

0.0346 g of the (Ru (II) carbine complex of NCN-pincer 1,3-bis(2-pyridylmethyl)-1H-4-methyl siloxypropyl imidazolium catalyst immobilized on aluminum oxide nanoparticle carriers obtained in Example 8; 9.902 g of polydihydrosiloxane (MW ˜8,600 Dalton) obtained in Example 13; 10.112 g of poly(dihydrosiloxane-alt-methylhydrosiloxane) (MW ˜8,600 Dalton) obtained in Example 14; and 30.255 g of polymethylhydrosiloxane (MW ˜8,000 Dalton) obtained in Example 15 were added into a 100 ml glass bottle. The mixture was stirred with a glass rod to formulate Anti-icing Coating #2.

### Example 18 (Preparation of Nanoporous Base Coating for Anti-Icing Composition)

MHX-1107 Fluid (low molecular weight polymethylhydrosiloxane, 20 cSt) was purchased from Dow Corning. Glass slides were dipped in a KOH-alcohol solution for 4 hours. The KOH-alcohol solution was prepared by following Example 1. After rinsing with distilled water and oven drying for 1 hour at 110° C., the slides were cooled to room temperature and labeled on the back face.

A novel two-component polyaspartic ester amino-siloxane spray coating composition was prepared which consisted of (1) polyaspartic ester amino-siloxane as Component A, and (2) hydride polysiloxane as Component B (cross-linker). The preparation of the nanoporous base coating in this example requires mixing Component A with a large volume of solvent to support the suspension of the nanoparticles or nanofibers.

Preparation of Component A (polyaspartic ester amino-siloxane): In a 1,000 ml beaker, tert-butyl acetate (200 ml), the low molecular weight polyaspartic ester amine-functional siloxane (0.811 g, 1.36 mmol) obtained in Example 9, the medium molecular weight polyaspartic ester amine-functional polysiloxane (0.226 g, 0.185 mmol) obtained in Example 10, and the ZrO₂—La₂O₃—Y₂O₃ catalyst on silicon oxide nanoparticle carriers (0.0015 g) obtained in Example 7 were combined. The mixture was stirred and then sonicated to form a transparent suspension. The butyldimthylsilyl chloride treated nano-cellulose fibers (6.0 g) obtained in Example 5 were then added to the suspension under stirring.

Preparation of Component B: 1.00 g of 20 cSt.MHX-1107 fluid (0.0167 Eq.), a low molecular weight polymethylhydrosiloxane, was used as Component B.

After mixing Components A and B, the novel coating composition was immediately sprayed onto pre-cleaned and labeled glass slides. The slides were placed on an angled aluminum board and sprayed with a very fine mist at a distance of about 20-40 cm using a HVLP spray gun at 25 psi. Each slide was coated on the top face only and the thickness of the coating was adjusted to maintain optical clarity. After the completion of the spray coating, the glass slides were allowed to cure overnight on the aluminum board. After drying, the thicknesses of the nanoporous films were in the range of 2-10 microns (0.0787-0.394 mils).

### Example 19 (Ice Adhesion Testing of Novel Ice-Release Coating on Glass Slides)

Glass slides were dipped in a KOH-alcohol solution for 4 hours. The KOH-alcohol solution was prepared by following Example 1. After rinsing with distilled water and oven drying for 1 hour at 110° C., the slides were cooled to room temperature and labeled on the back face.

Each slide was coated on the front face using a double blade micrometer film applicator. The applicator was set to a wet film thickness of 2 microns (0.0787 mils). The Anti-icing Coatings #1 and #2 from Examples 16 and 17, respectively, were used. After coating, the glass slides were allowed to air dry for at least 4 hours.

A Revco® Ultima upright freezer was set to a temperature range of −25° C. to −30° C. All shelves on a freezer rack were adjusted to a horizontal position. The coated glass samples were placed on trays with the coated side facing up and pre-cooled to −25° C. to −30° C. Distilled water was pre-cooled to 4° C. Using a pipette set to 133.0 microliters (contact area ˜0.50 cm²), three droplets of cooled distilled water were carefully deposited onto each slide. After freezing at −25° to −30° C. for 2 hours, the slides were removed from the freezer and immediately tested for ice removal force. During first 1 to 2 rounds of icing, the frozen droplets were already separated from the slides and no ice removal force was necessary. Any negligible forces lower than 0.001 kg were beyond the measurement range of the Shimpo FGV-5XY force gauge and thus were reported as zero. The ice removal forces for Anti-icing Coatings #1 and #2 on glass slides over multiple rounds are listed below in Table I.

TABLE I

| | | Force required to remove ice from coated slide (kgf) per round | | | | | | | | | |
|---|---|---|---|---|---|---|---|---|---|---|---|
| Samples | | 1st | 2^{nd} | 3rd | 4th | 5th | 6^{th} | 7th | 8th | 9th | 10th |
| #1 | 150104-1 | 0.00 | 0.02 | 0.07 | 0.05 | 0.06 | 0.08 | 0.07 | 0.18 | 0.31 | 0.60 |
| | 150104-2 | 0.00 | 0.02 | 0.08 | 0.09 | 0.03 | 0.06 | 0.09 | 0.18 | 0.49 | 0.31 |
| | 150104-3 | 0.00 | 0.00 | 0.03 | 0.07 | 0.01 | 0.05 | 0.06 | 0.08 | 0.22 | 0.49 |
| | 150519-2 | 0.00 | 0.01 | 0.04 | 0.03 | 0.08 | 0.09 | 0.15 | 0.19 | 0.31 | 0.69 |
| | 150519-3 | 0.00 | 0.02 | 0.02 | 0.04 | 0.02 | 0.05 | 0.06 | 0.12 | 0.38 | 0.43 |
| | 150519-4 | 0.00 | 0.04 | 0.05 | 0.05 | 0.07 | 0.12 | 0.17 | 0.21 | 0.33 | 0.52 |
| #2 | 150804-2 | 0.00 | 0.02 | 0.04 | 0.02 | 0.04 | 0.06 | 0.08 | 0.17 | 0.19 | 0.24 |
| | 150804-3 | 0.00 | 0.01 | 0.02 | 0.03 | 0.03 | 0.05 | 0.08 | 0.14 | 0.19 | 0.22 |
| | 150804-5 | 0.00 | 0.00 | 0.00 | 0.01 | 0.01 | 0.02 | 0.04 | 0.11 | 0.16 | 0.18 |

### Example 20 (Ice Adhesion Testing of Novel Ice-Release Coatings with Nanoporous Base Layer on Glass Slides)

A nanoporous base layer was coated onto glass slides as described in Example 18. Each slide was coated on the front face with Anti-icing Coating #2 (obtained in Example 17) using a double blade micrometer film applicator set to a wet film thickness of 2 microns (0.0787 mils). After coating, the glass slides were allowed to air dry for at least 8 hours.

A Revco® Ultima upright freezer was set to a temperature range of −25° C. to −30° C. All shelves on a freezer rack were adjusted to a horizontal position. The coated glass samples were placed on trays with the coated side facing up and pre-cooled to the range of −25° C. to −30° C. Distilled water was pre-cooled to 4° C. Using a pipette set to 133.0 microliters (contact area ˜0.50 cm²), three droplets of cooled distilled water were carefully deposited onto each slide. After freezing at −25° to −30° C. for 2 hours, the slides were removed from the freezer and immediately tested for ice removal force. During the first 1-5 rounds of icing, the frozen droplets were automatically separated with no removal force necessary. Any negligible forces lower than 0.001 kg were beyond the measurement range of the Shimpo FGV-5XY force gauge and thus were reported as zero. The ice removal forces for Anti-icing Coating #2 applied on a nanoporous base coating on glass slides over multiple rounds are listed in Table II.

TABLE II

| | Average force required to remove ice from slide (kgf/cm²) per round | | | | | | | | | |
|---|---|---|---|---|---|---|---|---|---|---|
| Samples | 1st | 2nd | 3rd | 4th | 5th | 6th | 7th | 8th | 9th | 10th |
| 150815-13 | 0.00 | 0.00 | 0.00 | 0.00 | 0.00 | 0.01 | 0.01 | 0.01 | 0.02 | 0.02 |
| 150815-14 | 0.00 | 0.00 | 0.00 | 0.00 | 0.00 | 0.01 | 0.00 | 0.01 | 0.01 | 0.01 |
| 150104-15 | 0.00 | 0.00 | 0.00 | 0.00 | 0.01 | 0.01 | 0.01 | 0.02 | 0.02 | 0.02 |

### Example 21 (Preparation of Ice-Release Coatings on Anodized Aluminum Coupons)

Four (4) aluminum coupons with the dimensions of 56 mm×27 mm×4.8 mm were used as substrates. Surface contaminants were removed using acetone, followed by 0.2 N HF, and finally with 12N HNO₃ at 40-45° C. The cleaned coupons were thoroughly rinsed with distilled water and dried at 110° C. for 2 hours, followed by electro-polishing with a mixture of HClO₄ and ethanol.

The aluminum coupons were anodized under constant cell potential 40 V DC in 0.5 M oxalic acid at 4-5° C. for one hour while the electrolyte was vigorously stirred. The anodized film was removed using a mixture of 6% H₃PO₄ and 1.8% chromic acid at 60° C. for 10 minutes. The coupons were rinsed with distilled water and briefly allowed to air dry in preparation for the second anodization. The second anodization conditions were as follows: 40 V DC in 0.5 M oxalic acid at 4-5° C. for 4 hours. Pore opening was carried out in 5% H₃PO₄ at 35° C. for 30 minutes. After finishing the pore opening, the coupons were thoroughly rinsed with distilled water and dried at 110° C. for 2 hours to obtain the final anodized aluminum coupons.

Anti-icing Coating #2 (obtained in Example 17) was applied to the top face of each aluminum coupon using a small brush. After the coating application, the coupons were allowed to air dry for at least 8 hours.

### Example 22 (Ice Adhesion Testing of Ice-Release Coatings on Anodized Aluminum Coupons)

A Revco® Ultima upright freezer was set to a temperature range of −25° C. to −30° C. All shelves on a freezer rack were adjusted to a horizontal position. The coated aluminum coupons were placed on trays with the coated side facing up and pre-cooled to the range of −25° C. to −30° C. Distilled water was pre-cooled to 4° C. Using a pipette set to 133.0 microliters (contact area ˜0.50 cm²), three droplets of cooled distilled water were carefully deposited onto each coupon. After freezing at −25° to −30° C. for 2 hours, the coupons were removed from the freezer and immediately tested for ice removal force. During the first 1-5 rounds of icing, the frozen droplets were automatically separated with no removal force necessary. Any negligible forces lower than 0.001 kg were beyond the measurement range of the Shimpo FGV-5XY force gauge and thus were reported as zero. The ice removal forces for Anti-icing Coating #2 on anodized aluminum coupons over multiple rounds are listed in Table III.

TABLE III

| | Average force required to remove ice from slide (kgf/cm²) per round | | | | | | | | | |
|---|---|---|---|---|---|---|---|---|---|---|
| Samples | 1st | 2nd | 3rd | 4th | 5th | 6th | 7th | 8th | 9th | 10th |
| 150607-1 | 0.00 | 0.00 | 0.00 | 0.00 | 0.00 | 0.00 | 0.00 | 0.00 | 0.00 | 0.01 |
| 150607-2 | 0.00 | 0.00 | 0.00 | 0.00 | 0.00 | 0.00 | 0.00 | 0.00 | 0.01 | 0.01 |
| 150607-3 | 0.00 | 0.00 | 0.00 | 0.00 | 0.00 | 0.00 | 0.00 | 0.00 | 0.01 | 0.01 |
| 150607-4 | 0.00 | 0.00 | 0.00 | 0.00 | 0.00 | 0.00 | 0.00 | 0.00 | 0.00 | 0.00 |

1. A composition that can repel and detach ice from a substrate based on hydrogen generated from a dehydrogenative reaction, comprising: (a) a reactive hydrogen-rich compound; and (b) a catalyst immobilized on a plurality of nanoparticles; wherein the dehydrogenative reaction is active under subzero temperatures in the presence of water.

2. The anti-icing composition of claim 1, wherein said reactive hydrogen-rich compound is a hydride siloxane selected from polydihydrosiloxane, poly(dihydrosiloxane-alt-methylhydrosiloxane), polymethylhydrosiloxane, poly(dihydrosiloxane-alt-ethylhydrosiloxane), polyethylhydrosiloxane, C(SiH₃)₄, CH(SiH₃)₃, H₃C(SiH₃)₃, cyclic (H₂SiO)₃, cyclic (H₂SiO)₄, cyclic (H₂SiO)₅, cyclic (H₂SiO)₆, cyclic (H₂SiO)₇, cyclic (H₂SiO)₈, cyclic (H₂SiO)₉, cyclic (H₂SiO-alt-MeHSiO)₂, cyclic (H₂SiO-alt-MeHSiO)₃, cyclic (H₂SiO-alt-MeHSiO)₄, cyclic (H₂SiO-alt-MeHSiO)₅, cyclic (H₂SiO-alt-MeHSiO)₆, cyclic (MeHSiO)₃, cyclic (MeHSiO)₄, cyclic (MeHSiO)₅, cyclic (MeHSiO)₆, cyclic (MeHSiO)₇, cyclic (MeHSiO)₈, cyclic (MeHSiO)₉, and a combination thereof.

3. The anti-icing composition of claim 1, wherein a plurality of nanobrushes are grafted onto said substrate by a reactive linear polysiloxane selected from polysiloxane with an alpha-reactive group, polysiloxane with alpha-, and omega-reactive groups, polysiloxane with a plurality of pendant reactive groups, and a combination thereof; wherein the reactive group is selected from acetoxy, alkoxy, alkylamino, alkanolamino, carbinol, chloro, dicarbinol, epoxy, hydride, polyaspartic ester amine, mercapto, silanol, and a combination thereof.

4. The anti-icing composition of claim 1, wherein said substrate is coated with a nanoporous base layer comprising: (4a) a plurality of nanoparticles selected from the group consisting of nanoparticles with immobilized catalysts, fumed aluminum oxide (Al₂O₃), fumed cerium oxide (Ce₂O₃), fumed ferric oxide (Fe₂O₃), fumed lanthanum oxide (La₂O₃), fumed magnesium oxide (MgO), fumed silica (SiO₂), fumed titanium oxide (TiO₂), fumed zirconium oxide (ZrO₂), fibrous silica nanospheres, alumina nanofibers, lithium titanate nanofibers, silica nanofibers, titania nanofibers, zirconia nanofibers, cellulose nanofibers, collagen nanofibers, chitosan nanofibers, gelatin nanofibers, elastin nanofibers, silk fibroin nanofibers, wheat protein nanofibers, and a combination thereof; (4b) a two-component (2K), cross-linkable siloxane comprising a multifunctional siloxane and siloxane cross-linker, said multifunctional siloxane is a siloxane with reactive multifunctional groups selected from acetoxy, alkoxy, amine, aspartic ester amine, butoxy, enoxy, epoxy, methoxy, ethoxy, oxime, propoxy, secondary amine, silanol, and a mixture thereof, said siloxane cross-linker is selected from alkylhydrosiloxane, polyalkylhydrosiloxane, alkylhydrosilanolsiloxane, polyalkylhydrosilanolsiloxane, and a mixture thereof; and (4c) a solvent or solvent mixture.

5. The composition of claim 1, wherein said substrate is an anodic metal oxide comprising an interpore domain surface and a plurality of nanotube (or nanopore) capillaries; said anodic metal oxide is grown on a metal or a metal alloy by electrochemical anodic oxidation, wherein the metal element is selected from aluminum (Al), bismuth (Bi), cobalt (Co), chromium (Cr), hafnium (Hf), iron (Fe), magnesium (Mg), manganese (Mn), molybdenum (Mo), nickel (Ni), niobium (Nb), antimony (Sb), silicon (Si), tin (Sn), tantalum (Ta), titanium (Ti), vanadium (V), tungsten (W), zinc (Zn), zirconium (Zr), and a mixture thereof.

6. The composition of claim 1, wherein said nanoparticle is a fumed oxide, a nanofiber, or a combination thereof; said fumed oxide is selected from the group consisting of fumed aluminum oxide (Al₂O₃), fumed cerium oxide (Ce₂O₃), fumed ferric oxide (Fe₂O₃), fumed lanthanum oxide (La₂O₃), fumed magnesium oxide (MgO), fumed silica (SiO₂), fumed titanium oxide (TiO₂), fumed zirconium oxide (ZrO₂), and a mixture thereof; said nanofiber is selected from the group consisting of fibrous silica nanospheres, alumina nanofibers, lithium titanate nanofibers, silica nanofibers, titania nanofibers, zirconia nanofibers, cellulose nanofibers, collagen nanofibers, chitosan nanofibers, gelatin nanofibers, elastin nanofibers, silk fibroin nanofibers, wheat protein nanofibers, and combinations thereof.

7. The composition of claim 1, wherein said catalyst is selected from the group consisting of a metal atom, metal nano-cluster, dihydrogen complex of metal, metal organic, metal acetate, metal benzoate, metal borate, metal boride, metal bromide, metal carbonate, metal chloride, metal citrate, metal fluoride, metal fluoroalkylsulfonate metal formate, metal hexafluorophosphate, metal hexanoate, metal oxide chloride, metal hydride, metal hydroxide, metal iodide, metal lactate, metal maleate, metal malonate, metal molybdate, metal nitrate, metal oleate, metal oxide, metal oxide with reduced valence, metal nitrate, metal oxalate, metal oxide, metal oxide nitrate, metal perchlorate, metal perfluoroalkylsulfonate, metal phosphate, metal salicylate, metal sebacate, metal selenide, metal stearate, metal sulfate, metal sulfide, metal tartrate, metal teflate, metal telluride, metal tetrafluoroborate, metal tetrakis(pentafluorophenyl)boranate [B(C₆F₅)₄]⁻, metal triflate (trifluoromethanesulfonate), metal tungstate, and combinations thereof; wherein the metal element is selected from Sc, Y, La, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and combinations thereof.

8. The composition of claim 1, wherein said catalyst is a water tolerant Lewis acid based on a metal salt selected from metal acetate, metal bromide, metal borate, metal chloride, metal oxide chloride, metal citrate, metal fluoroalkylsulfonate, metal fluoride, metal fluoroalkylsulfonate, metal formate, metal hexafluorophosphate, metal hexanoate, metal iodide, metal lactate, metal maleate, metal malonate, metal nitrate, metal oxide nitrate, metal oleate, metal oxide, metal perchlorate, metal perfluoroalkylsulfonate, metal salicylate, metal sebacate, metal stearate, metal sulfate, metal tartrate, metal teflate, metal tetrafluoroborate, metal tetrakis(pentafluorophenyl)boranate [B(C₆F₅)₄]⁻, metal triflate (trifluoromethanesulfonate), and combinations thereof; wherein the metal element is selected from the group consisting of Sc, Y, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and combinations thereof.

9. The composition of claim 1, wherein said catalyst is an organometallic complex comprising a metal element atom (ion) coordinated with at least a ligand; wherein the metal element is selected from Ru, Rh, Pd, Os Ir, Pt, Sc, Y, Ti, Zr, Hf, V, Nb, Ta, Cr, Mo, W, Mn, Fe, Co, Ni, Cu, Ag, Au, Zn, Sn, lanthanides (La, Ce, Pr, Nd, Pm, Sm, Eu, Gd, Tb, Dy, Ho, Er, Tm, Yb, Lu), and combinations thereof, and said ligand is selected from H, Cl, F, OH, OR, CN, CH₃, CR₃, NO, NO₃, CO, PR₃, NH₃, CRR′ (carbine), CNR, ═O, ═S, ≡N, η³-C₃H₅ (π-allyl), ≡CR (carbyne), acetyl, acetonitrile, acetylene, acetylacetonate, acetylacetonato, acetylacetone, acetyl, acyl, adamantyl, alkyl, allyl, aryl, η³-benzyl, biarylmonophosphine, biguanide, BINAP, BINOL, binaphthyl monophosphine, biphynylphosphino-2,2-binaphthyl, 2,2′-dibypyridine, 2,2′-bipyridine-based, bis(arylphosphane), 1,2-bis(dimethylphosphino)ethane, 1,2-bis(diphenylphosphino)methane, bis(phosphane), chiral bis(phosphane), chiral bis(phosphane/phosphite), bis(phosphinite), 1,2-bis(diphenylphosphino)ethane, bis(diphynylphosphino)methane, 1,3-bis(diphenylphosphino)propane, 2,6-bis(imino)pyridine, bis(phospholane), N,N′-bis(salicylidene)ethylenediamine, 9-borabicyclo[3,3,1]]nonane, buta-1,3-diene, tert-butyldimethylsilyl, carbene pincer ligands, carbonyl, corrole, crown ether, η⁴-cyclopentadienone, η⁵-C₅H₅ (cyclopentadienyl), η⁶-C₆H₆ (benzene), η⁷-C₇H₇ (cycloheptatrienyl), cyclohexyl, cycloocta-1,5-dienene, cyclododeca-1,5,9-triene, diaminocyclohexane, dialkyl tartrate, diaza, dibenzylideneacetone, dicyclopentadiene, diethylenetriamine, dimethylglyoxime, dimethylglyoximato, 1,2-divinylcyclobutane, (S,S)-Diop, diop, 2,2′-dipyridine, dppb, dppe, dppf, dppn, dppp, dppx, dppdpe, dppn, H₂C═CH₂ (ethylene), divinyltetramethyldisiloxane, Duphos, EDTA, ethylenediamine, ethylenediaminetetraacetic acid, hyrdido tris(3,5-dimethylpyrazolyl) borate, hydrido tris(pyrazolyl) borate, N-hetrocyclic carbine, hexamethylphosphoric acid triamide, η⁵-hydroxycyclo tris(pentafluorophenyl), η⁵-indenyl, isothiocyanate, mesityl, oxalate, oxalate, η⁵-C₅Me₅(pentamethylcyclopentadienyl), phen, 1-,10-phenanthrolin, phenoxy-imine, phosphine, phthalocyanine, phosphane/phophite, 2-(phosphinophenyl)oxazoline, pincer ligand: (CCC, CCN, CNC, CNN, CNO, NCN, NCP, NNN, NHC, NNO, ONO, PCP, PNP, PSiP, SCS, SNS), propylenediamine, pyridine, (R,R)-DIPAMP, 4,4′-tert-butyl-2,2′-bipyridine, tolyl, p-toluenesulfonic acid, trifluorosulfonic acid, tertamethyldivinylsiloxane, 2,4,6,8-tetramethyl-2,4,6,8-tetravinylcyclotetrasiloxane, N,N,N″,N″-tetramethylethylenediamine, 4,4′-tert-butyl-2,2′-bipyridine, thiazolidine, thiourea, TACN, TMEAA, TMEDA, TPZ, triaminotriethyamine, triehtylenetetramine, triphenyl phosphine, tris(3,5-dimethylpyrazolyl) borate, tris(pentafluorophenyl) borane, 1,2,3-tris(pentafluorophenyl)-4,5,6,7-tetrafluoro-1-boraindene, tris(oxazolinyl)phenyl borate, tris(pyrazolyl)borate, 4-vinylcyclohex-1-ene, TTCN, urea, xantphos, and combinations thereof.

10. The composition of claim 1, wherein said substrate is a transparent material.

11. The composition of claim 1, wherein said substrate is selected from the group consisting of metal, alloy, ceramic, thermoplastic, thermoset, elastomer, elastomeric polyurethane, elastomeric polyaspartic ester urea, foamed polyurethane, foamed polyethylene, polyurethane coating, polyaspartic ester urea coating, polyurea coating, polyethylene, polypropylene, polyvinyl chloride, fiber glass reinforced polyester resin, fiber glass reinforced epoxy resin, closed-cell foamed elastomer, microcellular closed-cell foamed elastomer, thermoplastic elastomer, fiber-reinforced polymer composite, and combinations thereof.

12. An anti-icing composition for a nanoporous substrate, driven by hydrogen from a dehydrogenetive reaction of a hydride siloxane that is infused with nanoparticle with immobilized catalyst; wherein the dehydrogenetive reaction is active under subzero temperatures in the presence of water; and wherein the nanoporous substrate acts as reservoir for the storage of the nanoparticle-infused hydride siloxane.

13. The composition of claim 12, wherein said nanoparticle is a fumed oxide, a nanofiber, or a combination thereof; said fumed oxide is selected from the group consisting of fumed aluminum oxide (Al₂O₃), fumed cerium oxide (Ce₂O₃), fumed ferric oxide (Fe₂O₃), fumed lanthanum oxide (La₂O₃), fumed magnesium oxide (MgO), fumed silica (SiO₂), fumed titanium oxide (TiO₂), fumed zirconium oxide (ZrO₂), and a mixture thereof; said nanofiber is selected from the group consisting of fibrous silica nanospheres, alumina nanofibers, lithium titanate nanofibers, silica nanofibers, titania nanofibers, zirconia nanofibers, cellulose nanofibers, collagen nanofibers, chitosan nanofibers, gelatin nanofibers, elastin nanofibers, silk fibroin nanofibers, wheat protein nanofibers and combinations thereof.

14. The composition of claim 12, wherein said immobilized catalyst is selected from the group consisting of metal atom, metal nano-cluster, dihydrogen complex of metal, metal organic, metal acetate, metal benzoate, metal borate, metal boride, metal bromide, metal carbonate, metal chloride, metal citrate, metal fluoride, metal fluoroalkylsulfonate metal formate, metal hexafluorophosphate, metal hexanoate, metal oxide chloride, metal hydride, metal hydroxide, metal iodide, metal lactate, metal maleate, metal malonate, metal molybdate, metal nitrate, metal oleate, metal oxide, metal oxide with reduced valence, metal nitrate, metal oxalate, metal oxide, metal oxide nitrate, metal perchlorate, metal perfluoroalkylsulfonate, metal phosphate, metal salicylate, metal sebacate, metal selenide, metal stearate, metal sulfate, metal sulfide, metal tartrate, metal teflate, metal telluride, metal tetrafluoroborate, metal tetrakis(pentafluorophenyl)boranate [B(C₆F₅)₄]⁻, metal triflate (trifluoromethanesulfonate), metal tungstate, and a mixture thereof; and said metal element is selected from the group consisting of Sc, Y, La, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and combinations thereof.

15. The composition of claim 12, wherein said immobilized catalyst is a water tolerant Lewis acid based on a metal salt selected from the group consisting of metal acetate, metal bromide, metal borate, metal chloride, metal oxide chloride, metal citrate, metal fluoroalkylsulfonate, metal fluoride, metal fluoroalkylsulfonate, metal formate, metal hexafluorophosphate, metal hexanoate, metal iodide, metal lactate, metal maleate, metal malonate, metal nitrate, metal oxide nitrate, metal oleate, metal oxide, metal perchlorate, metal perfluoroalkylsulfonate, metal salicylate, metal sebacate, metal stearate, metal sulfate, metal tartrate, metal teflate, metal tetrafluoroborate, metal tetrakis(pentafluorophenyl)boranate [B(C₆F₅)₄]⁻, metal triflate (trifluoromethanesulfonate), and combinations thereof; wherein the metal element is selected from the group consisting of Sc, Y, Ti, Zr, Hf, V, Nb, Ta, Cr, Mo, W, Mn, Fe, Co, Ni, Ru, Rh, Pd, Os, Ir, Pt, Cu, Ag, Au, Zn, Sn, lanthanides (La, Ce, Pr, Nd, Pm, Sm, Eu, Gd, Tb, Dy, Ho, Er, Tm, Yb, Lu), and combinations thereof.

16. The composition of claim 12, wherein said immobilized catalyst is an organometallic complex comprising a metal element atom (ion) coordinated with at least a ligand; wherein the metal element is selected from Ru, Rh, Pd, Os Ir, Pt, Sc, Y, Ti, Zr, Hf, V, Nb, Ta, Cr, Mo, W, Mn, Fe, Co, Ni, Cu, Ag, Au, Zn, Sn, lanthanides (La, Ce, Pr, Nd, Pm, Sm, Eu, Gd, Tb, Dy, Ho, Er, Tm, Yb, Lu), and combinations thereof, and said ligand is selected from H, Cl, F, OH, OR, CN, CH₃, CR₃, NO, NO₃, CO, PR₃, NH₃, CRR′ (carbine), CNR, ═O, ═S, ≡N, η³-C₃H₅ (π-allyl), CR (carbyne), acetyl, acetonitrile, acetylene, acetylacetonate, acetylacetonato, acetylacetone, acetyl, acyl, adamantyl, alkyl, allyl, aryl, η³-benzyl, biarylmonophosphine, biguanide, BINAP, BINOL, binaphthyl monophosphine, biphynylphosphino-2,2-binaphthyl, 2,2′-dibypyridine, 2,2′-bipyridine-based, bis(arylphosphane), 1,2-bis(dimethylphosphino)ethane, 1,2-bis(diphenylphosphino)methane, bis(phosphane), chiral bis(phosphane), chiral bis(phosphane/phosphite), bis(phosphinite), 1,2-bis(diphenylphosphino)ethane, bis(diphynylphosphino)methane, 1,3-bis(diphenylphosphino)propane, 2,6-bis(imino)pyridine, bis(phospholane), N,N′-bis(salicylidene)ethylenediamine, 9-borabicyclo[3,3,1]]nonane, buta-1,3-diene, tert-butyldimethylsilyl, carbene pincer ligands, carbonyl, corrole, crown ether, η⁴-cyclopentadienone, η⁵-O₅H₅ (cyclopentadienyl), η⁶-C₆H₆ (benzene), η⁷-C₇H₇ (cycloheptatrienyl), cyclohexyl, cycloocta-1,5-dienene, cyclododeca-1,5,9-triene, diaminocyclohexane, dialkyl tartrate, diaza, dibenzylideneacetone, dicyclopentadiene, diethylenetriamine, dimethylglyoxime, dimethylglyoximato, 1,2-divinylcyclobutane, (S,S)-Diop, diop, 2,2′-dipyridine, dppb, dppe, dppf, dppn, dppp, dppx, dppdpe, dppn, H₂C═CH₂ (ethylene), divinyltetramethyldisiloxane, Duphos, EDTA, ethylenediamine, ethylenediaminetetraacetic acid, hyrdido tris(3,5-dimethylpyrazolyl) borate, hydrido tris(pyrazolyl) borate, N-hetrocyclic carbine, hexamethylphosphoric acid triamide, hydroxycyclo tris(pentafluorophenyl), η⁵-indenyl, isothiocyanate, mesityl, oxalate, oxalate, η⁵-O₅Me₅(pentamethylcyclopentadienyl), phen, 1-,10-phenanthrolin, phenoxy-imine, phosphine, phthalocyanine, phosphane/phophite, 2-(phosphinophenyl)oxazoline, pincer ligand: (CCC, CCN, CNC, CNN, CNO, NCN, NCP, NNN, NHC, NNO, ONO, PCP, PNP, PSiP, SCS, SNS), propylenediamine, pyridine, (R,R)-DIPAMP, 4,4′-tert-butyl-2,2′-bipyridine, tolyl, p-toluenesulfonic acid, trifluorosulfonic acid, tertamethyldivinylsiloxane, 2,4,6,8-tetramethyl-2,4,6,8-tetravinylcyclotetrasiloxane, N,N,N″,N″-tetramethylethylenediamine, 4,4′-tert-butyl-2,2′-bipyridine, thiazolidine, thiourea, TACN, TMEAA, TMEDA, TPZ, triaminotriethyamine, triehtylenetetramine, triphenyl phosphine, tris(3,5-dimethylpyrazolyl) borate, tris(pentafluorophenyl) borane, 1,2,3-tris(pentafluorophenyl)-4,5,6,7-tetrafluoro-1-boraindene, tris(oxazolinyl)phenyl borate, tris(pyrazolyl)borate, 4-vinylcyclohex-1-ene, TTCN, urea, xantphos, and combinations thereof.

17. The anti-icing composition of claim 12, wherein said hydride siloxane is selected from polydihydrosiloxane, poly(dihydrosiloxane-alt-methylhydrosiloxane), polymethylhydrosiloxane, poly(dihydrosiloxane-alt-ethylhydrosiloxane), polyethylhydrosiloxane, C(SiH₃)₄, CH(SiH₃)₃, H₃C(SiH₃)₃, cyclic (H₂SiO)₃, cyclic (H₂SiO)₄, cyclic (H₂SiO)₅, cyclic (H₂SiO)₆, cyclic (H₂SiO)₇, cyclic (H₂SiO)₈, cyclic (H₂SiO)₉, cyclic (H₂SiO-alt-MeHSiO)₂, cyclic (H₂SiO-alt-MeHSiO)₃, cyclic (H₂SiO-alt-MeHSiO)₄, cyclic (H₂SiO-alt-MeHSiO)₅, cyclic (H₂SiO-alt-MeHSiO)₆, cyclic (MeHSiO)₃, cyclic (MeHSiO)₄, cyclic (MeHSiO)₅, cyclic (MeHSiO)₆, cyclic (MeHSiO)₇, cyclic (MeHSiO)₈, cyclic (MeHSiO)₉, and a mixture thereof.

18. The anti-icing coating composition of claim 12, wherein said nanoporous substrate is an anodic metal oxide film comprising of an interpore domain surface and a plurality of nanotube (nanopore) capillaries; said anodic metal oxide film is grown on a metal or a metal alloy by electrochemical anodic oxidation, wherein the metal element is selected from aluminum (Al), bismuth (Bi), cobalt (Co), chromium (Cr), hafnium (Hf), iron (Fe), magnesium (Mg), manganese (Mn), molybdenum (Mo), nickel (Ni), niobium (Nb), antimony (Sb), silicon (Si), tin (Sn), tantalum (Ta), titanium (Ti), vanadium (V), tungsten (W), zinc (Zn), zirconium (Zr), and combinations thereof.

19. The anti-icing composition of claim 12, wherein said substrate is coated with a nanoporous base layer comprising: (19a) a plurality of nanoparticles selected from the group consisting of nanoparticles with immobilized catalysts, fumed aluminum oxide (Al₂O₃), fumed cerium oxide (Ce₂O₃), fumed ferric oxide (Fe₂O₃), fumed lanthanum oxide (La₂O₃), fumed magnesium oxide (MgO), fumed silica (SiO₂), fumed titanium oxide (TiO₂), fumed zirconium oxide (ZrO₂), fibrous silica nanospheres, alumina nanofibers, lithium titanate nanofibers, silica nanofibers, titania nanofibers, zirconia nanofibers, cellulose nanofibers, collagen nanofibers, chitosan nanofibers, gelatin nanofibers, elastin nanofibers, silk fibroin nanofibers, wheat protein nanofibers, and a combination thereof; (19b) a two-component (2K), cross-linkable siloxane comprising a multifunctional siloxane and siloxane cross-linker, said multifunctional siloxane is a siloxane with reactive multifunctional groups selected from acetoxy, alkoxy, amine, aspartic ester amine, butoxy, enoxy, epoxy, methoxy, ethoxy, oxime, propoxy, secondary amine, silanol, and a mixture thereof, said siloxane cross-linker is selected from alkylhydrosiloxane, polyalkylhydrosiloxane, alkylhydrosilanolsiloxane, polyalkylhydrosilanolsiloxane, and a mixture thereof; and (19c) a solvent or solvent mixture.

20. The composition of claim 12, wherein said nanoporous substrate is treated with reactive linear polysiloxane to form end-grafted nanobrushes, said reactive linear polysiloxane is selected from polysiloxane with an alpha-reactive group, polysiloxane with a plurality of alpha-, omega-reactive groups, and polysiloxane with a plurality of pendant reactive groups; wherein the reactive group is selected from acetoxy, alkoxy, alkylamino, alkanolamino, carbinol, chloro, epoxy, hydride, polyaspartic ester amine, mercapto, silanol, and combinations thereof.
